(19) United States
(12) Patent Application Publication
(10) Pub. No.: US 2016/0235068 A1
(43) Pub. Date: Aug. 18, 2016

(54) CONTROLLED RELEASE PARTICLES, PRODUCTION METHOD THEREOF, MOLDING MATERIAL, AND MOLDED ARTICLE

(71) Applicant: OSAKA GAS CHEMICALS CO., LTD., Osaka-shi, Osaka (JP)

(72) Inventors: Junji OSHIMA, Osaka (JP); Hideaki INOUE, Osaka (JP); Tomoko HOSHINO, Osaka (JP); Ayako KOBAYASHI, Osaka (JP)

(73) Assignee: OSAKA GAS CHEMICALS CO., LTD., Osaka-shi, Osaka (JP)

(21) Appl. No.: 14/914,949

(22) PCT Filed: Aug. 29, 2014
(86) PCT No.: PCT/JP2014/072837

§ 371 Date: Feb. 26, 2016

(30) Foreign Application Priority Data
Aug. 30, 2013 (JP) 2013-180254
May 29, 2014 (JP) 2014-111278
Aug. 28, 2014 (JP) 2014-174055
Aug. 28, 2014 (JP) 2014-174056

(51) Int. Cl. A01N 51/00; A01N 25/26; B01J 13/18

(52) U.S. Cl. CPC A01N 51/00; B01J 13/185; A01N 25/26

(57) ABSTRACT

A production method of controlled release particles 1 includes an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent; a water dispersion step in which a hydrophobic slurry is dispersed in water to prepare an aqueous dispersion; and a polymerization step in which the polymerizable vinyl monomer is subjected to suspension polymerization to produce a polymer.

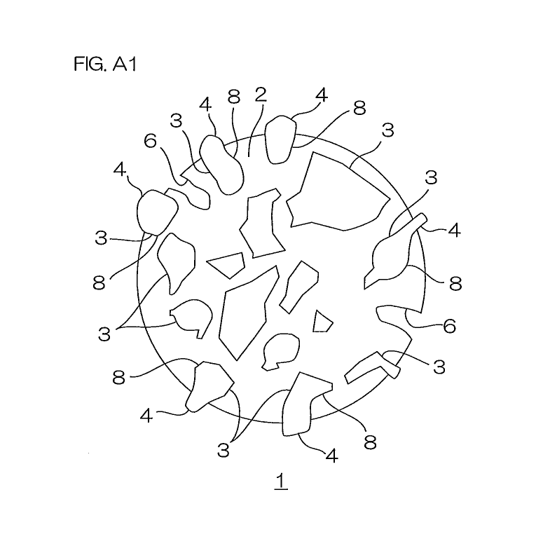

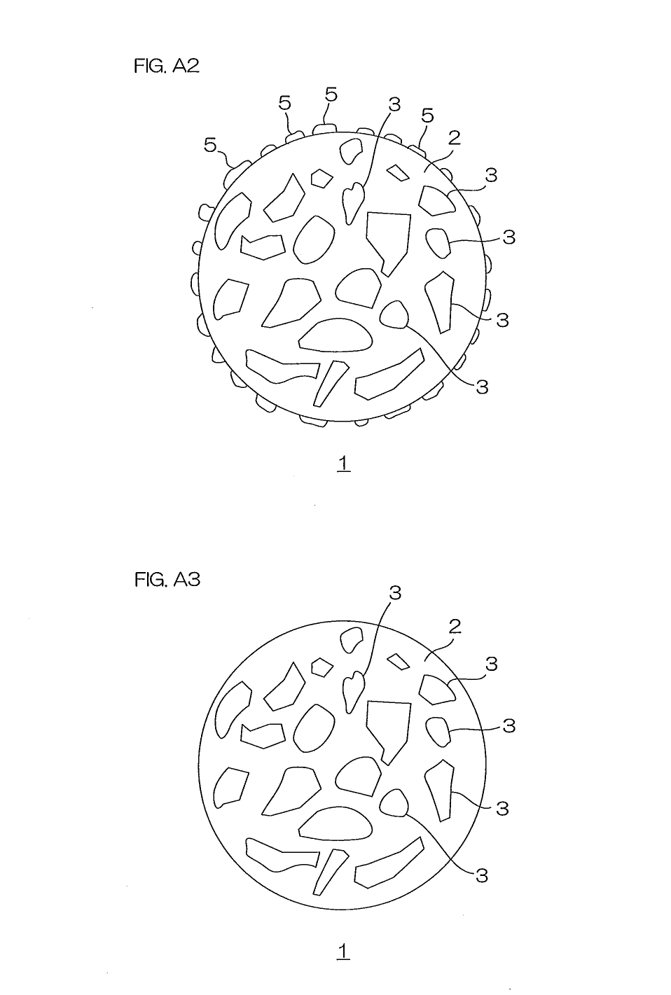

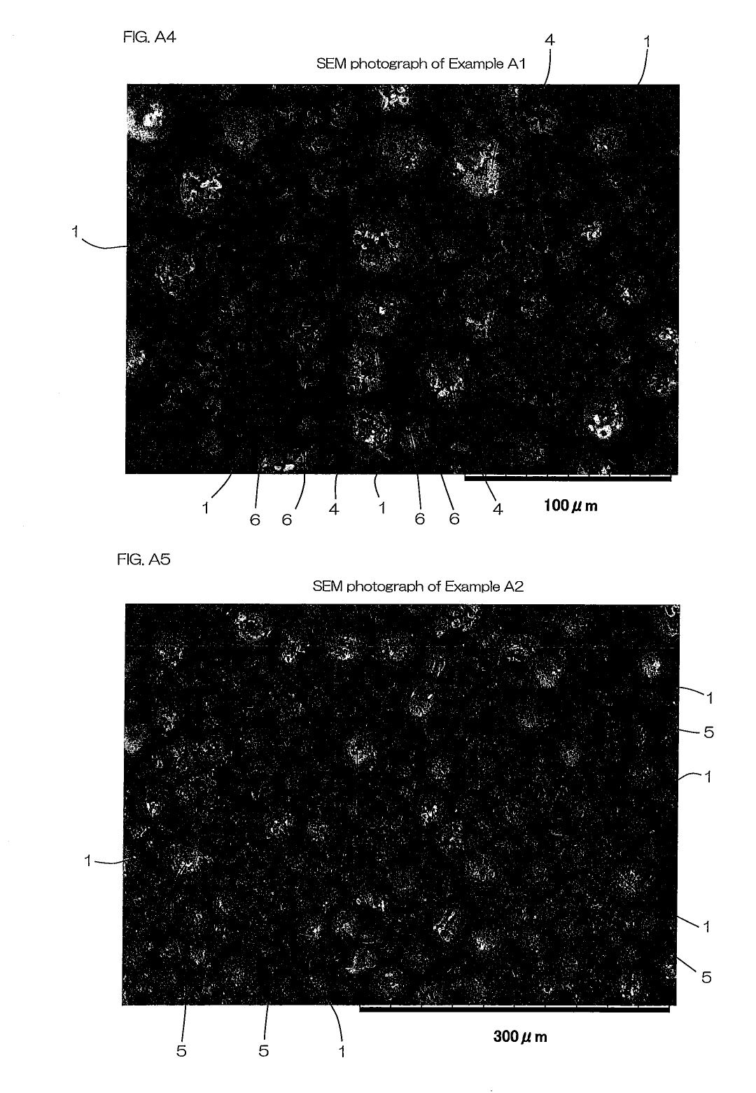

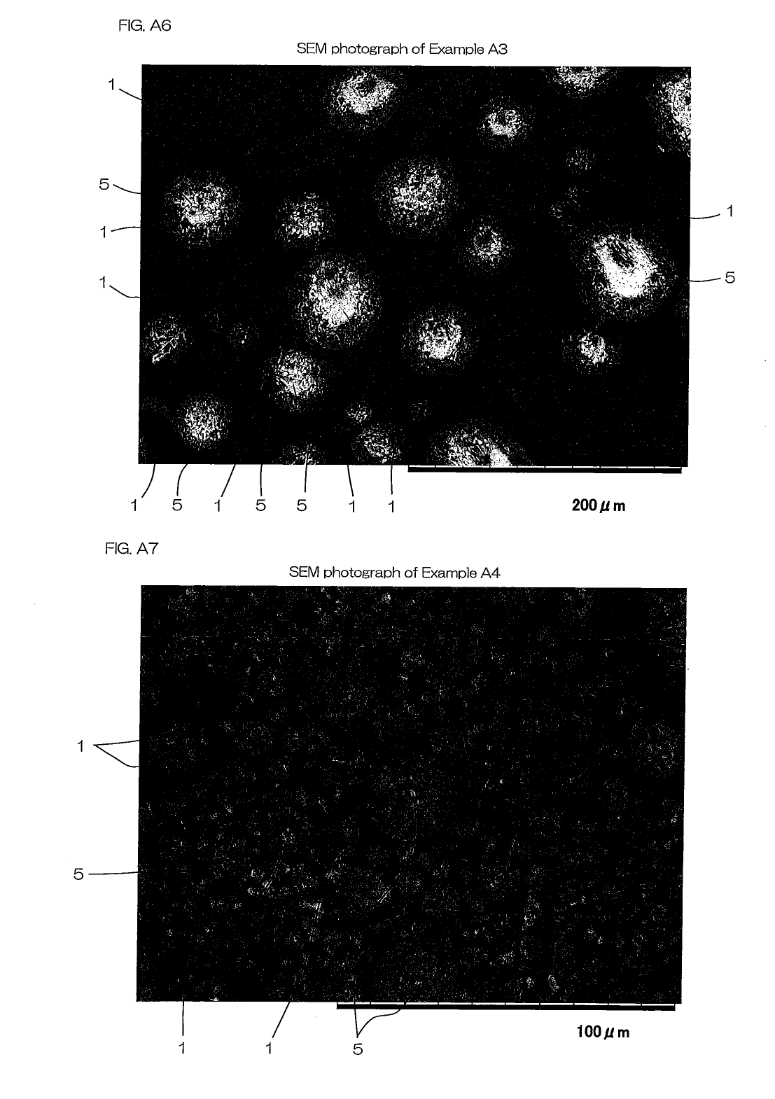

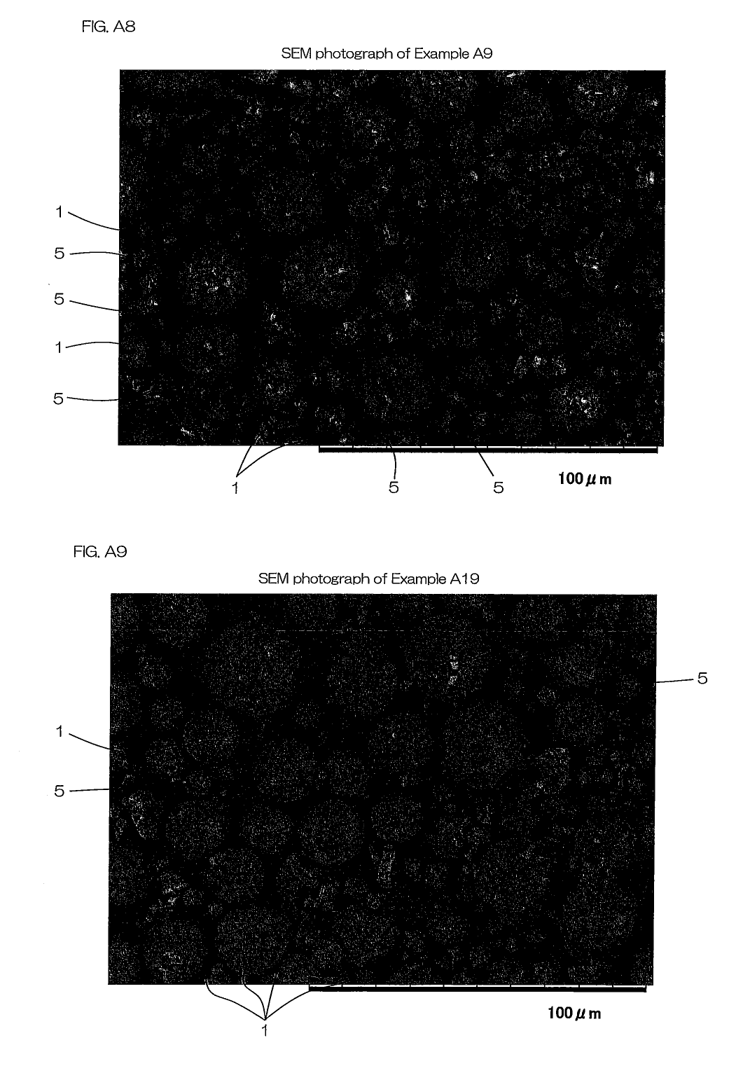

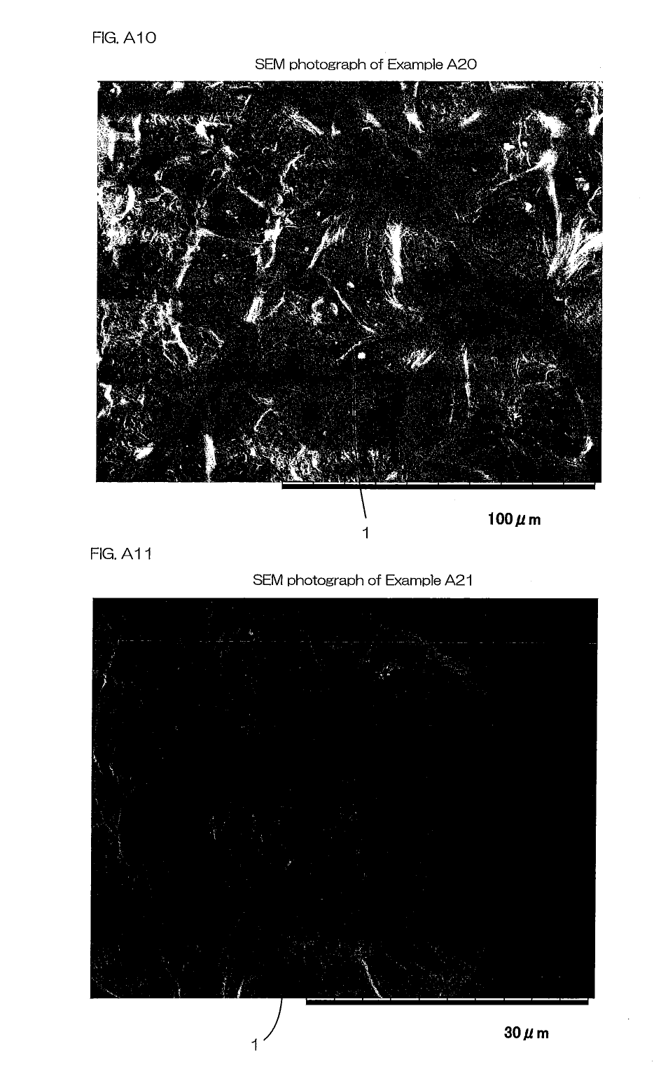

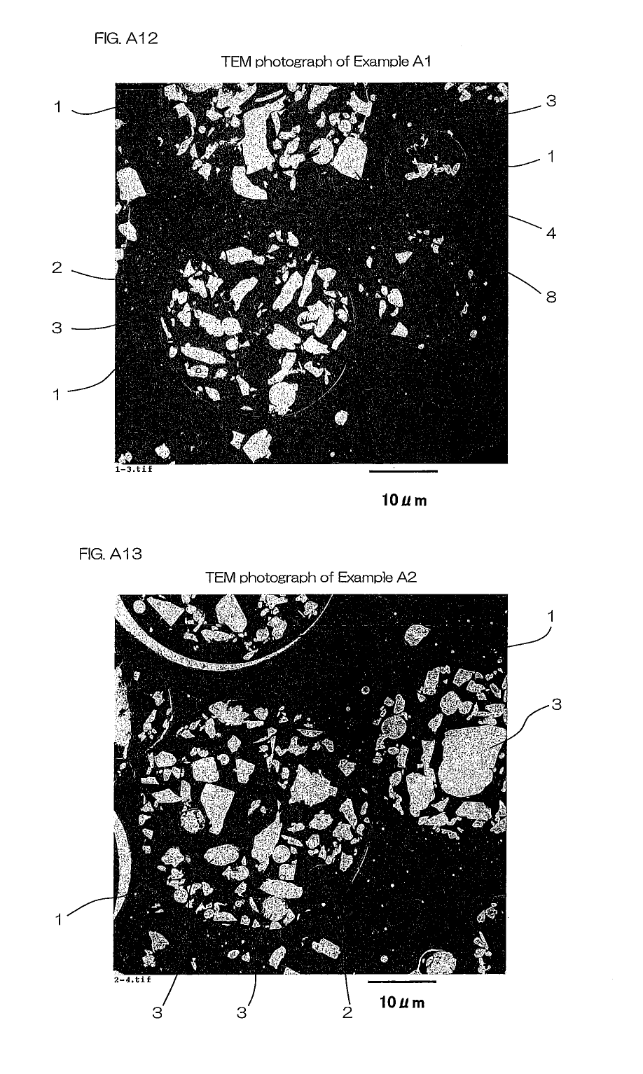

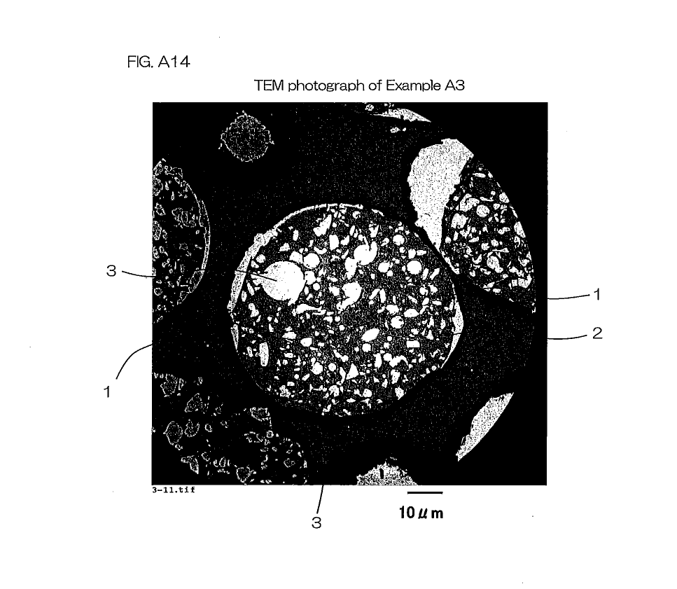

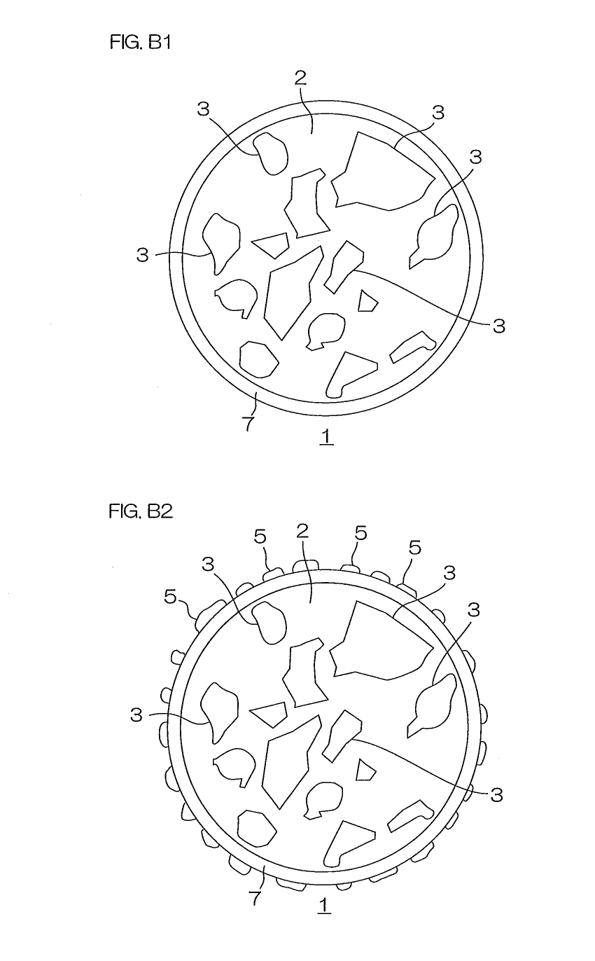

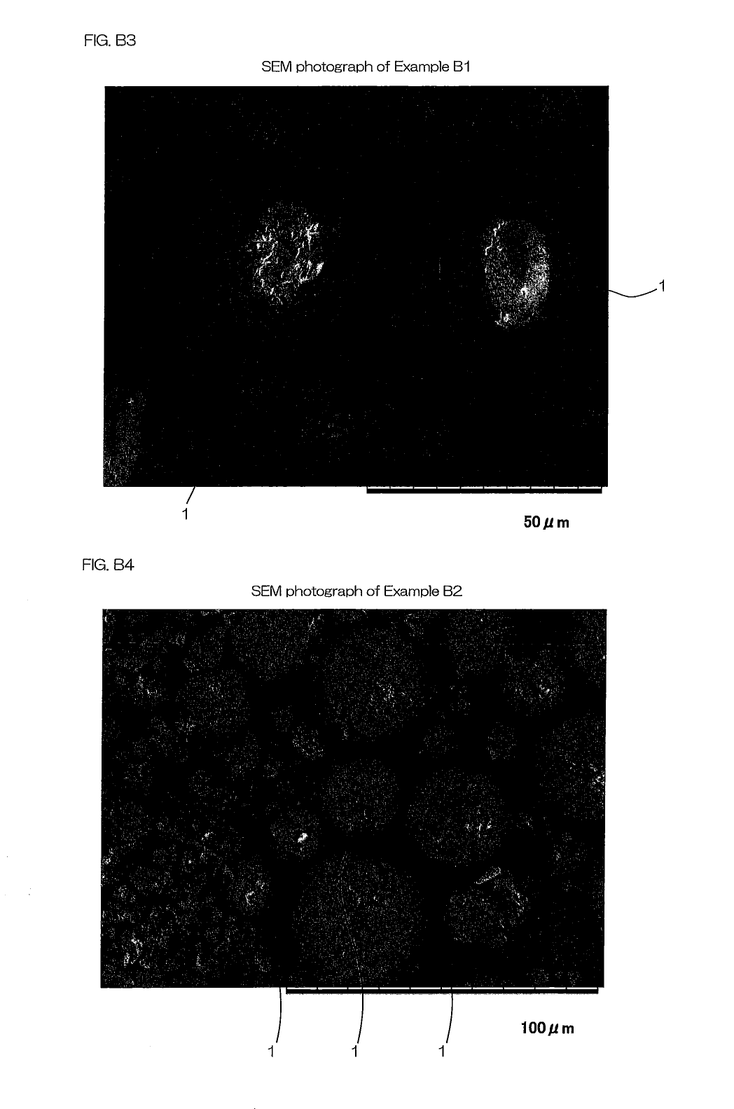

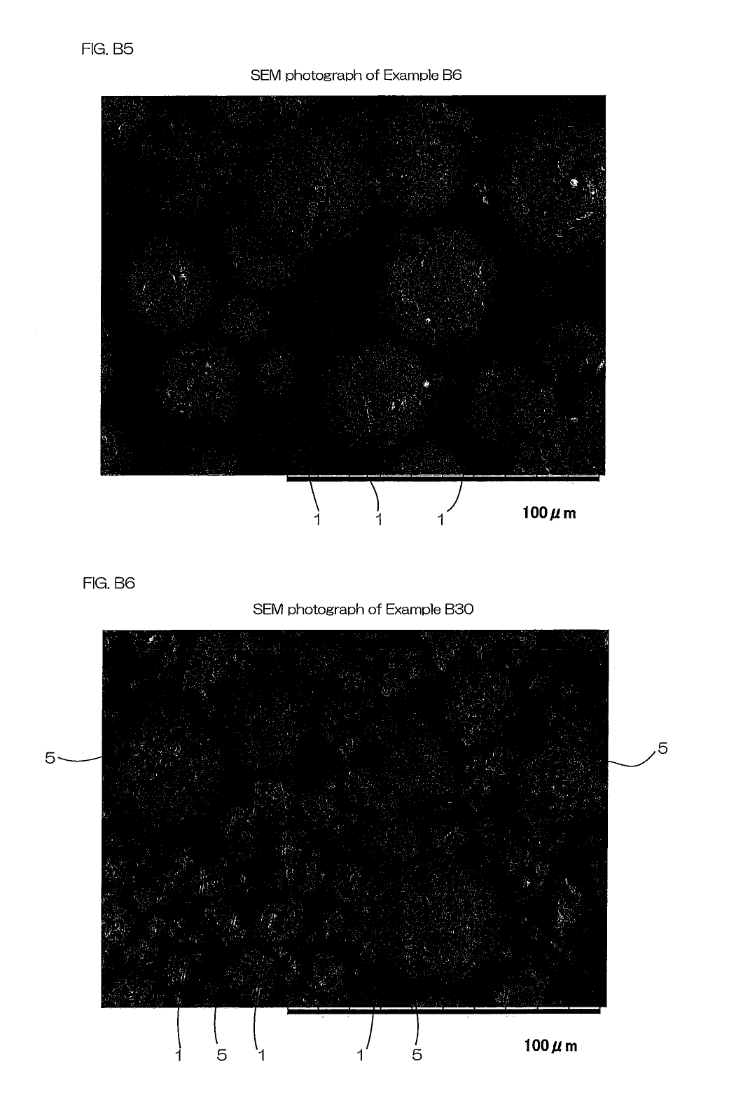

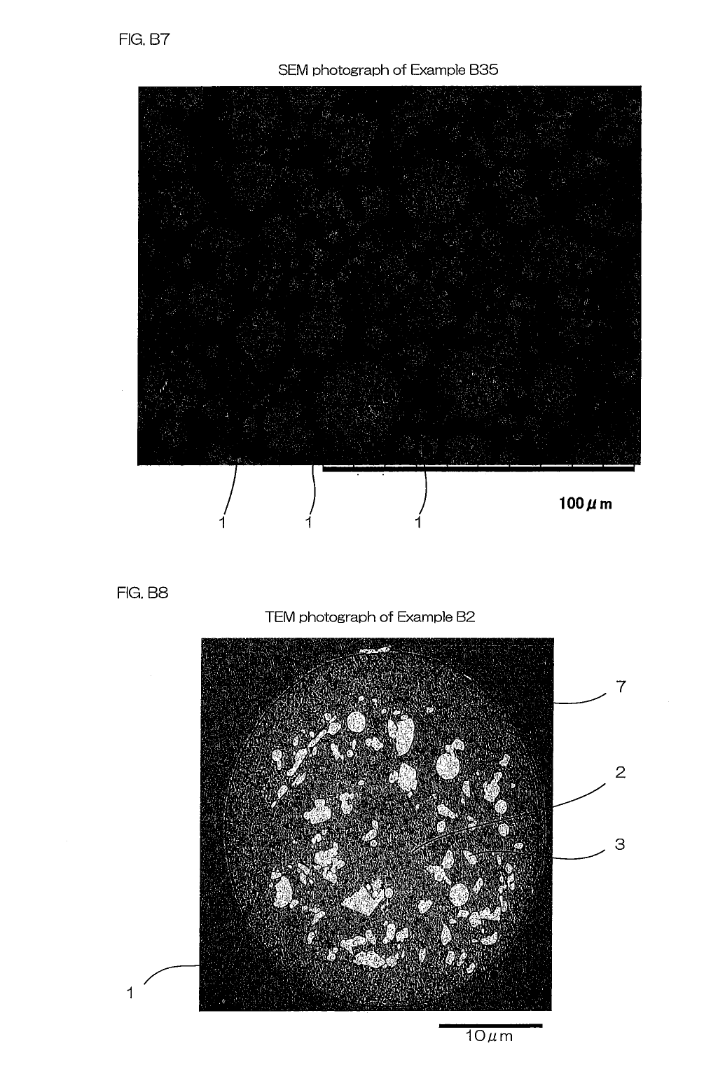

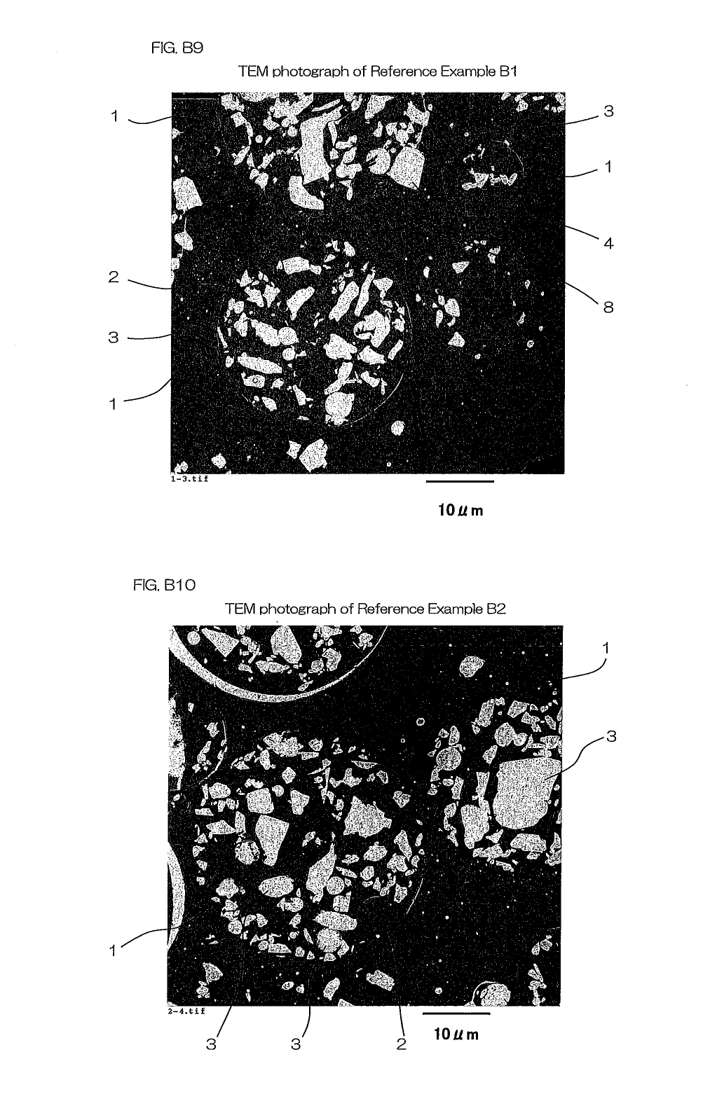

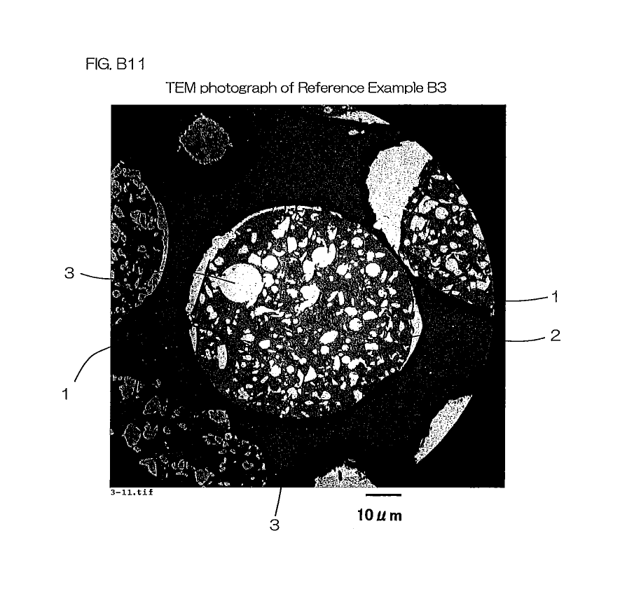

### TECHNICAL FIELD

The present invention relates to controlled release particles, a production method thereof, a molding material, and a molded article. In particular, the present invention relates to controlled release particles that allow controlled-release of an antibiotic compound, a production method thereof, a molding material, and a molded article.

### BACKGROUND ART

There has been known particles such as the following: forming a microcapsule of antibiotic compounds such as an insecticide, an insect repellent, an anti-termite agent, a sterilizer, an antiseptic, a herbicide, an antialgae, and a repellent, controlled-release of the antibiotic compound is allowed to ensure lasting effects.

For example, Patent Document 1 below has proposed a method for forming a microcapsule of a neonicotinoid-based compound by dispersing a slurry containing a neonicotinoid-based compound, a disperse medium, and a polyisocyanate component in water, and thereafter, blending polyamine and interfacially polymerizing the mixture.

### CITATION LIST

### Patent Document

### Patent Document 1: Japanese Unexamined Patent Publication No. 2000-247821

### SUMMARY OF THE INVENTION

### Problem to be Solved by the Invention

However, particles are sometimes required to have controlled release properties depending on use and purposes. There are disadvantages, however, in the microcapsule produced by the method described in Patent Document 1 in that the above-described requirement cannot be satisfied sufficiently.

There are disadvantages in that when the microcapsule described in Patent Document 1 is kneaded with resin or rubber, the microcapsule is broken by shearing at the time of kneading.

An object of the present invention is to provide controlled release particles with excellent controlled release properties and durability; a production method thereof; and a molding material and a molded article in which the controlled release particles are used.

### Means for Solving the Problem

The present inventors made an energetic study on the controlled release particles, a production method thereof, and a molding material and a molded article in which the controlled release particles are used of the above-described object, and found out that durable controlled release particles with excellent controlled release properties, a molding material and a molded article in which these are used can be produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which a polymerizable vinyl monomer is subjected to suspension polymerization to produce a polymer, and accomplished a first invention group.

A first invention group relates to:

(1)

controlled release particles produced by a production method including
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer;
   (2)

the controlled release particles of the above-described (1), wherein in the polymerization step, the polymerizable vinyl monomer is subjected to suspension polymerization in the presence of a salt of a condensate of aromatic sulfonic acid and formaldehyde, and/or the polymerizable vinyl monomer contains a (meth)acrylate monomer and a (meth)acrylate-based crosslinkable monomer;

(3)

the controlled release particles of the above-described (1) or (2), wherein the antibiotic compound is a neonicotinoid-based insecticide;

(4)

the controlled release particles of the above-described (3), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine;

(5)

controlled release particles having a two-phase structure formed from a matrix made of a polymer, and a domain made of an antibiotic compound substantially insoluble to a monomer for producing the polymer and is dispersed in the matrix;

(6)

the controlled release particles of the above-described (5), wherein both of the matrix and the domain are exposed on the surface of the controlled release particles,

(7)

the controlled release particles of the above-described (5), wherein the domain is covered by the matrix,

(8)

the controlled release particles of the above-described (7), wherein the antibiotic compound is further attached to the surface of the matrix;

(9)

the controlled release particles of any one of the above-described (5) to (8), wherein the antibiotic compound is a neonicotinoid-based insecticide,

(10)

the controlled release particles of the above-described (9), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine;

(11)

the controlled release particles of any one of the above-described (1) to (10), prepared as powder formulation;

(12)

a molding material containing a thermoplastic resin, and the controlled release particles of any one of the above-described (1) to (11);

(13)

a molded article containing a thermoplastic resin, and the controlled release particles of any one of the above-described (1) to (11),

(14)

a method for producing controlled release particles, the method including the steps of: an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer;

(15)

the method for producing controlled release particles of the above-described (14), wherein in the polymerization step, the polymerizable vinyl monomer is subjected to suspension polymerization in the presence of a salt of a condensate of aromatic sulfonic acid and formaldehyde, and/or the polymerizable vinyl monomer contains a (meth)acrylate monomer and a (meth)acrylate-based crosslinkable monomer;

(16)

the method for producing controlled release particles of the above-described (14) or (15), further including a step of preparing powder formulation by blending the suspension produced in the polymerization step and a solid carrier, and drying them;

(17)

the method for producing controlled release particles of any one of the above-described (14) to (16), wherein the antibiotic compound is a neonicotinoid-based insecticide; and

(18)

the method for producing controlled release particles of the above-described (17), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

Furthermore, the present inventors made an energetic study on the controlled release particles, production method thereof, and molding material and molded article in which the controlled release particles are used of the above-described first invention group, and found out that durable controlled release particles with excellent controlled release properties and alkali-resistance, molding material and molded article in which these are used can be produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer, wherein in the polymerization step, the polymerizable vinyl monomer is subjected to suspension polymerization, and a hydrophobic shell-forming component and a hydrophilic-shell forming component are subjected to interfacial polymerization to form a shell that covers a suspension polymer, and accomplished a second invention group.

A second invention group relates to:

(1)

controlled release particles produced by a production method including,
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer,
wherein in any of at least one step of the oil phase component preparation step, the water dispersion step, and the polymerization step, a hydrophobic shell-forming component and a hydrophilic-shell forming component are blended, and in the polymerization step, the polymerizable vinyl monomer is subjected to suspension polymerization and the hydrophobic shell-forming component and the hydrophilic shell-forming component are subjected to interfacial polymerization to form a shell that covers a suspension polymer;
   (2)

the controlled release particles of the above-described (1), wherein the interfacial polymerization is started simultaneously with the start of the suspension polymerization, or is started before the start of the suspension polymerization;

(3)

the controlled release particles of the above-described (1) or (2), wherein the hydrophobic shell-forming component contains polyisocyanate, and the hydrophilic shell-forming component contains polyamine;

(4)

the controlled release particles of any one of the above-described (1) to (3), wherein the antibiotic compound is a neonicotinoid-based insecticide;

(5)

the controlled release particles of the above-described (4), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine;

(6)

controlled release particles including a matrix made of a polymer, a domain made of an antibiotic compound substantially insoluble to a monomer for producing the polymer and is dispersed in the matrix, and a shell that covers the matrix;

(7)

the controlled release particles of the above-described (6), wherein the shell is made of polyurea,

(8)

the controlled release particles of the above-described (6) or (7), wherein the antibiotic compound is attached to the surface of the shell;

(9)

the controlled release particles of any one of the above-described (6) to (8), wherein the antibiotic compound is a neonicotinoid-based insecticide;

(10)

the controlled release particles of the above-described (9), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine;

(11)

the controlled release particles of any one of the above-described (1) to (10), prepared as powder formulation;

(12)

a molding material containing a thermoplastic resin, and the controlled release particles of any one of the above-described (1) to (11);

(13)

a molded article containing a thermoplastic resin, and the controlled release particles of any one of the above-described (1) to (11);

(14)

a method for producing controlled release particles, the method including the steps of:

an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,

a water dispersion step in which the oil phase component is dispersed in water to prepare an aqueous dispersion, and

a polymerization step in which the polymerizable vinyl monomer is subjected to suspension polymerization to produce a polymer,

wherein in any of at least one step of the oil phase component preparation step, the water dispersion step, and the polymerization step, a hydrophobic shell-forming component and a hydrophilic-shell forming component are blended, and in the polymerization step, the polymerizable vinyl monomer is subjected to suspension polymerization and the hydrophobic shell-forming component and the hydrophilic shell-forming component are subjected to interfacial polymerization to form a shell that covers a suspension polymer;

(15)

the method for producing controlled release particles of the above-described (14), wherein in the polymerization step, the interfacial polymerization is started simultaneously with the start of the suspension polymerization, or is started before the start of the suspension polymerization;

(16)

the method for producing controlled release particles of the above-described 14 or 15, wherein the hydrophobic shell-forming component is polyisocyanate and the hydrophilic shell-forming component is polyamine;

(17)

the method for producing controlled release particles of any one of the above-described 14 to 16, further including a step of preparing powder formulation by blending the suspension produced in the polymerization step and a solid carrier, and drying these;

(18)

the method for producing controlled release particles of any one of the above-described 14 to 17, wherein the antibiotic compound is a neonicotinoid-based insecticide;

(19)

the method for producing controlled release particles of the above-described (18), wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

### Effect of the Invention

The controlled release particles of the first invention group is produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer, and therefore durable controlled release particles with excellent controlled release properties can be produced.

With the method for producing controlled release particles of the first invention group, controlled release particles that are durable and have excellent controlled release properties can be produced.

The controlled release particles of the first invention group have a two-phase structure formed from a matrix made of a polymer, and a domain made of an antibiotic compound and is dispersed in the matrix, and therefore controlled release of the antibiotic compound is excellent, and durability is excellent, and thus the controlled release particles are kneaded with resin excellently.

The molding material of the first invention group contains the above-described controlled release particles, and therefore excellent controlled release properties of the antibiotic compound can be given to the molded article of the first invention group.

The controlled release particles of the second invention group are produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer, and therefore durable controlled release particles with excellent controlled release properties and alkali-resistance can be produced.

With the method for producing controlled release particles of the second invention group, controlled release particles that are durable and have excellent controlled release properties and alkali-resistance can be produced.

Furthermore, in the controlled release particles of the second invention group, in the polymerization step, the polymerizable vinyl monomer is subjected to suspension polymerization and a hydrophobic shell-forming component and a hydrophilic-shell forming component are subjected to interfacial polymerization to form a shell that covers a suspension polymer, and therefore a high encapsulation rate of the antibiotic compound and excellent alkali-resistance of the antibiotic compound are achieved.

The controlled release particles of the second invention group include a matrix made of a polymer and a domain made of an antibiotic compound and is dispersed in the matrix, and therefore the antibiotic compound has excellent controlled release properties and durability, thus can be excellently kneaded with resin.

Furthermore, the controlled release particles of the second invention group include a shell that covers the matrix, and therefore the antibiotic compound has excellent controlled release properties and alkali-resistance.

The molding material of the second invention group contains the above-described controlled release particles, and therefore excellent controlled release properties and alkali-resistance of the antibiotic compound can be given to the second invention group.

### BRIEF DESCRIPTION OF THE DRAWINGS

FIG. A1 shows a schematic cross-sectional view of the controlled release particles of the first invention group in the first embodiment.

FIG. A2 shows a schematic cross-sectional view of the controlled release particles of the first invention group in the second embodiment (embodiment in which the domain is covered by the matrix, and attachment is attached to the surface of the matrix).

FIG. A3 shows a schematic cross-sectional view of a modified second embodiment (embodiment in which the entire surface of the matrix is exposed).

FIG. A4 shows an image-processed SEM photograph of the controlled release particles of Example A1.

FIG. A5 shows an image-processed SEM photograph of the controlled release particles of Example A2.

FIG. A6 shows an image-processed SEM photograph of the controlled release particles of Example A3.

FIG. A7 shows an image-processed SEM photograph of the controlled release particles of Example A4.

FIG. A8 shows an image-processed SEM photograph of the controlled release particles of Example A9.

FIG. A9 shows an image-processed SEM photograph of the controlled release particles of Example A19.

FIG. A10 shows an image-processed SEM photograph of the fracture surface of the strand of Example A20.

FIG. A11 shows an image-processed SEM photograph of the fracture surface of the strand of Example A21.

FIG. A12 shows an image-processed TEM photograph of the controlled release particles of Example A1.

FIG. A13 shows an image-processed TEM photograph of the controlled release particles of Example A2.

FIG. A14 shows an image-processed TEM photograph of the controlled release particles of Example A3.

FIG. B1 shows a schematic cross-sectional view of the controlled release particles of the second invention group in the third embodiment.

FIG. B2 shows a schematic cross-sectional view of the controlled release particles of the second invention group in the fourth embodiment.

FIG. B3 shows an image-processed SEM photograph of the controlled release particles of Example B1.

FIG. B4 shows an image-processed SEM photograph of the controlled release particles of Example B2.

FIG. B5 shows an image-processed SEM photograph of the controlled release particles of Example B6.

FIG. B6 shows an image-processed SEM photograph of the controlled release particles of Example B30.

FIG. B7 shows an image-processed SEM photograph of the controlled release particles of Example B35.

FIG. B8 shows an image-processed TEM photograph of the controlled release particles of Example B2.

FIG. B9 shows an image-processed TEM photograph of the controlled release particles of Reference Example B1.

FIG. B10 shows an image-processed TEM photograph of the controlled release particles of Reference Example B2.

FIG. B11 shows an image-processed TEM photograph of the controlled release particles of Reference Example B3.

### DESCRIPTION OF EMBODIMENTS

In the following, the first invention group and the second invention group that are included in the present invention and are interrelated will be described in sequence.

### [First Invention Group]

### <Description of Method for Producing Controlled Release Particles>

The method for producing controlled release particles of the first invention group includes an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer.

In the following, materials used in the above-described steps are described.

### (Antibiotic Compound)

The antibiotic compound is selected from, for example, an insecticide (including formicide), an insect repellent (including anti-termite agent), a sterilizer, an antibacterial agent, an antiseptic, a herbicide, an antialgae, a fungicide, an attractant, a repellent, and a rodenticide, having antibiotic activity such as, for example, insecticidal (including formicide), insect repellent (including anti-termite), sterilization, antibacterial, antiseptic, herbicidal, antialgae, and fungicidal activities.

To be specific, examples of the antibiotic compound include the following. Examples of insecticides include neonicotinoid-based insecticides such as clothianidin ((E)-1-(2-chlorothiazole-5-ylmethyl)-3-methyl-2-nitroguanidine), imidacloprid (1-(6-chloro-3-pyridylmethyl)-N-nitroimidazolidin-2-ylideneamine), thiacloprid, thiamethoxam ((EZ)-3-(2-chloro-1,3-thiazole-5-ylmethyl)-5-methyl-1,3,5-oxadiazinan-4-ylidene(nitro)amine), and dinotefuran; diamide-based insecticides such as flubendiamide and chlorantraniliprol; insect growth regulators such as diflubenzuron, teflubenzuron, chlorfluazuron, tebufenozide, methoxyfenozide, and cyromazine; acaricides such as clofentezine; and other synthetic agents such as pymetrozine and sodium oleate. Examples of the sterilizer include copper-based sterilizers such as basic copper chloride, basic copper sulfate, and oxine-copper; silver-based sterilizers such as metalic silver; organic sulfur-based sterilizers such as polycarbamate; melanin biosynthesis inhibitors such as fthalid and tricyclazole; benzimidazole-based sterilizers such as thiophanate-methyl, carbendazim (MBC), and diethofencarb; acid amide-based sterilizers such as isotianil; sterol biosynthesis inhibitors such as triforine; isothiazolone-based sterilizers such as 1,2-benzisothiazolin-3-one; and other synthesis inhibitors such as diclomezine, fluoroimide, captan, chlorothalonil, chinomethionat, oxolinic acid, benthiavalicarb-isopropyl, cyazofamid, and zinc pyrithione. Examples of the herbicide-antialgae include urea-based agents such as 3-(3,4-dichlorophenyl)-1,1-dimethylurea (DCMU), cumyluron, and karbutilate; sulfonylurea-based agents such as ethoxysulfuron, halosulfuron-methyl, flazasulfron, nicosulfuron, thifensulfuron-methyl, imazosulfuron, cyclosulfamuron, flucetosulfuron, and sodium trifloxysulfuron; triazine-based agents such as simazine (CAT), atrazine, triaziflam, lenacil, cyfluthrin, and terbutryn; amino acid-based agents such as glyphosate; phenylphthalimide-based agents such as flumioxazin; triketone-based agents such as mesotrione; and other agents such as quinoclamin and pyriftalid. For the antibiotic compound, preferably, in view of chemo selectivity and safety, neonicotinoid-based insecticides, and in view of versatility and effectiveness, zinc pyrithione is used, more preferably, in view of insolubility, clothianidin, imidacloprid, zinc pyrithione are used, even more preferably, clothianidin and imidacloprid are used. Particularly preferably, in view of safety for mammals, clothianidin is used.

The antibiotic compound is substantially hydrophobic. To be specific, the antibiotic compound has an extremely low solubility to, for example, water at room temperature (20 to 30° C., to be more specific, 25° C.). To be more specific, the antibiotic compound has a solubility at, for example, room temperature, of 1.5 parts by mass/100 parts by volume of water (15 g/L) or less, preferably, 0.5 parts by volume/100 parts by mass of water (5 g/L) or less, even more preferably, 0.1 parts by mass/100 parts by volume of water (1 g/L) or less.

The antibiotic compound is substantially insoluble to the polymerizable vinyl monomer. To be specific, for example, the antibiotic compound has an extremely low solubility to the polymerizable vinyl monomer at room temperature (20 to 30° C., to be more specific, 25° C.). To be specific, the antibiotic compound has a solubility at room temperature of, for example, 0.1 part by mass/100 parts by volume of the polymerizable vinyl monomer (to be used)(mixture)(1 g/L) or less, preferably, 0.05 parts by mass/100 parts by volume of the polymerizable vinyl monomer (to be used)(mixture)(0.5 g/L) or less.

The antibiotic compound has a melting point of, for example, 80° C. or more, preferably, 100° C. or more, and when the antibiotic compound is a compound that does not contain metal atoms, for example, 300° C. or less.

### (Polymerizable Vinyl Monomer)

Examples of the polymerizable vinyl monomer include a (meth)acrylate monomer, an aromatic vinyl monomer, a vinyl ester monomer, a maleate monomer, a vinyl halide, a vinylidene halide, a nitrogen-containing vinyl monomer, and a crosslinkable monomer.

Examples of the (meth)acrylate monomer include methacrylate and/or acrylate, to be specific, alkyl (meth)acrylate having a straight chain, branched, or cyclic alkyl moiety with 1 to 6 carbon atoms such as methyl (meth)acrylate, ethyl (meth)acrylate, n-propyl (meth)acrylate, isopropyl (meth)acrylate, (meth)n-butyl acrylate, isobutyl (meth)acrylate (i-BMA/i-BA), tert-butyl (meth)acrylate, n-pentyl (meth)acrylate, n-hexyl (meth)acrylate, and cyclohexyl (meth)acrylate; alkoxyalkyl (meth)acrylate such as 2-methoxyethyl (meth)acrylate; (meth)acrylic acidhydroxyalkyl such as hydroxyethyl (meth)acrylate; epoxy group-containing (meth)acrylates such as glycidyl (meth)acrylate. Preferably, alkyl (meth)acrylate is used.

For the alkyl (meth)acrylate, more preferably, alkyl (meth)acrylate having an alkyl moiety with 1 to 6 carbon atoms, particularly preferably, isobutyl methacrylate (i-BMA) is used.

Examples of the aromatic vinyl monomer include styrene monomers (monovinylbenzene) such as styrene (vinylbenzene), p-methylstyrene, o-methylstyrene, α-methylstyrene, and ethylvinylbenzene. Preferably, styrene and ethylvinylbenzene are used.

Examples of the vinyl ester monomer include vinyl acetate and vinyl propionate.

Examples of the maleate monomer include dimethyl maleate, diethyl maleate, and dibutyl maleate.

Examples of the vinyl halide include vinyl chloride and vinyl fluoride.

Examples of the vinylidene halide include vinylidene chloride and vinylidene fluoride.

Examples of the nitrogen-containing vinyl monomer include (meth)acrylonitrile, N-phenylmaleimide, and vinylpyridine.

Examples of the crosslinkable monomer include (meth)acrylate crosslinkable monomers, allyl monomers, and aromatic crosslinkable monomers. Examples of the (meth)acrylate crosslinkable monomer include mono or polyethylene glycoldi(meth)acrylate such as ethylene glycoldi(meth)acrylate and diethylene glycoldi(meth)acrylate; alkane diol di(meth)acrylate such as 1,3-propanedioldi(meth)acrylate, 1,4-butanedioldi(meth)acrylate, and 1,5-pentanedioldi(meth)acrylate; and alkane polyol poly(meth)acrylate such as trimethylolpropanetri(meth)acrylate and pentaerythritoltetra(meth)acrylate (PETA/PETM). Examples of the allyl monomer include allyl(meth)methacrylate and triallyl(iso)cyanurate. Examples of the aromatic crosslinkable monomer include divinylbenzene and trivinylbenzene. Preferably, mono or polyethylene glycoldi(meth)acrylate and divinylbenzene, more preferably, ethylene glycoldi(meth)acrylate and divinylbenzene are used.

The polymerizable vinyl monomer can be used singly, or can be used in combination.

The polymer produced by polymerization of the polymerizable vinyl monomer has durable surface at room temperature, and therefore has a glass transition temperature of, for example, 30° C. or more, preferably, 50° C. or more, and the polymerizable vinyl monomer is selected to give such a glass transition temperature.

The polymerizable vinyl monomer is, for example, substantially hydrophobic. To be specific, the polymerizable vinyl monomer has an extremely low solubility to, for example, water at room temperature. To be more specific, the polymerizable vinyl monomer has a solubility at room temperature of, for example, 10 parts by mass/100 parts by volume of water (100 g/L) or less, preferably, 8 parts by mass/100 parts by volume of water (80 g/L) or less. When different kinds of polymerizable vinyl monomers are used, the entire polymerizable vinyl monomer (that is, mixture of different kinds of polymerizable vinyl monomers) is substantially hydrophobic.

Next, each step in the method for producing controlled release particles is described in sequence.

### (Oil Phase Component Preparation Step)

In the oil phase component preparation step, without the presence of a solvent, an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer.

To be specific, the above-described polymerizable vinyl monomer and the antibiotic compound are blended, and stirred without blending a solvent (hydrophobic organic solvent such as hexane, toluene, and ethyl acetate). A hydrophobic slurry is prepared in this manner. The hydrophobic slurry is contained in the oil phase component.

To disperse the antibiotic compound in the polymerizable vinyl monomer, for example, a disperser such as a paint shaker, a homodisper (high-speed disperser), a bead mill (including batch type bead mill), a ball mill, and a rod mill are used. The disperser can be used singly, or can be used in combination. For the disperser, preferably, in view of the fact that it can be used for a wide range of viscosity, and can be used for a large-scale industrial production, a batch type bead mill is used.

The above-described dispersion allows for wet grinding of the antibiotic compound.

The whole of the polymerizable vinyl monomer can be blended in the antibiotic compound, or the polymerizable vinyl monomer can be blended in the antibiotic compound dividedly. When the polymerizable vinyl monomer is blended in dividedly, first, a portion of the polymerizable vinyl monomer is blended in the antibiotic compound, and the mixture is dispersed to prepare a hydrophobic slurry, and thereafter, the remaining portion of the polymerizable vinyl monomer is blended in the hydrophobic slurry.

In this manner, an oil phase component containing a hydrophobic slurry is prepared.

The mixing ratio of the antibiotic compound relative to the polymerizable vinyl monomer based on the mass ratio (that is, parts by mass of the antibiotic compound/parts by mass of the polymerizable vinyl monomer) is, for example, 1/99 or more, preferably 10/90 or more, more preferably 15/85 or more, and for example, 90/10 or less, preferably, 75/25 or less, more preferably, 70/30 or less, even more preferably, 65/35 or less, and particularly preferably, 60/40 or less.

The mixing ratio of the antibiotic compound relative to 100 parts by mass of the polymerizable vinyl monomer is, for example, 1 part by mass or more, preferably, 10 part by mass or more, more preferably, 20 parts by mass or more, and for example, 900 parts by mass or less, preferably, 300 parts by mass or less, more preferably, 200 parts by mass or less, even more preferably, 150 parts by mass or less.

The oil phase component has an antibiotic compound content of, for example, 1 mass % or more, preferably, 10 mass % or more, and for example, 90 mass % or less, preferably, 80 mass % or less, more preferably, 70 mass % or less, more preferably, 60 mass % or less.

In the above-described dispersion, as necessary, a dispersing agent (a first dispersing agent) can be blended. Examples of the dispersing agent include an amphiphilic polymer dispersing agent and non ionic surfactant (first surfactant).

Examples of the amphiphilic polymer dispersing agent include non ionic amphiphilic polymer dispersing agent such as EFKA4008 and EFKA4009 (urethane-based polymer dispersing agent manufactured by Ciba Specialty Chemicals), DISPERBYK-2164 and DISPERBYK-164 (pigment dispersing functional group-modified copolymer manufactured by BYK Japan KK), NUOSPERSE2008, NUOSPERSE FA-196, and NUOSPERSE657 (manufactured by Elementis plc), FlOWLEN D-90, POLYFLOW KL-100, POLYFLOW KL-700 (manufactured by Kyoeisha Chemical Co., Ltd.), and HOMOGENOL L-95 (manufactured by Kao Corporation). The examples of the amphiphilic polymer dispersing agent also include anionic amphiphilic polymer dispersing agent such as FlOWLEN G-900 (carboxyl group-modified polymer manufactured by Kyoeisha Chemical Co., Ltd.), DISPARLON DA-234, DISPARLON DA-325, DISPARLON DA-375, DISPARLON DA-550, and DISPARLON AQ-330 (polyether phosphate manufactured by Kusumoto Chemicals, Ltd.). Furthermore, examples of the amphiphilic polymer dispersing agent include cationic amphiphilic polymer dispersing agent such as NOPCOSPERSE 092 (manufactured by San Nopco Limited).

Examples of the non ionic surfactant include Amorgen CBH (alkylbetaine), Amorgen SH (alkylamidebetaine), NOIGEN 100E (polyoxyethylene oleyl ether), NOIGEN EA73 (polyoxyethylenedodecylphenylether), NOIGEN ES99 (monooleic acid polyethylene glycol), Dianol CME (palm oil fatty acid monoethanolamide), Dianol 300 (palm oil fatty acid monoethanoldiamide), Solgen 30 (sorbitan sesquioleate), Solgen 40 (sorbitan monooleate), Solgen 50 (sorbitan monostearate), Epan 420 (polyoxyethylenepolyoxypropylene glycol), and Epan 720 (polyoxyethylenepolyoxypropylene glycol)(all manufactured by Kao Corporation).

For the dispersing agent, preferably, the amphiphilic polymer dispersing agent is used, more preferably, non ionic amphiphilic polymer dispersing agent and anionic amphiphilic polymer dispersing agent are used, even more preferably, non ionic amphiphilic polymer dispersing agent is used, particularly preferably, pigment dispersing functional group-modified copolymer dispersing agent and urethane-based polymer dispersing agent are used.

The mixing ratio of the dispersing agent relative to the antibiotic compound is, for example, 0.1 mass % or more, preferably, 1 mass % or more, and for example, 40 mass % or less, preferably, 20 mass % or less.

The antibiotic compound in the oil phase component has an average particle size of, for example, 5 μm or less, preferably, 2.5 μm or less, and for example, 0.05 μm or more, preferably, 0.1 μm or more.

In this method, for example, at the same time with the preparation of the hydrophobic slurry, or after the preparation of the hydrophobic slurry, a polymerization initiator is blended. Preferably, after the preparation of the hydrophobic slurry, the polymerization initiator is blended in the prepared hydrophobic slurry. In such a case, the polymerizable vinyl monomer can be dividedly blended in the antibiotic compound, to be specific, a portion of the polymerizable vinyl monomer can be blended in the antibiotic compound to prepare the hydrophobic slurry, and then a polymerization initiator can be dissolved in the remaining portion of the polymerizable vinyl monomer, and then the mixture is blended in the prepared hydrophobic slurry. In this manner, an oil phase component containing a polymerization initiator and a hydrophobic slurry is prepared.

For the polymerization initiator, a radical polymerization initiator generally used in suspension polymerization is used, and to be specific, an oil-soluble polymerization initiator is used.

Examples of the oil-soluble polymerization initiator include oil-soluble organic peroxide such as dilauroyl peroxide, 1,1,3,3-tetramethylbutylperoxy-2-ethylhexanoate, t-hexylperoxy-2-ethylhexanoate, diisopropylperoxydicarbonate, and benzoyl peroxide, and oil-soluble azo compounds such as 2,2′-azobisisobutyronitrile, 2,2′-azobis(2,4-dimethylvaleronitrile), and 2,2′-azobis(2-methylbutyronitrile). Preferably, dilauroyl peroxide, t-hexylperoxy-2-ethylhexanoate, and 2,2′-azobisisobutyronitrile are used.

The polymerization initiator can be used singly or in combination of two or more.

The mixing ratio of the polymerization initiator relative to 100 parts by mass of the polymerizable vinyl monomer is, for example, 0.01 parts by mass or more, preferably, 0.1 parts by mass or more, more preferably, 0.5 parts by mass or more, and for example, 5 parts by mass or less, preferably, 3 parts by mass or less, more preferably, 1.0 part by mass or less. When the mixing ratio of the polymerization initiator is more than the above-described upper limit, the molecular weight of the polymer may be reduced excessively, and when the mixing ratio of the polymerization initiator is below the above-described lower limit, the conversion rate does not improve sufficiently, and unreacted polymerizable vinyl monomer may remain a several % or more.

### (Water Dispersion Step)

Then, the above-described oil phase component is dispersed (suspended) in water.

That is, the oil phase component and water are blended and stirred homogeneously, thereby dispersing (suspending) the oil phase component in water. A dispersion (suspension) of the oil phase component in water is produced in this manner.

Conditions for the dispersion in water are not particularly limited. For example, the dispersion in water may be performed at normal temperature, or can be performed by heating.

In dispersion of the oil phase component in water, preferably, a dispersing agent (second dispersing agent) and a surfactant (second surfactant) are blended.

Examples of the dispersing agent (second dispersing agent) include water-soluble polymers such as polyvinyl alcohol (PVA), polyvinyl pyrrolidone, gelatin, gum arabic, hydroxyethyl cellulose, hydroxypropyl cellulose, carboxymethyl cellulose, cationic starch, polyacrylic acid and its sodium salt, a styrene maleic acid copolymer and its sodium salt; and inorganic dispersing agents such as tribasic calcium phosphate, colloidal silica, montmorillonite, magnesium carbonate, aluminum hydroxide, and zinc white.

Of the dispersing agent, preferably, polyvinylalcohol (PVA) and tribasic calcium phosphate are used. Even more preferably, polyvinylalcohol (PVA) is used.

The mixing ratio of the dispersing agent relative to 100 parts by mass of the oil phase component is, for example, 0.01 parts by mass or more, preferably 0.1 parts by mass or more, more preferably 1 part by mass or more, and for example, 10 parts by mass or less, preferably, 5 parts by mass or less.

The surfactant (second surfactant) is used to effectively prevent particle coagulation during radical polymerization, preferably, in combination with the above-described dispersing agent (second dispersing agent), and examples thereof include anionic surfactants such as sodium dodecylbenzene sulphonate, sodium lauryl sulfate, sodium di-2-ethylhexyl sulfosuccinate, sodium dodecyl diphenyl ether disulphonate, sodium nonyl diphenyl ether sulfonate, and a salt of a condensate of aromatic sulfonic acid and formaldehyde; and non ionic surfactants such as polyoxyethylene lauryl ether, polyoxyethylene nonyl phenyl ether, polyoxyethylene monostearate, polyoxyethylene sorbitan monooleate, and a polyoxyethylene polyoxypropylene block copolymer. Preferably, a non ionic surfactant and an anionic surfactant, more preferably, a polyoxyethylene polyoxypropylene block copolymer and a salt of a condensate of aromatic sulfonic acid and formaldehyde are used.

The mixing ratio of the surfactant relative to 100 parts by mass of the oil phase component is, for example, 0.0001 parts by mass or more, preferably, 0.001 parts by mass or more, and for example, 1.0 part by mass or less, preferably 0.1 parts by mass or less.

The dispersing agent, or the dispersing agent and surfactant can be blended, for example, before or after blending the oil phase component in water, and preferably, blended in water before blending the oil phase component. An aqueous solution of dispersing agent or an aqueous solution of dispersing agent and surfactant are prepared in this manner.

In the above-described dispersion (suspension) of the oil phase component in water, for example, dispersers such as a homomixer (Homo Mixer), an ultrasonic homogenizer, a pressure homogenizer, Milder, and porous membrane injection disperser are used, and preferably, a homomixer is used.

The conditions for water dispersion are set suitably, and when Homo Mixer is used, the number of revolution is set to, for example, 100 rpm or more, preferably 1000 rpm or more, and for example, 10000 rpm or less, for example, 8000 rpm or less.

An aqueous dispersion in which the oil phase component is dispersed in an aqueous phase is prepared in this manner.

When the dispersing agent (second dispersing agent), or the dispersing agent and surfactant is/are blended in the aqueous dispersion, the dispersing agent or the dispersing agent and surfactant stabilize droplets of the oil phase component in the aqueous dispersion more.

The mixing ratio of the water (or aqueous solution) relative to 100 parts by mass of the oil phase component is adjusted to be, for example, 50 parts by mass or more, preferably, 100 parts by mass or more, more preferably, 150 parts by mass or more, and for example, 1900 parts by mass or less, preferably, 900 parts by mass or less, more preferably, 400 parts by mass or less.

### (Polymerization Step)

In the polymerization step, the polymerizable vinyl monomer is subjected to suspension polymerization, thereby producing a polymer. To subject the polymerizable vinyl monomer to suspension polymerization, the temperature of the aqueous dispersion is increased to a predetermined temperature. In suspension polymerization, the polymerizable vinyl monomer is allowed to react (to be specific, radical polymerization) while stirring the aqueous dispersion so as to maintain the water dispersed state of the aqueous dispersion, thereby producing a polymer of the polymerizable vinyl monomer. The suspension polymerization is an in situ polymerization, because all of the polymerizable vinyl monomer that is going to be a polymer is in water dispersion particles (hydrophobic liquid phase).

To be specific, in suspension polymerization, by heating the aqueous dispersion while stirring, the polymerizable vinyl monomer starts to polymerize as is in the water dispersion particles, thereby producing a polymer.

The stirring can be performed, for example, with a stirrer having an impeller. The stirring can be performed so that the circumferential speed of the impeller is, for example, 10 m/min or more, preferably, 20 m/min or more, and 400 m/min or less, preferably 200 m/min or less.

The aqueous dispersion is heated so that its temperature is, for example, 40° C. or more, preferably, 50° C. or more, more preferably, 60° C. or more, and for example, 100° C. or less, preferably, 90° C. or less, more preferably, 80° C. or less.

Then, suspension polymerization progresses while the antibiotic compound is in non-miscible state with the polymer.

The heating time is, for example, 2 hours or more, preferably, 3 hours or more, and for example, 12 hours or less, preferably, 8 hours or less. Furthermore, the heating can also be carried out in stages: after heating to a predetermined temperature, the temperature is kept for a predetermined time period, and thereafter, the heating and the temperature keeping is repeated.

In suspension polymerization, the antibiotic compound is substantially insoluble to the polymerizable vinyl monomer, and the antibiotic compound maintains the non-miscible state to the polymerizable vinyl monomer and/or polymer from the start of polymerization to after polymerization.

Thereafter, the aqueous dispersion after polymerization is cooled, for example, by allowing the aqueous dispersion after polymerization to stand to cool and filtering with filter cloth of 100 mesh, and an aqueous dispersion (suspension) of controlled release particles is obtained.

The cooling temperature is, for example, room temperature (20 to 30° C., to be more specific, 25° C.).

The produced controlled release particles have an antibiotic compound concentration of, for example, 1 mass % or more, preferably, 5 mass % or more, more preferably, 10 mass % or more, and for example, 50 mass % or less, preferably, 40 mass % or less, more preferably, 35 mass % or less.

The controlled release particles content in the suspension is determined by the blending amounts of the oil phase component and the water (or aqueous solution) in which it is dispersed, to be specific, for example, 10 mass % or more, preferably, 20 mass % or more, and for example, 50 mass % or less, preferably, 40 mass % or less.

The controlled release particles have an average particle size of, for example, 1 μm or more, preferably, 2 μm or more, and for example, 20 mm or less, preferably, 10 mm or less. The average particle size is calculated as median size/diameter.

The controlled release particles produced by the above-described method for producing controlled release particles have a two-phase structure formed from a matrix and a domain dispersed in the matrix, both to be described later.

As necessary, known additives such as other dispersing agents, a thickening agent, an antifreezing agent, an antiseptic, a microbial growth inhibitor, and a specific gravity adjuster can be added suitably to the aqueous dispersion (suspension) containing the controlled release particles produced by the above-described production method.

The thus produced controlled release particles may be used as is (suspension), that is, may be used as a suspending agent. Alternatively, the thus produced controlled release particles may be spray-dried and directly used as a powder formulation. Alternatively, the thus produced controlled release particles may be formulated into a known form such as powder formulation or granular formulation, subjecting to solid-liquid separation by, for example, centrifugal separation and filter pressing, and as necessary, after washing, for example, dried by, for example, fluid bed drying and shelf drying, and as necessary, crushed with, for example, atomizer and feather mill, and classified with a vibrating sieve.

To formulate the controlled release particles into powder formulation, for example, the suspension of the controlled release particles is blended with a solid carrier and the mixture is stirred, and thereafter, the mixture is dried (powder formulation step). That is, the method for producing controlled release particles can further include, in addition to the oil phase component preparation step, water dispersion step, and polymerization step, a powder formulation step.

Examples of the solid carrier include pumice, bentonite, clay, kaolin, talc, acid clay, zeolite, vermiculite, pearlite, calcium carbonate, and silica sand. For the solid carrier, preferably, pumice is used. For the solid carrier, a commercially available product can be used. To be specific, KAGALITE series products (fine grain of natural pumice, manufactured by KAGALITE KOGYO CO., LTD.) are used. The solid carrier has an average particle size of, for example, 100 μm or more, preferably, 300 μm or more, and for example, 5.00 mm or less, preferably, 2.00 mm or less.

In the powder formulation step, the mixing ratio of the suspension of the controlled release particles is adjusted such that the produced powder formulation (solid carrier and controlled release particles) has an antibiotic compound concentration of, for example, 0.01 mass % or more, preferably, 0.05 mass % or more, and for example, 2 mass % or less, preferably, 1 mass % or less. To be specific, the mixing ratio of the suspension (including water) of the controlled release particles relative to 100 parts by mass of the solid carrier is, for example, 0.01 parts by mass or more, preferably, 0.05 parts by mass or more, more preferably, 0.1 parts by mass or more, even more preferably, 0.2 parts by mass or more, and for example, 10 parts by mass or less, preferably, 5 parts by mass or less.

### <Effects of Controlled Release Particles of the First Invention Group>

The controlled release particles of the first invention group are produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer, and therefore durable controlled release particles with excellent controlled release properties can be produced.

However, the microcapsule produced by the method described in Patent Document 1 is produced only by interfacial polymerization, and the disperse medium (solvent) remains in the microcapsule. Therefore, its surface hardness may be insufficient. As a result, when the dispersion liquid of the microcapsule undergoes a step in which a high shearing force is applied or is stored for a long period of time, the microcapsule may coagulate and redispersion may be difficult.

Furthermore, because of insufficient surface hardness of the microcapsule, the microcapsule easily undergoes blocking, and it may become difficult to take out the microcapsule as dried particles.

Meanwhile, the controlled release particles of the first invention group are produced by a production method including an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer, and therefore the above-described interfacial reduction in surface hardness of the controlled release particles, caused by the presence of solvent in polymerization, is prevented, durable controlled release particles can be produced, and the produced controlled release particles can be redispersed excellently and has excellent resistance to blocking.

With the method for producing controlled release particles, the controlled release particles that are durable, and are excellent in redispersiveness and resistance to blocking can be produced.

Such controlled release particles can be applied to various industrial products, and can be added to, for example, indoor/outdoor paint, rubber, fiber, resin (including plastic), adhesive, joint mixture, sealing agent, building material, caulking agent, wood treatment agent, soil treating agent, white water in paper-making processes, pigment, treatment liquid for printing plates, cooling water, ink, cutting oil, cosmetic products, nonwoven fabric, spinning oil, and leather. The amount of the antibiotic compound added in the controlled release particles for these industrial products is, for example, 10 mg/kg to 100 g/kg (product weight).

Next, description is given below of an embodiment in which the powder formulation formulated from the controlled release particles is blended with the thermoplastic resin.

In this method, first, the suspension of the controlled release particles is dried and formulated into powder formulation.

Then, the powder formulation and thermoplastic resin are melt-kneaded, thereby preparing a kneaded material.

To prepare the kneaded material, for example, to be specific, an extruder or Banbury mixer is used. Examples of the extruder include biaxial extruder and uniaxial extruder. The kneaded material is a molding material for molding a molded article. To be specific, the kneaded material is cooled once and prepared as a pelletized molding material (kneaded material pellet, or master batch). In contrast, the kneaded material can be continuously subjected to molding to be described later as is in the melted state without taking out as a solid molding material (melt-kneaded material).

The powder formulation is blended with the thermoplastic resin so that the antibiotic compound content relative to the thermoplastic resin is, for example, 0.01 mass % or more, preferably, 0.1 mass % or more, and for example, 10 mass % or less, preferably, 3 mass % or less. However, when the kneaded material is prepared as master batch, the above does not apply. To be specific, the powder formulation is blended with the thermoplastic resin so that the antibiotic compound content relative to the thermoplastic resin is, for example, 1 mass % or more, preferably, 5 mass % or more, and for example, 50 mass % or less, preferably, 30 mass % or less, thereby producing a master batch.

The thermoplastic resin is not particularly limited, and examples thereof include polyolefin resins such as polyethylene and polypropylene; polystyrene and/or polyacrylic resin such as polystyrene, or polymethyl methacrylate, acrylonitrile-styrene copolymer resin (AS resin), methyl methacrylate-styrene copolymer (MS resin), and acrylonitrile-styrene-butadiene copolymer resin (ABS resin); polyester resins such as polyethylene terephthalate and polylactic acid; polyamide resins such as 6-nylon; vinyl halide resins such as vinyl chloride resin and vinylidene chloride resin; polycarbonate; polyphenylene ether; polyacetal; and thermoplastic polyurethane. The thermoplastic resin can be used singly, or can be used in combination. Preferably, polyolefin resin, vinyl chloride resin, thermoplastic polyurethane, more preferably, polyolefin resin, vinyl chloride resin, even more preferably, polyethylene and polypropylene are used.

Then, the kneaded material pellet, or the melt-kneaded material is molded into a molded article.

For the molding method, for example, injection molding, extrusion molding, inflation molding, pultrusion molding, and compression molding are used.

In this manner, a molded article molded into a predetermined shape and to which powder formulation (controlled release particles) is added is produced.

In the description above, powder formulation formulated from the controlled release particles is added to the thermoplastic resin. However, it is not particularly limited as long as it is resin, and for example, it can be added to the thermosetting resin.

In particular, the powder formulation can be suitably added to a resin such as epoxy resin and silicone resin in liquid state.

Such a molded article is used in various use, and is used as, for example, building material; for example, electric wire cable material and covering material for the electric wire cable; for example, pipes for gas and a covering material for the pipe; and for example, textile goods such as garments and a mosquito net.

### <Effects of Molded Article of the First Invention Group>

In such a molded article, the controlled release particles of powder formulation have a durable two-phase structure formed from the matrix and the domain, are not damaged when the powder formulation is kneaded and molded, and are dispersed in the molded article or localized on the surface. In a molded article to which the above-described powder formulation is added, the antibiotic compound is released excellently with control. In other words, the above-described molding material contains the above-described controlled release particles, and therefore the above-described controlled release particles are dispersed in the above-described molded article localized on the surface, and can provide excellent controlled release of the antibiotic compound to the molded article.

Furthermore, by forming controlled release particles into beads having a diameter of 1 mm to 20 mm, and by setting/providing/fixing the beads in a distribution channel of fluid (gas and liquid), antibiotic effects such as sterilization can be given to the passing fluid steadily.

The controlled release particles produced by the above-described method for producing controlled release particles include, to be specific, the controlled release particles of the first embodiment and the second embodiment to be described next.

### First Embodiment

The controlled release particles in the first embodiment are described with reference to FIG. A1.

As shown in the cross-sectional view of FIG. A1, controlled release particles 1 are formed, for example, as spherical particles. The controlled release particles 1 have a two-phase structure formed from a matrix 2, and a domain 3 dispersed in the matrix 2. The matrix 2 is made of a polymer produced from the above-described polymerizable vinyl monomer. The domain 3 is made of the above-described antibiotic compound.

To be specific, in the controlled release particles 1, the matrix 2 forms a medium or a continuous phase, and a multidomain structure or a sea-island structure (or polynuclear structure) in which a plurality of domains 3 are scattered in isolation is formed. Furthermore, in the controlled release particles 1, the matrix 2 and the domain 3 are immiscible to each other, and form a phase separation structure separating from each other.

The matrix 2 is in a region other than the domain 3 in the controlled release particles 1, and is formed into a shape that complements domain 3.

The plurality of domains 3 form a dispersion phase in the matrix 2. The shape of the domain 3 is not particularly limited, and is formed, for example, suitably into a shape such as an amorphous shape, spherical, bulk shape, and plate shape. The domain 3 has an average maximum length of, for example, 0.05 μm or more, preferably, 0.1 μm or more, and for example, 20 μm or less, preferably, 10 μm or less.

Furthermore, the domain 3 includes a projection 4 that projects from the inside to the outside of the matrix 2. The projection 4 is exposed from the surface of the matrix 2. In this manner, at the surface of the controlled release particles 1, both of the matrix 2 and the domain 3 are exposed. The projection 4 includes an embedded portion 8 embedded in the outer layer portion of the matrix 2. The projection 4 functions to increase the initial controlled-release speed of the antibiotic compound of the controlled release particles 1, and to significantly increase resistance to blocking of the controlled release particles 1. The exposure percentage (that is, exposure percentage of the domain 3) of the projection 4 relative to the entire surface of the matrix 2 is, relative to the entire surface of the controlled release particles 1, for example, 0.1% or more, preferably, 1% or more, and for example, 50% or less, preferably, 30% or less. The exposure percentage of the matrix 2 is obtained by deducting the exposure percentage of the projection 4 from the entire surface of the controlled release particles 1.

The surface of the controlled release particles 1 has a hole 6, which is formed by a portion of the domain 3 eliminated (fell off) from the matrix 2. The hole 6 is formed so as to correspond to the shape of the antibiotic compound forming the domain 3.

To produce the controlled release particles 1, in the above-described production method of the controlled release particles 1, particularly in the oil phase component preparation step, (meth)acrylate monomer and (meth)acrylate crosslinkable monomer are not used as the polymerizable vinyl monomer, and in the water dispersion step, preferably, a salt of a condensate of aromatic sulfonic acid and formaldehyde is not blended as the surfactant (second surfactant).

In the oil phase component preparation step, for the polymerizable vinyl monomer, preferably, a combination of an aromatic vinyl monomer and an aromatic crosslinkable monomer is used.

When the polymerizable vinyl monomer is a combination of the aromatic vinyl monomer and the aromatic crosslinkable monomer, the aromatic vinyl monomer content relative to 100 parts by mass of a total amount of the aromatic vinyl monomer and the aromatic crosslinkable monomer is, for example, 10 parts by mass or more, preferably, 20 parts by mass or more, more preferably, 30 parts by mass or more, and for example, 90 parts by mass or less, preferably, 80 parts by mass or less, more preferably, 70 parts by mass or less.

In the water dispersion step, a salt of a condensate of aromatic sulfonic acid and formaldehyde is not blended as the surfactant (second surfactant), but preferably, a dispersing agent (second dispersing agent) is blended.

### <Effects of First Embodiment>

In the method for producing controlled release particles for producing the controlled release particles in the first embodiment, in the oil phase component preparation step, (meth)acrylate monomer and (meth)acrylate crosslinkable monomer are not used as the polymerizable vinyl monomer, and in the water dispersion step, a salt of a condensate of aromatic sulfonic acid and formaldehyde is not blended, and then in the polymerization step, the above-described polymerizable vinyl monomer is subjected to suspension polymerization, and therefore the projection 4 can be formed reliably.

On the surface of the controlled release particles 1, both of the matrix 2 and the domain 3 are exposed. In particular, on the surface of the controlled release particles 1, the antibiotic compound is exposed so as to protrude to the outside, thereby forming the projection 4. The controlled release particles 1 have a two-phase structure formed from the matrix 2 and the domain 3, and do not have a shell.

Furthermore, in the controlled release particles 1, the projection 4 is exposed from the matrix 2, and therefore the projection 4 allows for more improvement in resistance to blocking.

Furthermore, in the controlled release particles 1, the antibiotic compound forming the exposed projection 4 can start controlled release from the initial period, and when the projection 4 falls off, the initial controlled-release speed of the antibiotic compound accelerates furthermore, and therefore the initial controlled-release speed of the antibiotic compound can be made faster to adjust the controlled-release speed of the antibiotic compound.

As shown in FIG. A1, the controlled release particles 1 have a two-phase structure formed from a matrix 2 made of a polymer and a domain 3 made of an antibiotic compound and dispersed in the matrix 2, and therefore the antibiotic compound has excellent controlled release properties and excellent durability. Therefore, the controlled release particles can be excellently kneaded with resin as described above.

### Second Embodiment

The controlled release particles in the second embodiment are described with reference to FIG. A2.

As shown in the cross-sectional view of FIG. A2, on the surface of the controlled release particle 1, the domain 3 is not exposed, and all of the domains 3 are enclosed in the matrix 2. That is, in the controlled release particles 1, the antibiotic compound that forms the domain 3 is covered and protected by the matrix 2.

On the surface of the matrix 2 of the controlled release particles 1, for example, the antibiotic compound is attached. To be specific, an attachment 5 made of the antibiotic compound is attached so as to cover entirely or portion of the entire surface of the matrix 2. The attachment 5 is different from the projection 4 of the controlled release particles 1 (ref: FIG. A1) of the first embodiment, does not have the embedded portion 8, and is in contact with the surface of the matrix 2. The shape of the attachment 5 is not particularly limited, and for example, suitably formed into a shape such as an amorphous shape, spherical, bulk shape, and plate shape. In particular, the internal face (contact face making contact with the surface of the matrix 2) of the attachment 5 has a concave surface corresponding to the surface (spherical surface) of the matrix 2, to be specific, has a bent surface sunken externally. The attachment 5 has the same size as that of the domain 3 or smaller, relative to the average value of the maximum length of the domain 3, for example, 100% or less, preferably, 50% or less, and for example, 0.01% or more, and to be specific, the average value of the maximum length of the attachment 5 is, for example, 10 μm or less, preferably, 5 μm or less, for example, 0.05 μm or more, preferably, 0.1 μm or more. The covering percentage of the attachment 5 relative to the entire surface of the matrix 2 is, for example, 10% or more, preferably, 20% or more, and for example, 100% or less, preferably, 90% or less.

To produce the controlled release particles 1, in the water dispersion step of the above-described production method of the controlled release particles 1, a salt of a condensate of aromatic sulfonic acid and formaldehyde is blended as a surfactant (second surfactant), and/or in the oil phase component preparation step, (meth)acrylate monomer and (meth)acrylate crosslinkable monomer are blended as the polymerizable vinyl monomer.

The second surfactant is preferably used in combination with the above-described second dispersing agent.

Examples of the aromatic sulfonic acid include benzene sulfonic acid, toluene sulfonic acid, cumene sulfonic acid, and naphthalene sulfonic acid. Preferably, naphthalene sulfonic acids such as α-naphthalene sulfonic acid and β-naphthalene sulfonic acid are used.

For cation forming the salt, for example, monovalent cation is used. Examples of the monovalent cation include alkali metal cation such as sodium cation and potassium cation, and ammonium cation. Preferably, alkali metal cation is used.

Examples of the salt of a condensate of aromatic sulfonic acid and formaldehyde include, to be specific, a salt of a condensate of naphthalene sulfonic acid and formaldehyde (naphthalene sulfonic acid formaldehyde condensate sodium salt). For the salt of a condensate of aromatic sulfonic acid and formaldehyde, a commercially available product can be used, to be specific, DEMOL NL (β-naphthalene sulfonic acid formaldehyde condensate sodium salt, 41% aqueous solution, manufactured by Kao Corporation) may be used.

The mixing ratio of the salt of a condensate of aromatic sulfonic acid and formaldehyde relative to 100 parts by mass of the hydrophobic slurry is, for example, 0.0001 parts by mass or more, preferably, 0.001 parts by mass or more, and for example, 1.0 part by mass or less, preferably, 0.2 parts by mass or less, more preferably, 0.1 parts by mass or less.

The polymerizable vinyl monomer has a (meth)acrylate crosslinkable monomer content of, for example, 10 mass % or more, preferably, 30 mass % or more, and for example, 100 mass % or less.

Because the polymerizable vinyl monomer contains the (meth)acrylate monomer and (meth)acrylate crosslinkable monomer, the polymer has a crosslinking structure, in which the polymer of the (meth)acrylate monomer is crosslinked by the (meth)acrylate-based crosslinkable monomer or its polymer.

### <Effects of Second Embodiment>

In the method for producing controlled release particles for producing the controlled release particles in the second embodiment, in the water dispersion step, a salt of a condensate of aromatic sulfonic acid and formaldehyde is blended, and/or in the oil phase component preparation step, (meth)acrylate monomer and (meth)acrylate crosslinkable monomer are used as the polymerizable vinyl monomer, and in the polymerization step, (meth)acrylate monomer and (meth)acrylate crosslinkable monomer are subjected to suspension polymerization. Therefore, exposure of the domain 3 made of an antibiotic compound on the surface of the controlled release particles 1 can be suppressed (ref: FIG. A1). That is, as shown in FIG. A2, the domain 3 can be covered with and protected by the matrix 2.

Furthermore, in the polymerization step, when the polymerizable vinyl monomer is subjected to suspension polymerization in the presence of a salt of a condensate of naphthalene sulfonic acid and formaldehyde (preferably, naphthalenesulfonic acid sodium salt), the interface between the suspension polymer and water continuous phase in the polymerization step is more stabilized, and therefore leakage of the antibiotic compound to the outside of the controlled release particles can be suppressed. As a result, based on the ratio of the salt of a condensate of naphthalene sulfonic acid and formaldehyde, controlled release properties of the antibiotic compound in the controlled release particles can be adjusted.

Furthermore, in the polymerization step, when (meth)acrylate monomer and (meth)acrylate crosslinkable monomer are subjected to suspension polymerization, and the antibiotic compound particles are dispersed and stabilized in the oil phase, and therefore leakage of the antibiotic compound to outside the controlled release particles can be suppressed. As a result, by using the (meth)acrylate monomer and (meth)acrylate crosslinkable monomer as the polymerizable vinyl monomer, controlled release properties of the antibiotic compound in the controlled release particles can be adjusted.

To be specific, in the controlled release particles produced by the above-described method for producing controlled release particles including the water dispersion step, as shown in FIG. A2, the domain 3 can be covered with the matrix 2, and the attachment 5 can be allowed to adhere to the surface of the matrix 2. Therefore, the controlled release particles 1 of the second embodiment are excellent in resistance to blocking based on the attachment 5. Furthermore, with the attachment 5, the initial controlled-release speed of the antibiotic compound can be made faster, and the controlled-release speed of the antibiotic compound can be adjusted.

Then, as shown in FIG. A2, in the second embodiment, although the attachment 5 is attached to the surface of the matrix 2, the domain 3 is covered with the matrix 2, and therefore compared with the controlled release particles 1 (ref: FIG. A1) including the projection 4 of the first embodiment, alkali-resistance is excellent. That is, with the controlled release particles 1 of the second embodiment, compared with the controlled release particles 1 of the first embodiment, even if it is stored in an alkaline aqueous solution, it can suppress reduction in the antibiotic compound concentration based on the projection 4 in the controlled release particles.

### <Modified Example of Second Embodiment>

As shown in FIG. A3, the entire surface of the matrix 2 can be exposed without attaching the attachment 5 to the surface of the matrix 2.

### [Second Invention Group]

### <Description of Method for Producing Controlled Release Particles>

The method for producing controlled release particles of the second invention group is described.

A production method of controlled release particles includes an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent, a water dispersion step in which the oil phase component is dispersed in water to prepare an aqueous dispersion, and a polymerization step in which the polymerizable vinyl monomer is subjected to suspension polymerization to produce a polymer. In the method for producing controlled release particles, in any of at least one step of the oil phase component preparation step, water dispersion step, and polymerization step, a hydrophobic shell-forming component and a hydrophilic-shell forming component are blended.

In the method for producing controlled release particles, preferably, in the oil phase component preparation step, a hydrophobic slurry is prepared by dispersing the antibiotic compound in a polymerizable vinyl monomer, and then the hydrophobic slurry and a hydrophobic shell-forming component are blended, thereby preparing an oil phase component containing the hydrophobic slurry and the hydrophobic shell-forming component. Furthermore, in the method for producing controlled release particles, preferably, in any of at least one step of the water dispersion step and the polymerization step, hydrophilic shell-forming component are blended, more preferably, in the polymerization step, the hydrophilic shell-forming component is blended.

In the following, the above-described antibiotic compound, polymerizable vinyl monomer, hydrophobic shell-forming component and hydrophilic-shell forming component are described in sequence.

### (Antibiotic Compound)

The antibiotic compound is selected from, for example, an insecticide (including formicide), an insect repellent (including anti-termite agent), a sterilizer, an antibacterial agent, an antiseptic, a herbicide, an antialgae, a fungicide, an attractant, a repellent, and a rodenticide, having antibiotic activity such as, for example, insecticidal (including formicide), insect repellent (including anti-termite), sterilization, antibacterial, antiseptic, herbicidal, antialgae, and fungicidal activities.

To be specific, examples of the antibiotic compound include the following. Examples of insecticides include neonicotinoid-based insecticides such as clothianidin ((E)-1-(2-chlorothiazole-5-ylmethyl)-3-methyl-2-nitroguanidine), imidacloprid (1-(6-chloro-3-pyridylmethyl)-N-nitroimidazolidin-2-ylideneamine), thiacloprid, thiamethoxam ((EZ)-3-(2-chloro-1,3-thiazole-5-ylmethyl)-5-methyl-1,3,5-oxadiazinan-4-ylidene(nitro)amine), and dinotefuran; diamide-based insecticides such as flubendiamide and chlorantraniliprol; insect growth regulators such as diflubenzuron, teflubenzuron, chlorfluazuron, tebufenozide, methoxyfenozide, and cyromazine; acaricides such as clofentezine; and other synthetic agents such as pymetrozine and sodium oleate. Examples of the sterilizer include copper-based sterilizers such as basic copper chloride, basic copper sulfate, and oxine-copper; silver-based sterilizers such as metal silver; organic sulfur-based sterilizers such as polycarbamate; melanin biosynthesis inhibitors such as fthalid and tricyclazole; benzimidazole-based sterilizers such as thiophanate-methyl, carbendazim (MBC), and diethofencarb; acid amide-based sterilizers such as isotianil; sterol biosynthesis inhibitors such as triforine; isothiazolone-based sterilizers such as 1,2-benzisothiazolin-3-one; and other synthesis inhibitors such as diclomezine, fluoroimide, captan, chlorothalonil, chinomethionat, oxolinic acid, benthiavalicarb-isopropyl, cyazofamid, and zinc pyrithione. Examples of the herbicide-antialgae include urea-based agents such as 3-(3,4-dichlorophenyl)-1,1-dimethylurea (DCMU), cumyluron, and karbutilate; sulfonylurea-based agents such as ethoxysulfuron, halosulfuron-methyl, flazasulfron, nicosulfuron, thifensulfuron-methyl, imazosulfuron, cyclosulfamuron, flucetosulfuron, and trifloxysulfuron-sodium salt; triazine-based agents such as simazine (CAT), atrazine, triaziflam, lenacil, cyfluthrin, and terbutryn; amino acid-based agents such as glyphosate; phenylphthalimide-based agents such as flumioxazin; triketone-based agents such as mesotrione; and other agents such as quinoclamin and pyriftalid. For the antibiotic compound, preferably, in view of chemo selectivity and safety, neonicotinoid-based insecticides, and in view of versatility and effectiveness, zinc pyrithione is used, more preferably, in view of insolubility, clothianidin, imidacloprid, zinc pyrithione are used, even more preferably, clothianidin and imidacloprid are used. Particularly preferably, in view of safety for mammals, clothianidin is used.

The antibiotic compound is substantially insoluble to the polymerizable vinyl monomer. To be specific, for example, the antibiotic compound has an extremely low solubility to the polymerizable vinyl monomer at room temperature (20 to 30° C., to be more specific, 25° C.). To be specific, the antibiotic compound has a solubility at room temperature of, for example, 0.1 part by mass/100 parts by volume of the polymerizable vinyl monomer (to be used)(mixture)(1 g/L) or less, preferably, 0.05 parts by mass/100 parts by volume of the polymerizable vinyl monomer (to be used)(mixture)(0.5 g/L) or less.

The antibiotic compound is substantially insoluble to the polymerizable vinyl monomer. To be specific, for example, the antibiotic compound has an extremely low solubility to the polymerizable vinyl monomer at room temperature (20 to 30° C., to be more specific, 25° C.). To be specific, the antibiotic compound has a solubility at room temperature of, for example, 0.1 part by mass/100 parts by volume of the polymerizable vinyl monomer (to be used) (mixture) (1 g/L) or less, preferably, 0.05 parts by mass/100 parts by volume of the polymerizable vinyl monomer (to be used) (mixture) (0.5 g/L) or less.

The antibiotic compound has a melting point of, for example, 80° C. or more, preferably, 100° C. or more, and when the antibiotic compound is a compound that does not contain metal atoms, for example, 300° C. or less.

### (Polymerizable Vinyl Monomer)

Examples of the polymerizable vinyl monomer include a (meth)acrylate monomer, an aromatic vinyl monomer, a vinyl ester monomer, a maleate monomer, a vinyl halide, a vinylidene halide, a nitrogen-containing vinyl monomer, and a crosslinkable monomer.

Examples of the (meth)acrylate monomer include methacrylate and/or acrylate, to be specific, alkyl (meth)acrylate having a straight chain, branched, or cyclic alkyl moiety with 1 to 6 carbon atoms such as methyl (meth)acrylate, ethyl (meth)acrylate, n-propyl (meth)acrylate, isopropyl (meth)acrylate, (meth)n-butyl acrylate, isobutyl (meth)acrylate (i-BMA/i-BA), tert-butyl (meth)acrylate, n-pentyl (meth)acrylate, n-hexyl (meth)acrylate, and cyclohexyl (meth)acrylate; (meth)acrylic acid alkoxyalkyl ester such as 2-methoxyethyl (meth)acrylate; (meth)acrylic acidhydroxyalkyl such as (meth)acrylic acidhydroxyethyl; epoxy group-containing (meth)acrylates such as glycidyl (meth)acrylate. Preferably, alkyl (meth)acrylate is used.

For the alkyl (meth)acrylate, more preferably, alkyl (meth)acrylate having an alkyl moiety with 1 to 6 carbon atoms, particularly preferably, isobutyl methacrylate (i-BMA) is used.

Examples of the aromatic vinyl monomer include styrene monomers (monovinylbenzene) such as styrene (vinylbenzene), p-methylstyrene, o-methylstyrene, α-methylstyrene, and ethylvinylbenzene. Preferably, styrene and ethylvinylbenzene are used.

Examples of the vinyl ester monomer include vinyl acetate and vinyl propionate.

Examples of the maleate monomer include dimethyl maleate, diethyl maleate, and dibutyl maleate.

Examples of the vinyl halide include vinyl chloride and vinyl fluoride.

Examples of the vinylidene halide include vinylidene chloride and vinylidene fluoride.

Examples of the nitrogen-containing vinyl monomer include (meth)acrylonitrile, N-phenylmaleimide, and vinylpyridine.

Examples of the crosslinkable monomer include (meth)acrylate crosslinkable monomers, allyl monomers, and aromatic crosslinkable monomers. Examples of the (meth)acrylate crosslinkable monomer include mono or polyethylene glycoldi(meth)acrylate such as ethylene glycoldi(meth)acrylate and diethylene glycoldi(meth)acrylate; alkane diol di(meth)acrylate such as 1,3-propanedioldi(meth)acrylate, 1,4-butanedioldi(meth)acrylate, and 1,5-pentanedioldi(meth)acrylate; and alkane polyol poly(meth)acrylate such as trimethylolpropanetri(meth)acrylate and pentaerythritoltetra(meth)acrylate (PETA/PETM). Examples of the allyl monomer include allyl(meth)methacrylate and triallyl(iso)cyanurate. Examples of the aromatic crosslinkable monomer include divinylbenzene and trivinylbenzene. Preferably, mono or polyethylene glycoldi(meth)acrylate and divinylbenzene, more preferably, ethylene glycoldi(meth)acrylate and divinylbenzene are used.

The polymerizable vinyl monomer can be used singly, or can be used in combination.

For the polymerizable vinyl monomer, preferably, a combination of (meth)acrylate monomer and a crosslinkable monomer, and a combination of an aromatic vinyl monomer and a crosslinkable monomer is used.

When the polymerizable vinyl monomer is a combination of a (meth)acrylate monomer and a crosslinkable monomer, the (meth)acrylate monomer content relative to 100 parts by mass of a total of the (meth)acrylate monomer and the crosslinkable monomer is, for example, 10 parts by mass or more, preferably, 20 parts by mass or more, more preferably, 30 parts by mass or more, and for example, 90 parts by mass or less, preferably, 80 parts by mass or less, more preferably, 70 parts by mass or less. When the polymerizable vinyl monomer is a combination of the aromatic vinyl monomer and the crosslinkable monomer, the mixing ratio of the aromatic vinyl monomer relative to 100 parts by mass of a total of the aromatic vinyl monomer and the crosslinkable monomer is, for example, 10 parts by mass or more, preferably, 20 parts by mass or more, more preferably, 30 parts by mass or more, and for example, 90 parts by mass or less, preferably, 80 parts by mass or less, more preferably, 70 parts by mass or less.

The polymer produced by polymerization of the polymerizable vinyl monomer has durable surface at room temperature, and therefore has a glass transition temperature of, for example, 30° C. or more, preferably, 50° C. or more, and the polymerizable vinyl monomer is selected to give such a glass transition temperature.

The polymerizable vinyl monomer is, for example, substantially hydrophobic. To be specific, the polymerizable vinyl monomer has an extremely low solubility to, for example, water at room temperature. To be more specific, the polymerizable vinyl monomer has a solubility at room temperature of, for example, 10 parts by mass/100 parts by volume of water (100 g/L) or less, preferably, 8 parts by mass/100 parts by volume of water (80 g/L) or less. When different kinds of polymerizable vinyl monomers are used, the entire polymerizable vinyl monomer (that is, mixture of different kinds of polymerizable vinyl monomers) is substantially hydrophobic.

### (Hydrophobic Shell-Forming Component and Hydrophilic-Shell Forming Component)

The hydrophobic shell-forming component and the hydrophilic-shell forming component are two components that react by polyaddition or polycondensation (condensation polymerization) and are different from each other.

The hydrophobic shell-forming component is, for example, substantially hydrophobic, to be specific, has an extremely low solubility to water at room temperature, to be more specific, for example, has a solubility at room temperature of, 1 part by mass/100 parts by volume of water (10 g/L) or less, preferably, 0.5 parts by mass/100 parts by volume of water (5 g/L) or less, more preferably, 0.1 parts by mass/100 parts by volume of water (1 g/L) or less.

The hydrophobic shell-forming component is an oil-soluble compound that forms a shell by polyaddition or polycondensation with the hydrophilic shell-forming component, and examples thereof include polyisocyanate, polycarboxylic acid chloride, and polysulfonate chloride.

Examples of the polyisocyanate include aromatic polyisocyanate (aromatic diisocyanate) such as diphenylmethane diisocyanate, and toluenediisocyanate; aliphatic polyisocyanate (aliphatic diisocyanate) such as hexamethylene diisocyanate; alicyclic polyisocyanate (alicyclic diisocyanate) such as isophorone diisocyanate (IPDI), hydrogenated xylylenediisocyanate, and hydrogenated diphenylmethane diisocyanate; and aralkyl polyisocyanate (aralkyl diisocyanate) such as xylylenediisocyanate and tetramethylxylylenediisocyanate.

Examples of the polyisocyanate also include multimers of the above-described polyisocyanate, to be specific, dimers, trimers (isocyanurate group-containing polyisocyanate, cyclic trimer), pentamers, and septamers. Preferably, trimer, to be specific, an IPDI trimer is used.

Furthermore, examples also include modified polyisocyanates of the above-described polyisocyanates (excluding multimers) including polyol modified polyisocyanate such as an IPDI adduct of trimethylolpropane.

Examples of the polycarboxylic acid chloride include sebacic acid dichloride, adipic acid dichloride, azelaic acid dichloride, terephthalic acid dichloride, and trimesic acid dichloride.

Examples of polysulfonic acid chloride include benzenesulfonyl dichloride.

The hydrophobic shell-forming component can be used singly, or can be used in combination.

For the hydrophobic shell-forming component, preferably, polyisocyanate, more preferably, a cyclic trimer of diisocyanate, and a trimethylolpropane adduct are used.

The hydrophilic shell-forming component is a water-soluble compound that is present in the aqueous phase before the interfacial polymerization. The hydrophilic shell-forming component is an active hydrogen group-containing compound, and the active hydrogen group-containing compound includes a compound having an active hydrogen group such as an amino group and a hydroxyl group, and to be specific, examples include polyamine, polyol, and water.

Examples of the polyamine include diamines such as ethylene diamine, propylene diamine, hexamethylene diamine, diaminotoluene, phenylene diamine, and piperazine; and polyamine having a valency of 3 or more such as diethylene triamine, triethylenetetramine, tetraethylene, pentamine, and pentaethylenehexamine. Preferably, polyamine with a valency of 3 or more, more preferably, diethylene triamine is used.

Examples of polyol include diols such as ethylene glycol, propanediol, 1,4-butanediol, 1,6-hexanediol, neopentyl glycol, diethylene glycol, triethylene glycol, dipropylene glycol, cyclohexanedimethanol, polyethylene glycol, and polypropylene glycol; triols such as glycerine, and trimethylolpropane; and tetraol such as pentaerythritol.

The hydrophilic shell-forming component can be used singly, or can be used in combination.

For the hydrophilic shell-forming component, preferably, polyamine and polyol, more preferably, polyamine is used.

Next, an oil phase component preparation step, a water dispersion step, and a polymerization step are described in sequence.

### (Oil Phase Component Preparation Step)

In the oil phase component preparation step, without the presence of a solvent, a hydrophobic slurry is prepared by dispersing, in a hydrophobic polymerizable vinyl monomer, an antibiotic compound that is hydrophobic and is substantially insoluble to the hydrophobic polymerizable vinyl monomer, and then the hydrophobic slurry and a hydrophobic shell-forming component are blended, thereby preparing an oil phase component containing the hydrophobic slurry and the hydrophobic shell-forming component.

To be specific, first, the above-described polymerizable vinyl monomer and the antibiotic compound are blended, and stirred without blending a solvent (hydrophobic organic solvent such as hexane, toluene, and ethyl acetate). A hydrophobic slurry is prepared in this manner. The hydrophobic slurry is contained in the oil phase component.

To disperse the antibiotic compound in the polymerizable vinyl monomer, for example, a disperser such as a paint shaker, a homodisper (high-speed disperser), a bead mill (including batch type bead mill), a ball mill, and a rod mill are used. The disperser can be used singly, or can be used in combination. For the disperser, preferably, in view of the fact that it can be used for a wide range of viscosity, and can be used for a large-scale industrial production, a batch type bead mill is used.

The above-described dispersion allows for wet grinding of the antibiotic compound.

The mixing ratio of the antibiotic compound relative to the polymerizable vinyl monomer based on the mass ratio (that is, parts by mass of the antibiotic compound/parts by mass of the polymerizable vinyl monomer) is, for example, 1/99 or more, preferably 10/90 or more, more preferably 15/85 or more, and for example, 90/10 or less, preferably, 75/25 or less, more preferably, 70/30 or less, even more preferably, 65/35 or less, and particularly preferably, 60/40 or less.

The mixing ratio of the antibiotic compound relative to 100 parts by mass of the polymerizable vinyl monomer is, for example, 1 part by mass or more, preferably, 10 part by mass or more, more preferably, 20 parts by mass or more, and for example, 900 parts by mass or less, preferably, 300 parts by mass or less, more preferably, 200 parts by mass or less, even more preferably, 150 parts by mass or less.

In the above-described dispersion, as necessary, a dispersing agent (a first dispersing agent) can be blended. Examples of the dispersing agent include an amphiphilic polymer dispersing agent and non ionic surfactant (first surfactant).

Examples of the amphiphilic polymer dispersing agent include non ionic amphiphilic polymer dispersing agent such as EFKA4008 and EFKA4009 (urethane-based polymer dispersing agent manufactured by Ciba Specialty Chemicals), DISPERBYK-2164 and DISPERBYK-164 (pigment dispersing functional group-modified copolymer manufactured by BYK Japan KK), NUOSPERSE2008, NUOSPERSE FA-196, and NUOSPERSE657 (manufactured by Elementis plc), FlOWLEN D-90, POLYFLOW KL-100, POLYFLOW KL-700 (manufactured by Kyoeisha Chemical Co., Ltd.), and HOMOGENOL L-95 (manufactured by Kao Corporation). The examples of the amphiphilic polymer dispersing agent also include anionic amphiphilic polymer dispersing agent such as FlOWLEN G-900 (carboxyl group-modified polymer manufactured by Kyoeisha Chemical Co., Ltd.), DISPARLON DA-234, DISPARLON DA-325, DISPARLON DA-375, DISPARLON DA-550, and DISPARLON AQ-330 (polyether phosphate manufactured by Kusumoto Chemicals, Ltd.). Furthermore, examples of the amphiphilic polymer dispersing agent include cationic amphiphilic polymer dispersing agent such as NOPCOSPERSE 092 (manufactured by San Nopco Limited).

Examples of the non ionic surfactant include Amorgen CBH (alkylbetaine), Amorgen SH (alkylamidebetaine), NOIGEN 100E (polyoxyethylene oleyl ether), NOIGEN EA73 (polyoxyethylenedodecylphenylether), NOIGEN ES99 (monooleic acid polyethylene glycol), Dianol CME (palm oil fatty acid monoethanolamide), Dianol 300 (palm oil fatty acid monoethanoldiamide), Solgen 30 (sorbitan sesquioleate), Solgen 40 (sorbitan monooleate), Solgen 50 (sorbitan monostearate), Epan 420 (polyoxyethylenepolyoxypropylene glycol), and Epan 720 (polyoxyethylenepolyoxypropylene glycol)(all manufactured by Kao Corporation).

For the dispersing agent, preferably, the amphiphilic polymer dispersing agent is used, more preferably, non ionic amphiphilic polymer dispersing agent and anionic amphiphilic polymer dispersing agent are used, even more preferably, non ionic amphiphilic polymer dispersing agent is used, particularly preferably, pigment dispersing functional group-modified copolymer dispersing agent and urethane-based polymer dispersing agent are used.

The mixing ratio of the dispersing agent relative to the antibiotic compound is, for example, 0.1 mass % or more, preferably, 1 mass % or more, and for example, 40 mass % or less, preferably, 20 mass % or less.

After the preparation of the hydrophobic slurry, the hydrophobic slurry and the hydrophobic shell-forming component are blended.

To be specific, the hydrophobic shell-forming component is blended to the hydrophobic slurry.

Preferably, the hydrophobic shell-forming component is blended, along with the polymerization initiator, to the hydrophobic slurry.

For the polymerization initiator, a radical polymerization initiator generally used in suspension polymerization is used, and to be specific, an oil-soluble polymerization initiator is used.

Examples of the oil-soluble polymerization initiator include oil-soluble organic peroxides such as dilauroyl peroxide (10 hours half-life temperature T_{1/2}: 61.6° C.), 1,1,3,3-tetramethylbutylperoxy-2-ethylhexanoate (10 hours half-life temperature T_{1/2}: 65.3° C.), t-hexylperoxy-2-ethylhexanoate (10 hours half-life temperature T_{1/2}: 69.9° C.), diisopropylperoxydicarbonate (10 hours half-life temperature T_{1/2}: 40.5° C.), and benzoyl peroxide (10 hours half-life temperature T_{1/2}: 73.6° C.); and oil-soluble azo compounds such as 2,2′-azobisisobutyronitrile (10 hours half-life temperature T_{1/2}: 60° C.), 2,2′-azobis(2,4-dimethylvaleronitrile) (10 hours half-life temperature T_{1/2}: 51° C.), and 2,2′-azobis(2-methylbutyronitrile) (10 hours half-life temperature T_{1/2}: 67° C.). Preferably, dilauroyl peroxide, t-hexylperoxy-2-ethylhexanoate, and 2,2′-azobisisobutyronitrile are used.

The polymerization initiator has a 10 hours half-life temperature T_{1/2} of, for example, 40° C. or more, preferably, 50 or more, and for example, 90° C. or less, preferably, 80° C. or less. The 10 hours half-life temperature T_{1/2} of the polymerization initiator is regarded as a 10 hours value temperature in a graph in which concentration half-life hours is plotted at several arbitrary temperatures.

The polymerization initiator can be used singly or in combination of two or more.

The mixing ratio of the polymerization initiator relative to 100 parts by mass of the polymerizable vinyl monomer is, for example, 0.01 parts by mass or more, preferably, 0.1 parts by mass or more, more preferably, 0.5 parts by mass or more, and for example, 5 parts by mass or less, preferably, 3 parts by mass or less, more preferably, 2.0 parts by mass or less. When the mixing ratio of the polymerization initiator is more than the above-described upper limit, the molecular weight of the polymer may be reduced excessively, and when the mixing ratio of the polymerization initiator is below the above-described lower limit, the conversion rate does not improve sufficiently, and unreacted polymerizable vinyl monomer may remain a several % or more.

The polymerizable vinyl monomer can be blended dividedly, and in such a case, first, a portion of the polymerizable vinyl monomer is blended with the antibiotic compound, and the mixture is dispersed to prepare a hydrophobic slurry, and thereafter, the polymerization initiator and the hydrophobic shell-forming component are dissolved in the remaining portion of the polymerizable vinyl monomer, and the mixture is blended with the hydrophobic slurry.

In this manner, an oil phase component containing a polymerization initiator, the hydrophobic shell-forming component, and the hydrophobic slurry is prepared.

The mixing ratio of the hydrophobic shell-forming component relative to 100 parts by mass of the polymerizable vinyl monomer is, for example, 2 parts by mass or more, preferably, 5 parts by mass or more, more preferably, 10 parts by mass or more, even more preferably, 20 parts by mass or more, and for example, 100 parts by mass or less, preferably, 80 parts by mass or less, more preferably, 70 parts by mass or less, even more preferably, 60 parts by mass or less.

The mixing ratio of the hydrophobic shell-forming component relative to the oil phase component is, for example, 1 mass % or more, preferably, 2 mass % or more, and for example, 60 mass % or less, preferably, 40 mass % or less.

Meanwhile, the oil phase component has an antibiotic compound content of, for example, 1 mass % or more, preferably, 10 mass % or more, and for example, 90 mass % or less, preferably, 80 mass % or less, more preferably, 70 mass % or less, more preferably, 60 mass % or less.

The oil phase component has a polymerizable vinyl monomer content of, for example, 10 mass % or more, preferably, 30 mass % or more, preferably, 50 mass % or more, and for example, 90 mass % or less, preferably, 80 mass % or less, more preferably, 70 mass % or less.

The antibiotic compound in the oil phase component has an average particle size of, for example, 5 μm or less, preferably, 2.5 μm or less, and for example, 0.05 μm or more, preferably, 0.1 μm or more.

Although in the description above, the hydrophobic shell-forming component and the polymerization initiator are blended with the hydrophobic slurry, for example, the hydrophobic shell-forming component and the polymerization initiator can be blended with the antibiotic compound and the polymerizable vinyl monomer before preparing the hydrophobic slurry. To be specific, first, the hydrophobic shell-forming component is blended to the antibiotic compound and the polymerizable vinyl monomer, and then the mixture is dispersed to prepare the hydrophobic slurry. In this manner, the oil phase component containing the antibiotic compound, the polymerizable vinyl monomer, the hydrophobic shell-forming component and the polymerization initiator is prepared at once.

### (Water Dispersion Step)

Then, the above-described oil phase component is dispersed (suspended) in water.

That is, the oil phase component and water are blended and stirred homogeneously, thereby dispersing (suspending) the oil phase component in water. A dispersion (suspension) of the oil phase component in water is produced in this manner.

Conditions for the dispersion in water are not particularly limited. For example, the dispersion in water may be performed at room temperature, or can be performed by heating.

In dispersion of the oil phase component in water, preferably, a dispersing agent (second dispersing agent) and a surfactant (second surfactant) are blended.

Examples of the dispersing agent (second dispersing agent) include water-soluble polymers such as polyvinyl alcohol (PVA), polyvinyl pyrrolidone, gelatin, gum arabic, hydroxyethyl cellulose, hydroxypropyl cellulose, carboxymethyl cellulose, cationic starch, polyacrylic acid and its sodium salt, a styrene maleic acid copolymer and its sodium salt; and inorganic dispersing agents such as tribasic calcium phosphate, colloidal silica, montmorillonite, magnesium carbonate, aluminum hydroxide, and zinc white.

Of the dispersing agent, preferably, polyvinylalcohol (PVA) and tribasic calcium phosphate are used. Even more preferably, polyvinylalcohol (PVA) is used.

The mixing ratio of the dispersing agent relative to 100 parts by mass of the oil phase component is, for example, 0.01 parts by mass or more, preferably 0.1 parts by mass or more, more preferably 1 part by mass or more, and for example, 10 parts by mass or less, preferably, 5 parts by mass or less.

The surfactant (second surfactant) is used to effectively prevent particle coagulation during radical polymerization, preferably, in combination with the above-described dispersing agent (second dispersing agent), to be specific, examples thereof include anionic surfactants such as sodium dodecylbenzene sulphonate, sodium lauryl sulfate, sodium di-2-ethylhexyl sulfosuccinate, sodium dodecyl diphenyl ether disulphonate, sodium nonyl diphenyl ether sulfonate, and a salt of a condensate of aromatic sulfonic acid and formaldehyde; and a non ionic surfactants such as polyoxyethylene lauryl ether, polyoxyethylenenonylphenylether, polyoxyethylene monostearate, polyoxyethylene sorbitan monooleate, and a polyoxyethylene polyoxypropylene block copolymer. Preferably, a non ionic surfactant and an anionic surfactant, more preferably, a polyoxyethylene polyoxypropylene block copolymer and a salt of a condensate of aromatic sulfonic acid and formaldehyde are used.

The surfactant can be used singly, or can be used in combination. Preferably, a combination of a non ionic surfactant and an anion surfactant is used, more preferably, a combination of a polyoxyethylene polyoxypropylene block copolymer and a salt of a condensate of aromatic sulfonic acid and formaldehyde is used.

Examples of the aromatic sulfonic acid include benzene sulfonic acid, toluene sulfonic acid, cumene sulfonic acid, and naphthalene sulfonic acid. Preferably, naphthalene sulfonic acids such as α-naphthalene sulfonic acid and β-naphthalene sulfonic acid are used.

For cation forming the salt, for example, monovalent alkali metal cation such as sodium cation and potassium cation, and ammonium cation is used. Preferably, monovalent alkali metal cation is used.

Examples of the salt of a condensate of aromatic sulfonic acid and formaldehyde include, to be specific, a salt of a condensate of naphthalene sulfonic acid and formaldehyde (naphthalene sulfonic acid formaldehyde condensate sodium salt). For the salt of a condensate of aromatic sulfonic acid and formaldehyde, a commercially available product can be used, to be specific, DEMOL NL (β-naphthalene sulfonic acid formaldehyde condensate sodium salt, 41% aqueous solution, manufactured by Kao Corporation) may be used.

The mixing ratio of the surfactant relative to 100 parts by mass of the oil phase component is, for example, 0.0001 parts by mass or more, preferably, 0.001 parts by mass or more, and for example, 1.0 part by mass or less, preferably 0.1 parts by mass or less. When the surfactant is a combination of the non ionic surfactant and the anion surfactant, the mixing ratio of the non ionic surfactant and the mixing ratio of the anion surfactant relative to 100 parts by mass of the oil phase component is, for example, 0.0001 parts by mass or more, preferably, 0.001 parts by mass or more, and for example, 1.0 part by mass or less, preferably, 0.1 parts by mass or less.

The dispersing agent, or the dispersing agent and surfactant can be blended, for example, before or after blending the oil phase component in water, and preferably, blended in water before blending the oil phase component. An aqueous solution of dispersing agent or an aqueous solution of dispersing agent and surfactant are prepared in this manner.

In the above-described dispersion (suspension) of the oil phase component in water, for example, dispersers such as a homomixer (Homo Mixer), an ultrasonic homogenizer, a pressure homogenizer, Milder, and porous membrane injection disperser are used, and preferably, a homomixer is used.

The conditions for water dispersion are set suitably, and when Homo Mixer is used, the number of revolution is set to, for example, 100 rpm or more, preferably 1000 rpm or more, and for example, 10000 rpm or less, for example, 8000 rpm or less.

An aqueous dispersion in which the oil phase component is dispersed in an aqueous phase is prepared in this manner.

When the dispersing agent (second dispersing agent), or the dispersing agent and surfactant is/are blended in the aqueous dispersion, the dispersing agent or the dispersing agent and surfactant stabilize droplets of the oil phase component in the aqueous dispersion more.

The mixing ratio of the water (or aqueous solution) relative to 100 parts by mass of the oil phase component is adjusted to be, for example, 50 parts by mass or more, preferably, 100 parts by mass or more, more preferably, 150 parts by mass or more, and for example, 1900 parts by mass or less, preferably, 900 parts by mass or less, more preferably, 400 parts by mass or less.

### (Polymerization Step)

In the polymerization step, the polymerizable vinyl monomer is subjected to suspension polymerization, and a hydrophobic shell-forming component and a hydrophilic-shell forming component are subjected to interfacial polymerization, thereby forming a shell that covers a suspension polymer. That is, the shell is formed so as to cover the polymer produced by suspension polymerization, that is, suspension polymer.

### <Suspension Polymerization>

In the polymerization step, the polymerizable vinyl monomer is subjected to suspension polymerization, thereby producing a polymer. To subject the polymerizable vinyl monomer to suspension polymerization, the temperature of the aqueous dispersion is increased to a predetermined temperature. In suspension polymerization, the polymerizable vinyl monomer is allowed to react (to be specific, radical polymerization) while stirring the aqueous dispersion so as to maintain the water dispersed state of the aqueous dispersion, thereby producing a polymer of the polymerizable vinyl monomer. The suspension polymerization is an in situ polymerization, because all of the polymerizable vinyl monomer that is going to be a polymer is in water dispersion particles (hydrophobic liquid phase).

To be specific, in suspension polymerization, by heating the aqueous dispersion while stirring, the polymerizable vinyl monomer starts to polymerize as is in the water dispersion particles, thereby producing a polymer.

The stirring can be performed, for example, with a stirrer having an impeller. The stirring can be performed so that the circumferential speed of the impeller is, for example, 10 m/min or more, preferably, 20 m/min or more, and 400 m/min or less, preferably 200 m/min or less.

The aqueous dispersion is heated so that its temperature is, for example, 40° C. or more, preferably, 50° C. or more, more preferably, 60° C. or more, and for example, 100° C. or less, preferably, 90° C. or less, more preferably, 80° C. or less.

Then, suspension polymerization progresses while the antibiotic compound is in non-miscible state with the polymer.

The heating time is, for example, 2 hours or more, preferably, 3 hours or more, and for example, 12 hours or less, preferably, 8 hours or less. Furthermore, the heating can also be carried out in stages: after heating to a predetermined temperature, the temperature is kept for a predetermined time period, and thereafter, the heating and the temperature keeping is repeated.

In suspension polymerization, the antibiotic compound is substantially insoluble to the polymerizable vinyl monomer, and the antibiotic compound maintains the non-miscible state to the polymerizable vinyl monomer and/or polymer from the start of polymerization to after polymerization.

By suspension polymerization, the polymer prepared from the polymerizable vinyl monomer is produced as the suspension polymer.

### <Interfacial Polymerization>

To perform interfacial polymerization along with the above-described suspension polymerization, for example, the hydrophilic shell-forming component is blended with the aqueous dispersion containing the hydrophobic shell-forming component, and the temperature of the aqueous dispersion is increased. To be specific, the hydrophilic shell-forming component is blended with the aqueous dispersion containing the hydrophobic shell-forming component, and the temperature of the aqueous dispersion is increased to the temperature (to be specific, temperature of the decomposition temperature of the polymerization initiator or more) at which suspension polymerization starts.

The temperature at which interfacial polymerization starts (starting temperature) Tᵢₚ is not particularly limited, and for example, 0° C. or more, preferably, 10° C. or more, and for example, 100° C. or less, preferably, 80° C. or less. The reaction of the interfacial polymerization accelerates when heating is carried out to achieve the temperature of, for example, 25° C. or more, preferably, 40° C. or more, and for example, 100° C. or less, preferably, 80° C. or less.

The temperature (starting temperature) Tᵢ at which the suspension polymerization starts and the above-described 10 hours half-life temperature T_{1/2} of the polymerization initiator satisfies, for example, a relation of the formula (1) shown below.

T_{1/2}−10≦Tᵢ≦T_{1/2}+10 (1)

(where Tᵢ represents starting temperature of suspension polymerization, and T_{1/2} represents 10 hours half-life temperature of polymerization initiator.)

To be specific, the temperature at which suspension polymerization starts is, for example, 55° C. or more, preferably, 60° C. or more, and for example, 100° C. or less, preferably, 80° C. or less.

Therefore, the starting temperature Tᵢ of suspension polymerization is set, for example, higher compared with the starting temperature Tᵢₚ of the interfacial polymerization. To be specific, the starting temperature Tᵢ of suspension polymerization is higher, compared with the starting temperature Tᵢₚ of interfacial polymerization, for example, by 5° C. or more, preferably, 10° C. or more, more preferably, 20° C. or more, and for example, higher by 100° C. or less.

### <Timing of Interfacial Polymerization>

Examples of methods for interfacial polymerization and suspension polymerization include the following: (1) method in which interfacial polymerization is started simultaneously with the start of suspension polymerization, (2) method in which interfacial polymerization is started before the start of the suspension polymerization, and (3) method in which interfacial polymerization is started after the start of suspension polymerization.

In the method in which (1) interfacial polymerization is started simultaneously with the start of suspension polymerization, for example, temperature of an aqueous dispersion in which an oil phase component containing a hydrophobic shell-forming component is contained is increased to the temperature at which suspension polymerization starts or more, and at this time, at the point when the temperature of the aqueous dispersion reached the temperature at which the suspension polymerization starts, the hydrophilic shell-forming component is blended with the aqueous dispersion.

In the method in which (2) interfacial polymerization is started before the start of the suspension polymerization, before the temperature is increased to the temperature at which suspension polymerization starts, the hydrophilic shell-forming component is blended with the aqueous dispersion in which an oil phase component containing a hydrophobic shell-forming component is contained. That is, first, the hydrophilic shell-forming component is blended with, for example, an aqueous dispersion having a temperature of room temperature (20 to 30° C.), and thereafter, the temperature of the aqueous dispersion having the normal temperature is increased to the temperature at which suspension polymerization starts.

It is also possible to increase the temperature of the aqueous dispersion to a temperature less than a temperature at which suspension polymerization starts immediately after the hydrophilic shell-forming component is blended with the aqueous dispersion in which an oil phase component containing a hydrophobic shell-forming component is contained, and thereafter, the temperature of the aqueous dispersion is increased to a temperature at which suspension polymerization starts. When the temperature of the aqueous dispersion is increased to a temperature less than the temperature at which suspension polymerization starts, the aqueous dispersion is heated so that its temperature is, for example, less than 55° C., preferably less than 50° C. In this manner, interfacial polymerization can be sufficiently accelerated before starting suspension polymerization.

In the method in which (3) interfacial polymerization is started after the start of suspension polymerization, first, the temperature of the aqueous dispersion is increased to the temperature at which suspension polymerization starts or more, and thereafter, the hydrophilic shell-forming component is blended with the aqueous dispersion. To be specific, the time from when the temperature of the aqueous dispersion is increased to the temperature at which suspension polymerization starts or more to when the hydrophilic shell-forming component is blended with the aqueous dispersion is, for example, 0.5 hours or more, preferably, 1 hour or more, and for example, 8 hours or less, preferably, 5 hours or less.

In the method of (1) or (2), compared with the method of (3), falling off of the antibiotic compound from the matrix (described later) can be suppressed, and therefore, the state in which the antibiotic compound is dispersed in the matrix is kept while forming the shell. That is, in the controlled release particles, the shell can reliably encapsulate the antibiotic compound in the matrix. Therefore, alkali-resistance of the antibiotic compound in the controlled release particles can be improved.

In the method in which (2) interfacial polymerization is started before the start of the suspension polymerization, the shell can be formed so as to cover the droplets of the oil phase component, and therefore transferring of the antibiotic compound encapsulated in the suspension polymerization from the suspension polymer to the aqueous phase interface (that is, interface between the suspension polymer and water continuous phase) can be controlled.

The mixing ratio of the hydrophilic shell-forming component is, when the hydrophobic shell-forming component is polyisocyanate, the equivalent ratio (isocyanate group/amino group) of the isocyanate group of the hydrophobic shell-forming component relative to the active hydrogen group (when the hydrophilic shell-forming component is polyamine, amino group) of the hydrophilic shell-forming component is, for example, 0.4 or more, preferably, 0.6 or more, and for example, 1.2 or less, preferably, 1.0 or less.

In the description above, the hydrophilic shell-forming component is blended with the aqueous dispersion containing the hydrophobic shell-forming component, but for example, when the hydrophilic shell-forming component is water, separately, the hydrophilic shell-forming component is not blended with the aqueous dispersion, and water contained in the aqueous dispersion is used as the hydrophilic shell-forming component, and the hydrophilic shell-forming component and the hydrophobic shell-forming component can be subjected to interfacial polymerization. When the hydrophilic shell-forming component is water, a polyaddition catalyst such as dibutyltin dilaurate may be used.

In interfacial polymerization, the hydrophobic shell-forming component in the oil phase component (oil phase) and the hydrophilic shell-forming component in the aqueous phase undergo interfacial polymerization at the surface of the water dispersion particles.

The polymerization time of the interfacial polymerization depends on the temperature of suspension polymerization, but can be confirmed by reduction (reaching point of neutralization) in pH of polymerization reaction liquid. The time for the interfacial polymerization completion is, when the polymerization temperature is 60 to 70° C., for example, 2 hours to 4 hours.

By starting the interfacial polymerization, preferably, before the start of or simultaneously with the start of suspension polymerization, shells covering the oil phase component droplets can be formed. As a result, transferring of the antibiotic compound encapsulated in the suspension polymerization from the suspension polymer to the aqueous phase interface (interface between the suspension polymer and water continuous phase) can be controlled.

Furthermore, on the surface of the suspension polymer produced by interfacial polymerization of the hydrophobic shell-forming component and the hydrophilic-shell forming component, a shell made of the polymer of the hydrophobic shell-forming component and the hydrophilic-shell forming component is formed. Therefore, the controlled-release speed of the antibiotic compound in the controlled release particles is reduced, and controlled release properties for a long time period can be achieved.

After the interfacial polymerization and suspension polymerization, the aqueous dispersion after the reaction is cooled, for example, by allowing the aqueous dispersion after the reaction to stand to cool and filtering with filter cloth of 100 mesh, and an aqueous dispersion (suspension) of controlled release particles is obtained.

The cooling temperature is, for example, room temperature (20 to 30° C., to be more specific, 25° C.).

The produced controlled release particles have an antibiotic compound concentration of, for example, 1 mass % or more, preferably, 5 mass % or more, more preferably, 10 mass % or more, and for example, 50 mass % or less, preferably, 40 mass % or less, more preferably, 35 mass % or less.

The controlled release particles content in the aqueous dispersion (suspension) is determined by the blending amounts of the oil phase component and the water (or aqueous solution) in which it is dispersed, to be specific, for example, 10 mass % or more, preferably, 20 mass % or more, and for example, 50 mass % or less, preferably, 40 mass % or less.

The controlled release particles have a shell concentration of, for example, 1 mass % or more, preferably, 2 mass % or more, and for example, 50 mass % or less, preferably, 40 mass % or less.

The controlled release particles have an average particle size of, for example, 1 μm or more, preferably, 2 μm or more, and for example, 20 mm or less, preferably, 10 mm or less. The average particle size is calculated as median size/diameter.

### <Effects of Controlled Release Particles of the Second Invention Group>

The controlled release particles of the second invention group are produced by a production method including an oil phase component preparation step in which an oil phase component containing a hydrophobic shell-forming component and a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent; a water dispersion step in which the oil phase component is dispersed in water to prepare an aqueous dispersion, and a polymerization step in which the hydrophobic shell-forming component and the hydrophilic shell-forming component are subjected to interfacial polymerization to form a polymer that is going to be a shell; and the polymerizable vinyl monomer is subjected to suspension polymerization to produce a polymer that is going to be a core, and therefore, durable controlled release particles with excellent controlled release properties and alkali-resistance can be produced.

However, the microcapsule produced by the method described in Patent Document 1 is produced only by interfacial polymerization, and the disperse medium (solvent) remains in the microcapsule. Therefore, its surface hardness may be insufficient. As a result, when the dispersion liquid of the microcapsule undergoes a step in which a high shearing force is applied or is stored for a long period of time, the microcapsule may coagulate and redispersion may be difficult.

Furthermore, because of insufficient surface hardness of the microcapsule, the microcapsule easily undergoes blocking, and it may become difficult to take out the microcapsule as dried particles.

Meanwhile, the controlled release particles of the second invention group are produced by a production method including an oil phase component preparation step in which, without the presence of a solvent, a hydrophobic slurry, in which an antibiotic compound that is hydrophobic and is substantially insoluble to the hydrophobic polymerizable vinyl monomer is dispersed in a hydrophobic polymerizable vinyl monomer, and an oil phase component containing a hydrophobic shell-forming component are prepared; a water dispersion step in which the oil phase component is dispersed in water to prepare an aqueous dispersion; and a polymerization step in which the hydrophobic shell-forming component and the hydrophilic shell-forming component are subjected to interfacial polymerization to form a polymer that is going to be a shell, and the polymerizable vinyl monomer is subjected to suspension polymerization to form a polymer that is going to be a core, and therefore due to the presence of the solvent in the above-described interfacial polymerization, reduction in surface hardness of the controlled release particles is prevented, durable controlled release particles can be produced, and the produced controlled release particles can be redispersed excellently and have excellent resistance to blocking.

With the method for producing controlled release particles, the controlled release particles that are durable, and are excellent in redispersiveness and resistance to blocking can be produced.

With the method for producing controlled release particles, a shell that covers a suspension polymer subjected to suspension polymerization is formed, and therefore the encapsulation rate (antibiotic compound concentration of the controlled release particles) of the antibiotic compound can be increased, and at the same time the antibiotic compound has excellent controlled release properties and alkali-resistance. Controlled release properties of the controlled release particles and alkali-resistance of the antibiotic compound in the controlled release particles are related to each other, and to be specific, when alkali-resistance of the antibiotic compound in the controlled release particles is improved, controlled release properties of the controlled release particles improve.

In particular, when the hydrophobic shell-forming component contains polyisocyanate, and the hydrophilic shell-forming component contains polyamine, the shell is made of polyurea, and therefore controlled release particles having excellent melting miscibility with thermoplastic urethane resin can be obtained.

Such controlled release particles can be applied to various industrial products, and can be added to, for example, indoor/outdoor paint, rubber, fiber, resin (including plastic), adhesive, joint mixture, sealing agent, building material, caulking agent, wood treatment agent, soil treating agent, white water in paper-making processes, pigment, treatment liquid for printing plates, cooling water, ink, cutting oil, cosmetic products, nonwoven fabric, spinning oil, and leather. The amount of the antibiotic compound added in the controlled release particles for these industrial products is, for example, 10 mg/kg to 100 g/kg (product weight).

Next, description is given below of an embodiment in which the powder formulation formulated from the controlled release particles is blended with the thermoplastic resin.

In this method, first, the suspension of the controlled release particles is dried and formulated into powder formulation.

Then, the powder formulation and thermoplastic resin are melt-kneaded, thereby preparing a kneaded material.

To prepare the kneaded material, for example, to be specific, an extruder or Banbury mixer is used. Examples of the extruder include biaxial extruder and uniaxial extruder. The kneaded material is a molding material for molding a molded article. To be specific, the kneaded material is cooled once and prepared as a pelletized molding material (kneaded material pellet, or master batch). In contrast, the kneaded material can be continuously subjected to molding to be described later as is in the melted state without taking out as a solid molding material (melt-kneaded material).

The powder formulation is blended with the thermoplastic resin so that the antibiotic compound content relative to the thermoplastic resin is, for example, 0.01 mass % or more, preferably, 0.1 mass % or more, and for example, 10 mass % or less, preferably, 3 mass % or less. However, when the kneaded material is prepared as master batch, the above does not apply. To be specific, the powder formulation is blended with the thermoplastic resin so that the antibiotic compound content relative to the thermoplastic resin is, for example, 1 mass % or more, preferably, 5 mass % or more, and for example, 50 mass % or less, preferably, 30 mass % or less, thereby producing a master batch.

The thermoplastic resin is not particularly limited, and examples thereof include polyolefin resins such as polyethylene and polypropylene; styrene and/or acrylic resin such as polystyrene, or polymethyl methacrylate, acrylonitrile-styrene copolymer resin (AS resin), methyl methacrylate-styrene copolymer (MS resin), and acrylonitrile-styrene-butadiene copolymer resin (ABS resin); polyester resins such as polyethylene terephthalate and polylactic acid; polyamide resins such as 6-nylon; vinyl halide resins such as vinyl chloride resin and vinylidene chloride resin; polycarbonate; polyphenylene ether; polyacetal; and thermoplastic polyurethane. Preferably, polyolefin resin, vinyl chloride resin, thermoplastic polyurethane are used.

Then, the kneaded material pellet, or the melt-kneaded material is molded into a molded article.

For the molding method, for example, injection molding, extrusion molding, inflation molding, pultrusion molding, and compression molding are used.

In this manner, a molded article molded into a predetermined shape and to which powder formulation (controlled release particles) is added is produced.

In the description above, powder formulation formulated from the controlled release particles is added to the thermoplastic resin. However, it is not particularly limited as long as it is resin, and for example, it can be added to the thermosetting resin.

In particular, the powder formulation can be suitably added to a resin such as epoxy resin and silicone resin in liquid state.

Such a molded article is used in various use, and is used as, for example, building material; for example, electric wire cable material and covering material for the electric wire cable; for example, pipes for gas and a covering material for the pipe; and for example, textile goods such as garments and a mosquito net.

### <Effects of Molded Article of the Second Invention Group>

Such a molded article is molded from the molding material containing the above-described controlled release particles, and therefore is excellent in controlled release properties of the antibiotic compound and alkali-resistance.

The controlled release particles produced by the above-described method for producing controlled release particles of the second invention group include, to be specific, a third embodiment and a fourth embodiment of the controlled release particles to be described next.

### Third Embodiment

The controlled release particles in the third embodiment are described with reference to FIG. B1.

The controlled release particles 1 are formed, as shown in the cross-sectional view of FIG. B1, for example, into spherical particles. The controlled release particles 1 include a matrix 2, a domain 3 dispersed in the matrix 2, and a shell 7 that covers the matrix 2.

The matrix 2 is made of a polymer prepared from the above-described polymerizable vinyl monomer. The domain 3 is made of the above-described antibiotic compound. The shell 7 is made of a polymer prepared from the above-described hydrophobic shell-forming component and hydrophilic-shell forming component.

To be specific, in the controlled release particles 1, a multi domain structure or a sea-island structure (or polynuclear structure) in which the matrix 2 forms medium or continuous phase, and a plurality of domains 3 are dispersed in isolation in the matrix 2 is formed. Furthermore, in the controlled release particles 1, the matrix 2 and the domain 3 are immiscible to each other, and form a phase separation structure or two-phase structure that are separate from each other. The matrix 2 and the domain 3 form a core, to the shell 7 to be described later.

To be specific, the plurality of domains 3 form a dispersion phase in the matrix 2. The shape of the domain 3 is not particularly limited, and is formed, for example, suitably into a shape such as an amorphous shape, spherical, bulk shape, and plate shape. The domain 3 has an average maximum length of, for example, 0.05 μm or more, preferably, 0.1 μm or more, and for example, 20 μm or less, preferably, 10 μm or less.

The shell 7 is formed on the surface of the matrix 2 (polymer produced by suspension polymerization of the above-described polymerizable vinyl monomer). To be specific, the shell 7 covers, for example, at least a portion of the surface of the matrix 2, preferably, the entire surface of the matrix 2. That is, the shell 7 forms a core-shell structure along with the core made of the matrix 2 and the domain 3.

In FIG. B1, the interface having a circular cross section is clearly formed between the matrix 2 and the shell 7. However, as shown in the TEM photo of FIG. B8, the interface between the matrix 2 and the shell 7 does not have to be formed clearly. As shown in the TEM photo of FIG. B8, the shell 7 is made of a polymer prepared from a hydrophobic shell-forming component and a hydrophilic-shell forming component, and to be specific, the outermost layer (outermost surface) is substantially made only of the polymer of interfacial polymerization, and it is made in a manner such that the concentration of the polymer prepared from the hydrophobic shell-forming component and a hydrophilic-shell forming component is lower relative to the matrix 2 (polymer) gradually from the outermost layer (outermost surface) to the inner side. In this manner, the shell 7 is disposed (unevenly distributed) at the outer layer of the matrix 2 so as to surround the domain 3.

Then, to obtain the controlled release particles 1, in the oil phase component preparation step of the above-described production method of the controlled release particles 1, the antibiotic compound is blended so that the antibiotic compound concentration of the controlled release particles is, for example, less than 30 mass %.

### <Effects of Third Embodiment>

The controlled release particles 1 of the third embodiment include the matrix 2 made of a polymer of a polymerizable vinyl monomer, and the domain 3 made of an antibiotic compound and dispersed in the matrix 2, and therefore the controlled release particles 1 of the third embodiment have excellent controlled release properties of the antibiotic compound, excellent durability, and can be excellently kneaded with resin.

The effects of the third embodiment are described furthermore in detail with reference to a reference embodiment of the second invention group.

In the reference embodiment, as shown in FIG. B9, the domain 3 includes a projection 4 that projects from the inside to the outside of the matrix 2. The projection 4 is exposed from the surface of the matrix 2. In this manner, at the surface of the controlled release particles 1, both of the matrix 2 and the domain 3 are exposed. The projection 4 includes an embedded portion 8 embedded in the outer layer portion of the matrix 2. The controlled release particles 1 have a two-phase structure formed from the matrix 2 and the domain 3, and does not have the shell 7.

The controlled release particles 1 shown in FIG. B9 are produced by the above-described production method, except that the hydrophobic shell-forming component and the hydrophilic-shell forming component are not blended, and interfacial polymerization is not performed.

The controlled release particles 1 of the above-described third embodiment shown in FIG. B1 have, unlike the controlled release particles 1 in the reference embodiment of FIG. B9, no projection 4, and the suspension polymer is covered with the shell 7, and therefore are excellent in continuous controlled release for a long time. To be specific, with the third embodiment, as shown in FIG. B1, the domain 3 (antibiotic compound) of the controlled release particles 1 can be protected with the shell 7. Therefore, the controlled release particles 1 of the third embodiment have excellent controlled release properties of antibiotic compound and alkali-resistance compared with the controlled release particles 1 of the reference embodiment.

### Fourth Embodiment

The controlled release particles in the fourth embodiment are described with reference to FIG. B2.

As shown in the cross-sectional view of FIG. B2, in the fourth embodiment, attachments 5 made of the antibiotic compound are attached on the surface of the shell 7.

The shape of the attachment 5 is not particularly limited, and for example, the attachment 5 is formed suitably into a shape such as an amorphous shape, spherical, bulk shape, and plate shape. In particular, the internal face (contact face making contact with the surface of the shell 7) of the attachment 5 has a concave surface corresponding to the surface (spherical surface) of the shell 7, to be specific, has a bent surface sunken externally. The attachment 5 has the same size as that of the domain 3 or smaller, relative to the average value of the maximum length of the domain 3, for example, 100% or less, preferably, 50% or less, and for example, 0.01% or more, and to be specific, the average value of the maximum length of the attachment 5 is, for example, 10 μm or less, preferably, 5 μm or less, for example, 0.05 μm or more, preferably, 0.1 μm or more. The covering percentage of the attachment 5 relative to the entire surface of the shell 7 is, for example, 10% or more, preferably, 20% or more, and for example, 100% or less, preferably, 90% or less.

To produce the above-described controlled release particles 1, in the oil phase component preparation step of the production method of the above-described controlled release particles 1, the antibiotic compound is blended so that the antibiotic compound concentration of the controlled release particles is, for example, more than 28 mass %, preferably, 30 mass % or more, more preferably, 35 mass %.

### <Effects of Fourth Embodiment>

With the controlled release particles in the fourth embodiment, the attachment 5 allows for more improvement in resistance to blocking.

In the second invention group, both of the controlled release particles in the third embodiment and the controlled release particles of the fourth embodiment can be mixedly present, and in such a case, the mixing ratio of the controlled release particles in the third embodiment and the controlled release particles of the fourth embodiment (controlled release particles in the third embodiment/controlled release particles of the fourth embodiment) based on mass is, for example, 1/99 or more, more preferably 10/90 or more, and for example, 99/1 or less, and further preferably 90/10 or less.

### EXAMPLES

### [1] Examples A Corresponding to the First Invention Group

The numeral values of Preparation Example A and Example A shown below can be replaced with the numeral values shown in the above-described “DESCRIPTION OF EMBODIMENTS” section (that is, the upper limit value or lower limit value). The unit in Preparation Example A, Example A, and Comparative Example A, such as % represents mass % unless specified otherwise.

First, details of the abbreviations used in Preparation Example A, Example A, and Comparative Example A are described next.

Clothianidin: (E)-1-(2-chlorothiazole-5-ylmethyl)-3-methyl-2-nitroguanidine, molecular weight 250, melting point 177° C., solubility to water: 0.33 g/L, manufactured by Sumitomo Chemical Co., Ltd.

Imidacloprid: 1-(6-chloro-3-pyridylmethyl)-N-nitroimidazolidin-2-ylideneamine, molecular weight 256, melting point 144° C., solubility to water: 0.48 g/L, manufactured by maruzen syoudoku Co., Ltd.

EGDMA: ethylene glycol dimethacrylate, trade name “Light ester EG”, insoluble to water, manufactured by Kyoeisha Chemical Co., Ltd.

i-BMA: isobutyl methacrylate, solubility to water: 0.6 g/L, manufactured by Nippon Shokubai Co., Ltd.

DVB-570: trade name, insoluble to water, composition: divinylbenzene (upper limit 60%), ethylvinylbenzene (upper limit 40%), manufactured by NIPPON STEEL & SUMIKIN CHEMICAL CO., LTD.

Styrene: solubility to water: 0.3 g/L, Waco special grade, manufactured by Wako Pure Chemical Industries, Ltd.

DISPERBYK-164: trade name, acetic acid butyl solution of functional group-modified copolymer for dispersing pigment (tertiary amine-containing polyester-modified polyurethane polymer, molecular weight 10000 to 50000), solid content concentration 60%, manufactured by BYK Additives & Instruments

PEROYL L: trade name, dilauroyl peroxide, manufactured by NOF CORPORATION

Perhexyl O: trade name, t-hexylperoxy-2-ethylhexanoate, manufactured by NOF CORPORATION

Pronon 208: trade name, polyoxyethylene polyoxypropylene block copolymer manufactured by NOF CORPORATION

PVA-217: trade name “Kuraray Poval 217”, partially saponified polyvinyl alcohol, manufactured by Kuraray Co., Ltd.

DEMOL NL: trade name, 41% aqueous solution of β-naphthalene sulfonic acid sodium salt, manufactured by Kao Corporation

### Preparation of Hydrophobic Slurry

### Preparation Example A1

### Preparation of Clothianidin Slurry (Slurry A)

A glass bottle was charged with 90 g of EGDMA, 90 g of i-BMA, 20 g of DISPERBYK-164, and 100 g of clothianidin, and zirconia beads with a diameter of 1.0 mm were introduced in an amount of ⅓ of the capacity of the glass bottle. The mixture was subjected to wet grinding with a paint conditioner (paint shaker, trade name “THE CLASSIC model 1400”, manufactured by Red Devil Equipment Company.) for 2 hours, thereby producing a slurry (hydrophobic slurry, hereinafter referred to as “slurry A”.) containing 33.3% of clothianidin.

Clothianidin in Slurry A had an average particle size measured with a concentrated particle size analyzer FPAR-1000 (manufactured by Otsuka Electronics Co. Ltd.) of 1.38 μm.

### Preparation Example A2

### Preparation of Clothianidin Slurry (Slurry B)

7200 g of DVB-570 and 804 g of DISPERBYK-164 were stirred and dispersed with a batch media disperser (batch bead mill, trade name “AD mill (AD-5), zirconia beads diameter 1.5 mm”, manufactured by ASADA IRON WORKS. CO., LTD.) until the mixture is homogeneous, and thereafter 3996 g of clothianidin was further introduced, and subjected to wet grinding for 150 minutes, thereby producing a slurry containing 33.3% of clothianidin (hydrophobic slurry, hereinafter may be referred to as “slurry B”).

Clothianidin in Slurry B had an average particle size measured with a concentrated particle analyzer FPAR-1000 (manufactured by Otsuka Electronics Co. Ltd.) of 0.45 μm.

### Preparation Example A3 to Preparation Example A8

### Preparation of Clothianidin Slurry (Slurry C to H)

Clothianidin slurry (hydrophobic slurry, hereinafter may be referred to as “slurry C to H”) was produced in the same manner as in Preparation Example A1, except that the mixing formulation was changed according to the formulation shown in Table A1.

The average particle size of clothianidin of slurry C to H is shown in Table A1.

### Preparation Example A9

### Preparation of Imidacloprid Slurry (Slurry I)

Imidacloprid slurry (hydrophobic slurry, hereinafter may be referred to as “slurry I”) was produced in the same manner as in Preparation Example A1, except that the mixing formulation was changed according to the formulation shown in Table A1.

Table A1 shows the average particle size of imidacloprid in slurry I.

TABLE A1

| | | Preparation Example A (slurry-forming step) | | | | | | | | |
|---|---|---|---|---|---|---|---|---|---|---|
| | | A1 | A2 | A3 | A4 | A5 | A6 | A7 | A8 | A9 |
| Slurry type | | A | B | C | D | E | F | G | H | I |
| | | Clothianidin slurry | | | | | | | | Imidacloprid |
| | | | | | | | | | | slurry |
| Polymerizable | DVB-570 | — | 7200 | — | — | — | — | — | — | — |
| vinyl monomer | i-BMA | 90 | — | — | — | — | 180 | 60 | — | 90 |
| | Styrene | — | — | 90 | — | 180 | — | — | 60 | — |
| | EGDMA | 90 | — | 90 | 180 | — | — | 60 | 60 | 90 |
| Dispersing agent | DISPERBYK-164 | 20 | 804 | 20 | 20 | 20 | 20 | 30 | 30 | 20 |
| Antibiotic | Clothianidin | 100 | 3996 | 100 | 100 | 100 | 100 | 150 | 150 | — |
| compound | Imidacloprid | — | — | — | — | — | — | — | — | 100 |

| Total | 300 | 12000 | 300 | 300 | 300 | 300 | 300 | 300 | 300 |
|---|---|---|---|---|---|---|---|---|---|
| Antibiotic compound concentration in slurry | 33.3 | 33.3 | 33.3 | 33.3 | 33.3 | 33.3 | 50.0 | 50.0 | 33.3 |
| (%) | | | | | | | | | |
| Preparation method | Paint shaker | Batch | Paint shaker | | | | | | |
| | | beads mill | | | | | | | |
| Average particle size (μm) | 1.38 | 0.45 | 0.90 | 0.64 | 1.27 | 1.54 | 1.25 | 0.98 | 1.22 |

### Water Dispersion Step and Polymerization Step

### Example A1

### Synthesis of Clothianidin-Containing Controlled Release Particles: Corresponding to First Embodiment

A 200 mL beaker (1) was charged with 100 g of slurry B prepared in Preparation Example A2 and 0.5 g of PEROYL L, and the mixture was stirred at room temperature, thereby dissolving PEROYL L in slurry B. In this manner, an oil phase component containing PEROYL L and slurry B was prepared.

Separately, a 500 mL beaker (2) was charged with 258.50 g of ion-exchange water, 40 g of an aqueous solution of 10% PVA-217, and 1 g of an aqueous solution of 1% Pronon 208, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 6000 rpm for 5 minutes to disperse the oil phase component in water, thereby preparing a suspension (aqueous dispersion).

Thereafter, the suspension (aqueous dispersion) was transferred to a 500 mL 4-neck flask equipped with a stirrer, a reflux condenser, a thermometer, and a nitrogen inlet tube, and subjected to suspension polymerization while increasing the temperature under a nitrogen gas flow and stirring.

In suspension polymerization, polymerization started at a point where the temperature reached 55° C., and thereafter, polymerization was performed continuously at 70±1° C. for 5 hours, and at 80±1° C. for 2 hours.

Thereafter, the suspension after reaction was cooled to 30° C. or less, thereby producing a suspension (suspending agent) of controlled release particles containing clothianidin and having a median size of 28.2 μm.

The median size of the controlled release particles was measured with a laser diffraction scattering particle size distribution analyzer LA-920 (manufactured by HORIBA, Ltd.). The measurement of the median size was conducted in the same manner as in Examples and Comparative Examples.

### Example A2

### Synthesis of Clothianidin-Containing Controlled Release Particles: Corresponding to Second Embodiment

A 200 mL beaker (1) was charged with 100 g of slurry B prepared in Preparation Example A2, and 0.5 g of PEROYL L, and the mixture was stirred at room temperature, thereby dissolving PEROYL L in slurry B. In this manner, an oil phase component containing PEROYL L and slurry B was prepared.

Separately, a 500 mL beaker (2) was charged with 258.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 6000 rpm for 5 minutes to disperse the oil phase component in water, thereby preparing a suspension (aqueous dispersion).

Thereafter, suspension polymerization was performed under the same conditions with those in Example A1, thereby producing a suspension (suspending agent) of controlled release particles containing clothianidin and having a median size of 24.5 μm.

### Example A3

### Synthesis of Clothianidin-Containing Controlled Release Particles: Corresponding to Second Embodiment

A 200 mL beaker (1) was charged with 100 g of slurry A prepared in Preparation Example A1 and 0.5 g of PEROYL L, and the mixture was stirred at room temperature, thereby dissolving PEROYL L in slurry A. In this manner, an oil phase component containing PEROYL L and slurry A was prepared.

Separately, a 500 mL beaker (2) was charged with 258.50 g of ion-exchange water, 40 g of an aqueous solution of 10% PVA-217, and 1 g of an aqueous solution of 1% Pronon 208, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 3000 rpm for 5 minutes to disperse the oil phase component, thereby preparing a suspension (aqueous dispersion).

Thereafter, suspension polymerization was performed under the same conditions with those in Example A1, thereby producing a suspension (suspending agent) of controlled release particles containing clothianidin and having a median size of 43.5 μm.

### Example A4

### Synthesis of Clothianidin-Containing Controlled Release Particles: Corresponding to Second Embodiment

A 200 mL beaker (1) was charged with 50 g of slurry A prepared in Preparation Example A1, 25 g of i-BMA, 25 g of EGDMA, and 0.5 g of PEROYL L, and the mixture was stirred at room temperature, thereby dissolving i-BMA, EGDMA, and PEROYL L in slurry A. In this manner, an oil phase component containing i-BMA, EGDMA, PEROYL L, and slurry A was prepared.

Separately, a 500 mL beaker (2) was charged with 258.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 5000 rpm for 5 minutes to disperse the oil phase component, thereby preparing a suspension (aqueous dispersion).

Thereafter, suspension polymerization was performed under the same conditions with those in Example A1, thereby producing a suspension (suspending agent) of controlled release particles containing clothianidin and having a median size of 9.3 μm.

### Example A5 to Example A8, Example A13, Example A15, Example A16

### Synthesis of Clothianidin-Containing Controlled Release Particles: Corresponding to Second Embodiment

A suspension (suspending agent) of controlled release particles containing clothianidin was produced in the same manner as in Example A4, except that the mixing formulation was changed according to the description shown in Table A2 and Table A3. The average particle size of the controlled release particles in the suspension is shown in Table A2 and Table A3.

### Example A9

### Synthesis of Clothianidin-Containing Controlled Release Particles: Corresponding to Second Embodiment

A 200 mL beaker (1) was charged with 50 g of slurry C prepared in Preparation Example A1, 25 g of styrene, 25 g of EGDMA, and 0.5 g of PEROYL L, and the mixture was stirred at room temperature, thereby dissolving styrene, EDGMA, and PEROYL L in slurry C. In this manner, an oil phase component containing styrene, EDGMA, PEROYL L, and slurry C was prepared.

Separately, a 500 mL beaker (2) was charged with 258.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 5000 rpm for 5 minutes to disperse the oil phase component, thereby preparing a suspension (aqueous dispersion).

Thereafter, suspension polymerization was performed under the same conditions with those in Example A1, thereby producing a suspension (suspending agent) of controlled release particles containing clothianidin and having a median size of 14.5 μm.

### Example A10 to Example A12, Example A14, Example A17, Example A18

### Synthesis of Clothianidin-Containing Controlled Release Particles: Corresponding to Second Embodiment

A suspension (suspending agent) of controlled release particles containing clothianidin was produced in the same manner as in Example A9, except that the mixing formulation was changed according to the description shown in Table A3. The average particle size of the controlled release particles in the suspension is shown in Table A3.

### Example A19

### Synthesis of Imidacloprid-Containing Controlled Release Particles: Corresponding to Second Embodiment

A suspension (suspending agent) of controlled release particles containing imidacloprid was produced in the same manner as in Example A4, except that the mixing formulation was changed according to the description shown in Table A3. The average particle size of the controlled release particles in the suspension is shown in Table A3.

TABLE A2

| | | Example | Example | Example | Example |
|---|---|---|---|---|---|
| Composition | Material | A1 | A2 | A3 | A4 |
| Aqueous phase | Deionized water | 258.50 | 258.26 | 258.50 | 258.26 |
| ingredient | 10% Aqueous solution of PVA-217 | 40 | 40 | 40 | 40 |
| (Aqueous solution) | Aqueous solution of 1% Pronon208 | 1 | 1 | 1 | 1 |
| | DEMOL NL | — | 0.24 | — | 0.24 |
| Oil phase ingredient | Slurry | B | B | A | A |
| | | Clothianidin | Clothianidin | Clothianidin | Clothianidin |
| | | slurry | slurry | slurry | slurry |
| | | 100 | 100 | 100 | 50 |
| | i-BMA | — | — | — | 25 |
| | Styrene | — | — | — | — |
| | EGDMA | — | — | — | 25 |
| | Perhexyl O | — | — | — | — |
| | PEROYL L | 0.5 | 0.5 | 0.5 | 0.5 |
| Mixing ratio of polymerizable vinyl | | DVB | DVB | i-BMA/EGDMA | |
| monomer | | 100% | 100% | 50%/50% | 50%/50% |
| Total | | 400 | 400 | 400 | 400 |
| Polymerization conditions | | 1 | 1 | 1 | 1 |
| Controlled release particles concentration in suspension | | 25 | 25 | 25 | 25 |
| liquid (%) | | | | | |
| Antibiotic compound concentration in controlled release | | 33.3 | 33.3 | 33.3 | 16.7 |
| particles (%) | | | | | |
| Antibiotic compound concentration in suspension (%) | | 8.3 | 8.3 | 8.3 | 4.1 |
| Revolutions per minute in dispersion (rpm) | | 6000 | 6000 | 3000 | 5000 |
| Controlled release particles type | | 1 | 2 | 2 | 2 |
| Median size (μm) | | 28.2 | 24.5 | 43.5 | 9.3 |
| | | Example | Example | Example | Example |
| Composition | Material | A5 | A6 | A7 | A8 |
| Aqueous phase | Deionized water | 258.26 | 258.26 | 258.26 | 258.26 |
| ingredient | 10% Aqueous solution of PVA-217 | 40 | 40 | 40 | 40 |
| (Aqueous solution) | Aqueous solution of 1% Pronon208 | 1 | 1 | 1 | 1 |
| | DEMOL NL | 0.24 | 0.24 | 0.24 | 0.24 |
| Oil phase ingredient | Slurry | A | A | D | F |
| | | Clothianidin | Clothianidin | Clothianidin | Clothianidin |
| | | slurry | slurry | slurry | slurry |
| | | 50 | 50 | 50 | 50 |
| | i-BMA | 5 | 45 | — | 50 |
| | Styrene | — | — | — | — |
| | EGDMA | 45 | 5 | 50 | — |
| | Perhexyl O | — | — | — | — |
| | PEROYL L | 0.5 | 0.5 | 0.5 | 0.5 |

| Mixing ratio of polymerizable vinyl | i-BMA/EGDMA | | | |
|---|---|---|---|---|
| monomer | 25%/75% | 75%/25% | 0%/100% | 100%/0% |
| Total | 400 | 400 | 400 | 400 |
| Polymerization conditions | 1 | 1 | 1 | 1 |
| Controlled release particles concentration in suspension | 25 | 25 | 25 | 25 |
| liquid (%) | | | | |
| Antibiotic compound concentration in controlled release | 16.7 | 16.7 | 16.7 | 16.7 |
| particles (%) | | | | |
| Antibiotic compound concentration in suspension (%) | 4.1 | 4.1 | 4.1 | 4.1 |
| Revolutions per minute in dispersion (rpm) | 5000 | 5000 | 5000 | 5000 |
| Controlled release particles type | 2 | 2 | 2 | 2 |
| Median size (μm) | 8.5 | 19.7 | 27.2 | 15.6 |

TABLE A3

| | | Example | Example | Example | Example | Example | Example |
|---|---|---|---|---|---|---|---|
| Composition | Material | A9 | A10 | A11 | A12 | A13 | A14 |
| Aqueous | Deionized water | 258.26 | 258.26 | 258.26 | 257.96 | 258.26 | 258.26 |
| phase | AQUEOUS SOLUTION OF | 40 | 40 | 40 | 40 | 40 | 40 |
| ingredient | 10% PVA-217 | | | | | | |
| (Aqueous | Aqueous solution of 1% | 1 | 1 | 1 | 1 | 1 | 1 |
| solution) | Pronon208 | | | | | | |
| | DEMOL NL | 0.24 | 0.24 | 0.24 | 0.24 | 0.24 | 0.24 |
| Oil phase | Slurry | C | C | C | E | G | H |
| ingredient | | Clothianidin | Clothianidin | Clothianidin | Clothianidin | Clothianidin | Clothianidin |
| | | slurry | slurry | slurry | slurry | slurry | slurry |
| | | 50 | 50 | 50 | 50 | 80 | 60 |
| | i-BMA | — | — | — | — | 10 | — |
| | Styrene | 25 | 5 | 45 | 50 | — | 20 |
| | EGDMA | 25 | 45 | 5 | — | 10 | 20 |
| | Perhexyl O | — | — | — | 0.5 | — | — |
| | PEROYL L | 0.5 | 0.5 | 0.5 | 0.3 | 0.5 | 0.5 |

| Mixing ratio of polymerizable | Styrene/EGDMA | | | | i-BMA/ | Styrene/ |
|---|---|---|---|---|---|---|
| vinyl monomer | | | | | EGDMA | EGDMA |
| | 50%/50% | 25%/75% | 75%/25% | 100%/0% | 50%/50% | 50%/50% |
| Total | 400 | 400 | 400 | 400 | 400 | 400 |
| Polymerization conditions | 1 | 1 | 1 | 2 | 1 | 1 |
| Controlled release particles concentration in | 25 | 25 | 25 | 25 | 25 | 25 |
| suspension (%) | | | | | | |
| Antibiotic compound concentration in | 16.7 | 16.7 | 16.7 | 16.7 | 40.0 | 30.0 |
| controlled release particles (%) | | | | | | |
| antibiotic compound concentration in | 4.1 | 4.1 | 4.1 | 4.1 | 10.0 | 7.5 |
| suspension (%) | | | | | | |
| Revolutions per minute in dispersion (rpm) | 5000 | 5000 | 5000 | 5000 | 5000 | 5000 |
| Controlled release particles type | 2 | 2 | 2 | 2 | 2 | 2 |
| Median size (μm) | 14.5 | 8.5 | 40.4 | 17.8 | 13.0 | 12.9 |

| | | Example | Example | Example | Example | Example |
|---|---|---|---|---|---|---|
| Composition | Material | A15 | A16 | A17 | A18 | A19 |
| Aqueous | Deionized water | 191.60 | 143.96 | 191.60 | 143.96 | 258.26 |
| phase | AQUEOUS SOLUTION OF | 40 | 40 | 40 | 40 | 40 |
| ingredient | 10% PVA-217 | | | | | |
| (Aqueous | Aqueous solution of 1% | 1 | 1 | 1 | 1 | 1 |
| solution) | Pronon208 | | | | | |
| | DEMOL NL | 0.24 | 0.24 | 0.24 | 0.24 | 0.24 |
| Oil phase | Slurry | A | A | C | C | I |
| ingredient | | Clothianidin | Clothianidin | Clothianidin | Clothianidin | Imidacloprid |
| | | slurry | slurry | slurry | slurry | slurry |
| | | 50 | 50 | 50 | 50 | 50 |
| | i-BMA | 25 | 25 | — | — | 5 |
| | Styrene | — | — | 25 | 25 | — |
| | EGDMA | 25 | 25 | 25 | 25 | 45 |
| | Perhexyl O | — | — | — | — | — |
| | PEROYL L | 0.5 | 0.5 | 0.5 | 0.5 | 0.5 |

| Mixing ratio of polymerizable | i-BMA/EGDMA | | Styrene/EGDMA | | i-BMA/ |
|---|---|---|---|---|---|
| vinyl monomer | | | | | EGDMA |
| | 50%/50% | | 50%/50% | | 50%/50% |
| Total | 333 | 286 | 333 | 286 | 400 |
| Polymerization conditions | 1 | 1 | 1 | 1 | 1 |
| Controlled release particles concentration in | 30 | 35 | 30 | 35 | 25 |
| suspension (%) | | | | | |
| Antibiotic compound concentration in | 16.7 | 16.7 | 16.7 | 16.7 | 16.7 |
| controlled release particles (%) | | | | | |
| antibiotic compound concentration in | 5.0 | 5.8 | 5.0 | 5.8 | 4.1 |
| suspension (%) | | | | | |
| Revolutions per minute in dispersion (rpm) | 5000 | 5000 | 5000 | 5000 | 5000 |
| Controlled release particles type | 2 | 2 | 2 | 2 | 2 |
| Median size (μm) | 12.3 | 12.4 | 10.6 | 11.6 | 8.2 |

In Table A2 and Table A3, “1” in “polymerization conditions” section indicates that the temperature of the suspension in the polymerization step was adjusted to “70±1° C. for 5 hours, 80±1° C. for 2 hours” and “2” indicates that the temperature of the suspension in the polymerization step was adjusted to “80±1° C. for 3 hours, 85±1° C. for 3 hours”.

“1” in “controlled release particles type” section indicates that the controlled release particles have the structure of the first embodiment shown in FIG. A1, and “2” indicates that the controlled release particles have the structure of the second embodiment shown in FIG. A2.

### Powder Formulation of Controlled Release Particles, Kneading with Thermoplastic Resin, and Molding

### Example A20

### Kneading of Powder Formulation of Example A1 with Polyethylene and Molding

The suspension of the controlled release particles produced in Example A1 was filtered with a filter cloth having 100 pores, and thereafter, dried at room temperature for one day, thereby producing powder of the controlled release particles (powder formulation). The produced powder of the controlled release particles (powder formulation) was dry-blended with high-density polyethylene (HDPE) HI-ZEX 6300M (manufactured by Prime Polymer Co., Ltd., melt flow rate 0.11 g/10 min) so that clothianidin relative to HDPE was 0.25%, introduced into a biaxial extrusion and injection molding DSMXplore MC15M (manufactured by DSM), melt-kneaded at 220° C. for 5 minutes to produce a strand, and then injection molded in the melted state, thereby producing a strip molded article (10 mm×76 mm×4 mm).

### Example A21

### Kneading of Powder Formulation of Example A3 with Polyethylene and Molding

A strip molded article was produced in the same manner as in Example A20, except that the suspension of the controlled release particles produced in Example A3 was used instead of the suspension of the controlled release particles produced in Example A1.

### Formulation of Powder Formulation of Controlled Release Particles

### Example A22

1.2 parts by mass of the suspension of the controlled release particles produced in Example A1 (clothianidin concentration 8.3 mass %) was blended with 100 parts by mass of KAGALITE No. 2 (manufactured by KAGALITE KOGYO CO., LTD., fine grain of pumice, particle size 425 to 1400 μm), and then the mixture was dried, thereby producing clothianidin powder formulation. The powder formulation had a clothianidin concentration of about 0.1 mass %.

### Example A23

A clothianidin powder formulation was produced in the same manner as in Example A22, except that 1.2 parts by mass of the suspension of the controlled release particles produced in Example A3 (clothianidin concentration 8.3 mass %) was blended instead of the suspension of the controlled release particles produced in Example A1. The powder formulation had a clothianidin concentration of about 0.1 mass %.

Comparative Example A1 (kneading of dried product of clothianidin microcapsule suspension with polyethylene) The same processes were carried out as in Example A6, except that clothianidin microcapsule suspension “XYLAMON MC” manufactured by Japan EnviroChemicals, Ltd. produced by interfacial polymerization was dried at room temperature for 1 day and ground to produce a sample, and the sample was used instead of the controlled release particles powder (powder formulation) prepared in Example A1. However, the capsules were broken while melt-kneading and the solvent was atomized, and kneading could not be done.

Evaluation

### 1. SEM (Scanning Electron Microscope) Observation

The suspension (suspending agent) of Example A1 to Example A4, and Example A9 and Example A19 was dropped on a stage, and thereafter, water was vaporized away. Then, the produced controlled release particles were observed with a scanning electron microscope Hitachi TM-3000 (manufactured by Hitachi High-Technologies Corporation). SEM images of the controlled release particles of Example A1 to Example A4, and Example A9 and Example A19 were shown in FIG. A4 to FIG. A9.

The strand of Example A20 and Example A21 was immersed in liquid nitrogen, and the fracture surface of the brittle fracture was observed with a scanning electron microscope Hitachi TM-3000 (manufactured by Hitachi High-Technologies Corporation). SEM images of the cross section of Example A20 and Example A21 are shown in FIG. A10 and FIG. A11.

### 2. TEM (Transmission Electron Microscope) Observation

The suspension (suspending agent) of Example A1 to Example A3 was freeze-dried, then dispersed in a bisphenol liquid epoxy resin, and thereafter cured with amine. Then, the cured product was cut with an ultramicrotome to expose its cross section, the cross section was dyed with osmium tetroxide, and as necessary, also with ruthenium tetroxide, the cross section was cut out with an ultramicrotome into extremely thin slices, thereby preparing samples. The prepared samples were observed with a transmission electron microscope (model number “H-7100”, manufactured by Hitachi, Ltd.).

Image-processed TEM photographs of Example A1 to Example A3 are shown in FIG. A12 to FIG. A14, respectively.

In FIG. A12 to FIG. A14, the blank space shown with reference numeral 3 represents a mark showing that clothianidin was dissolved and fell off in the process of allowing the ultrathin slice to float and to be collected in water, and represents the shape of the clothianidin domain.

### 3. Alkali-Resistance Test

### 3-1. Suspending Agent of Controlled Release Particles

Alkali-resistance test was conducted for the suspending agent of controlled release particles with the following procedure.

The suspension of the controlled release particles produced in Example A1 to Example A3 was filtered with a filter cloth having 100 pores, and thereafter, dried at room temperature for one day, thereby producing powder of the controlled release particles (powder formulation). The powder was diluted with deionized water to 1000 times, 6.3 mL of the dilution was measured and introduced in a glass bottle, and 2 mL of a saturated calcium hydroxide solution was added, thereby preparing a test solution. The test solution was allowed to stand in a constant temperature of 40° C.

10 mL of acetonitrile was added to the test solution after 1 day and after 7 days from the test, clothianidin was extracted, the clothianidin amount was determined with HPLC, and the remaining ratio was calculated.

As a control, an aqueous solution of technical product of clothianidin was used and the test was conducted in the same manner.

The results are shown in Table A4.

TABLE A4

Clothianidin remaining ratio(%)

| Example A | After one day | After seven days |
|---|---|---|
| Example A1 | 91.2 | 11.9 |
| Example A2 | 92.5 | 15.6 |
| Example A3 | 92.1 | 15.4 |
| Clothianidin (Control) | 86.7 | 7.3 |

As can be seen from Table A4, the suspending agent containing the controlled release particles of Example A1 to Example A3 has a high clothianidin remaining ratio of, after one day from when the test started, 91 to 93%, and a clothianidin remaining ratio of, after seven days from when the test started, 12 to 16%. Although the clothianidin remaining ratio after seven days from when the test started decreased compared with the clothianidin remaining ratio after one day from when the test started, considering the test result with the control was 7%, it is still at a practical level. Furthermore, Table A4 also shows that the controlled release particles of Example A2 and Example A3 corresponding to the second embodiment are excellent in alkali-resistance in any of the clothianidin remaining ratio after one day from when the test started and the clothianidin remaining ratio after seven days from when the test started, compared with the controlled release particles of Example A1 corresponding to the first embodiment.

### 3-2. Powder Formulation of Controlled Release Particles

1.0 g of the powder formulation produced in Example A22 and Example A23 was measured and taken out, and 3.6 mL of deionized water and 2 mL of a saturated calcium hydroxide aqueous solution were added thereto, thereby preparing a test solution. The test solution was allowed to stand in a constant temperature of 40° C.

10 mL of acetonitrile was added to the test solution after 1 day and after 7 days from the test, clothianidin was extracted, the clothianidin amount was determined with HPLC, and the remaining ratio was calculated.

As a control, an aqueous solution of technical product of clothianidin was used and the test was conducted in the same manner.

The results are shown in Table A5.

TABLE A5

Clothianidin remaining ratio(%)

| Example A | After one day | After seven days |
|---|---|---|
| Example A22 | 90.2 | 10.9 |
| Example A23 | 91.8 | 15.1 |
| Clothianidin (Control) | 86.7 | 7.3 |

As can be seen from Table A5, the powder formulation of Example A22 and Example A23 containing the controlled release particles of Example A1 and Example A3 has a high clothianidin remaining ratio of, after one day from when the test started, 90 to 92%, and a clothianidin remaining ratio of, after seven days from when the test started, 11 to 15%. Although the clothianidin remaining ratio after seven days from when the test started decreased compared with the clothianidin remaining ratio after one day from when the test started, considering the test result with the control was 7%, it is still at a practical level. Furthermore, Table A5 also shows that the powder formulation of Example A23 containing the controlled release particles of Example A3 corresponding to the second embodiment are excellent in alkali-resistance of the antibiotic compound in any of the clothianidin remaining ratio after one day from when the test started and the clothianidin remaining ratio after seven days from when the test started, compared with the powder formulation of Example A22 containing the controlled release particles of Example A1 corresponding to the first embodiment.

### 4. Termite Control Test of Molded Article

Silica sand was watered so that its water content was 8% (optimal water content for termite activities), and a plastic vessel was charged with the silica sand. Then, the strip molded article of Example A20 and Example A21 was set on the surface of the silica sand.

As a comparison, test was conducted for the one in which a strip molded article made only of HDPE to which controlled release particles were not kneaded was set.

50 ergates of coptotermes were introduced to the above-described plastic vessel, and the number of the dead coptotermes (=death rate) and activities of the termites were observed for 7 days (test was conducted with n=2). All the termites were dead on the second and third days from the start of the test with the strip molded article of Example A20 and Example A21.

Meanwhile, with the strip molded article with only HDPE, i.e., a comparison, the termites were not dead even after 7 days, and no change can be seen in the activities of the termites.

That is, significant formicidal effects can be seen in Example A20 and Example A21.

### [2] Examples B Corresponding to the Second Invention Group

The numeral values of Preparation Example B, Example B, and Reference Example B shown below can be replaced with the numeral values shown in the above-described “DESCRIPTION OF EMBODIMENTS” section (that is, the upper limit value or lower limit value). The unit in Preparation Example B, Example B, and Reference Example B, such as % represents mass % unless specified otherwise.

First, details of the abbreviations used in Preparation Example B, Example B, and Reference Example B are described next.

clothianidin: (E)-1-(2-chlorothiazole-5-ylmethyl)-3-methyl-2-nitroguanidine, molecular weight 250, melting point 177° C., solubility to water: 0.33 g/L, manufactured by Sumitomo Chemical Co., Ltd.

Imidacloprid: 1-(6-chloro-3-pyridylmethyl)-N-nitroimidazolidin-2-ylideneamine, molecular weight 256, melting point 144° C., solubility to water: 0.48 g/L, manufactured by maruzen syoudoku Co., Ltd.

EGDMA: ethylene glycol dimethacrylate, trade name “Light ester EG”, insoluble to water, manufactured by Kyoeisha Chemical Co., Ltd.

i-BMA: isobutyl methacrylate, solubility to water: 0.6 g/L, manufactured by Nippon Shokubai Co., Ltd.

DVB-570: trade name, insoluble to water, composition: divinylbenzene (upper limit 60%), ethylvinylbenzene (upper limit 40%), manufactured by NIPPON STEEL & SUMIKIN CHEMICAL CO., LTD.

styrene: solubility to water: 0.3 g/L, Waco special grade, manufactured by Wako Pure Chemical Industries, Ltd.

DISPERBYK-164: trade name, acetic acid butyl solution of functional group-modified copolymer for dispersing pigment (tertiary amine-containing polyester-modified polyurethane polymer, molecular weight 10000 to 50000), solid content concentration 60%, manufactured by BYK Additives & Instruments

PEROYL L: trade name, dilauroyl peroxide, 10 hours half-life temperature T_{1/2}: 61.6° C., manufactured by NOF CORPORATION

Pronon 208: trade name, a polyoxyethylene polyoxypropylene block copolymer manufactured by NOF CORPORATION

PVA-217: trade name “Kuraray Poval 217”, partially saponified polyvinyl alcohol, manufactured by Kuraray Co., Ltd.

DEMOL NL: trade name, 41% aqueous solution of β-naphthalene sulfonic acid sodium salt, manufactured by Kao Corporation T-1890: trade name “VESTANAT T 1890/100”, cyclic trimer of isophorone diisocyanate (IPDI), solubility to water: 0.02 g/L, manufactured by Evonik industries DETA: diethylene triamine, Wako 1st grade reagent, manufactured by Wako Pure Chemical Industries, Ltd.

### Preparation of Hydrophobic Slurry

### Preparation Example B1

### Preparation of Clothianidin Slurry (Slurry A)

A glass bottle was charged with 90 g of EGDMA, 90 g of i-BMA, 20 g of DISPERBYK-164, and 100 g of clothianidin, and zirconia beads with a diameter of 1.0 mm were introduced in an amount of ⅓ of the capacity of the glass bottle. The mixture was subjected to wet grinding with a paint conditioner (paint shaker, trade name “THE CLASSIC model 1400”, manufactured by Red Devil Equipment Company.) for 2 hours, thereby producing a slurry (hydrophobic slurry, hereinafter referred to as “slurry A”.) containing 33.3% of clothianidin.

Clothianidin in Slurry A had an average particle size measured with a concentrated particle size analyzer FPAR-1000 (manufactured by Otsuka Electronics Co. Ltd.) of 1.38 μm.

### Preparation Example B2

### Preparation of Clothianidin Slurry (Slurry B)

7200 g of DVB-570 and 804 g of DISPERBYK-164 were stirred and dispersed with a batch media disperser (batch bead mill, trade name “AD mill (AD-5), zirconia beads diameter 1.5 mm”, manufactured by ASADA IRON WORKS. CO., LTD.) until the mixture is homogeneous, and thereafter 3996 g of clothianidin was further introduced, and subjected to wet grinding for 150 minutes, thereby producing a slurry containing 33.3% of clothianidin (hydrophobic slurry, hereinafter may be referred to as “slurry B”).

Clothianidin in Slurry B had an average particle size measured with a concentrated particle analyzer FPAR-1000 (manufactured by Otsuka Electronics Co. Ltd.) of 0.45 μm.

### Preparation Example B3 to Preparation Example B8

### Preparation of Clothianidin Slurry (Slurry C to H)

Clothianidin slurry (hydrophobic slurry, hereinafter may be referred to as “slurry C to H”) was produced in the same manner as in Preparation Example B1, except that the mixing formulation was changed according to the formulation shown in Table B1.

The average particle size of clothianidin of slurry C to H is shown in Table B1.

### Preparation Example B9

### Preparation of Imidacloprid Slurry (Slurry I)

Imidacloprid slurry (hydrophobic slurry, hereinafter may be referred to as “slurry I”) was produced in the same manner as in Preparation Example B1, except that the mixing formulation was changed according to the formulation shown in Table B1.

Table B1 shows the average particle size of imidacloprid in slurry I.

TABLE B1

| | | Preparation Example B (slurry-forming step) | | | | | | | | |
|---|---|---|---|---|---|---|---|---|---|---|
| | | B1 | B2 | B3 | B4 | B5 | B6 | B7 | B8 | B9 |
| Slurry type | | A | B | C | D | E | F | G | H | I |
| | | Clothianidin slurry | | | | | | | | Imidacloprid |
| | | | | | | | | | | slurry |
| Polymerizable | DVB-570 | — | 7200 | — | — | — | — | — | — | — |
| vinyl monomer | i-BMA | 90 | — | — | — | — | 180 | 60 | — | 90 |
| | Styrene | — | — | 90 | — | 180 | — | — | 60 | — |
| | EGDMA | 90 | — | 90 | 180 | — | — | 60 | 60 | 90 |
| dispersing agent | DISPERBYK-164 | 20 | 804 | 20 | 20 | 20 | 20 | 30 | 30 | 20 |
| Antibiotic | Clothianidin | 100 | 3996 | 100 | 100 | 100 | 100 | 150 | 150 | — |
| compound | Imidacloprid | — | — | — | — | — | — | — | — | 100 |

| Total | 300 | 12000 | 300 | 300 | 300 | 300 | 300 | 300 | 300 |
|---|---|---|---|---|---|---|---|---|---|
| Antibiotic compound concentration | 33.3 | 33.3 | 33.3 | 33.3 | 33.3 | 33.3 | 50.0 | 50.0 | 33.3 |
| in slurry (%) | | | | | | | | | |
| Preparation method | Paint shaker | Batch | Paint shaker | | | | | | |
| | | beads mill | | | | | | | |
| Average particle size (μm) | 1.38 | 0.45 | 0.90 | 0.64 | 1.27 | 1.54 | 1.25 | 0.98 | 1.22 |

### Water Dispersion Step and Polymerization Step

### Example B1

### Synthesis of Polyurea Covered/Clothianidin-Containing Controlled Release Particles: Corresponding to Third Embodiment

A 200 mL beaker (1) was charged with 85 g of slurry B prepared in Preparation Example B2, 15 g of T-1890, and 0.5 g of PEROYL L, and the mixture was stirred at room temperature, thereby dissolving T-1890 and PEROYL L in slurry B. In this manner, an oil phase component containing T-1890, PEROYL L, and slurry B was prepared.

Separately, a 500 mL beaker (2) was charged with 240.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 6000 rpm for 5 minutes to disperse the oil phase component, thereby preparing a suspension (aqueous dispersion).

Thereafter, the suspension (aqueous dispersion) was transferred to a 500 mL 4-neck flask equipped with a stirrer, a reflux condenser, a thermometer, and a nitrogen inlet tube, and the mixture was stirred under nitrogen gas flow.

Then, 18 g of an aqueous solution of 10 mass % diethylene triamine was added to the suspension to start interfacial polymerization, and thereafter, the temperature of the suspension was increased to start suspension polymerization.

To be specific, first, to the suspension of room temperature, 18 g of an aqueous solution of 10 mass % diethylene triamine was added, and immediately after the addition, the temperature of the suspension was increased to 70° C., and the temperature was kept for 5 hours. Thereafter, the temperature of the suspension was increased to 80° C., and the temperature was kept for 2 hours.

The interfacial polymerization was started when the aqueous solution of 10 mass % diethylene triamine was introduced, and the suspension polymerization was started when the temperature reached 55° C. while increasing the temperature of the suspension to 70° C.

In this manner, clothianidin is dispersed in the matrix formed by suspension polymerization, and the matrix is covered with polyurea, thereby producing a suspension (suspending agent) of controlled release particles.

Thereafter, the suspension after reaction was cooled to 30° C. or less, clothianidin is dispersed in the matrix, and the matrix is covered with polyurea formed in interfacial polymerization, thereby producing a suspension (suspending agent) of controlled release particles.

The median size of the controlled release particles in the suspension was measured with a laser diffraction scattering particle size distribution analyzer LA-920 (manufactured by HORIBA, Ltd.). The results are shown in Table B2. The measurement of the median size was conducted in the same manner as in Examples, Reference Example, and Comparative Example, and the results are shown in Table B2 to Table B6.

### Example B2

### Synthesis of Polyurea Covered/Clothianidin-Containing Controlled Release Particles: Corresponding to Third Embodiment

A 200 mL beaker (1) was charged with 50 g of slurry A prepared in Preparation Example B1, 17.5 g of i-BMA, 17.5 g of EGDMA, 15 g of T-1890, and 0.5 g of PEROYL L, and the mixture was stirred at room temperature, thereby dissolving i-BMA, EGDMA, T-1890, and PEROYL L in slurry A. In this manner, an oil phase component containing i-BMA, EGDMA, T-1890, PEROYL L, and slurry A was prepared.

Separately, a 500 mL beaker (2) was charged with 240.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 5000 rpm for 5 minutes to disperse the oil phase component, thereby preparing a suspension (aqueous dispersion).

Thereafter, the suspension (aqueous dispersion) was transferred to a 500 mL 4-neck flask equipped with a stirrer, a reflux condenser, a thermometer, and a nitrogen inlet tube, and the mixture was stirred under nitrogen gas flow.

Then, 18 g of aqueous solution of 10 mass % diethylene triamine was added to the suspension to start interfacial polymerization, and thereafter, the temperature of the suspension was increased to start suspension polymerization.

To be specific, first, to the suspension of room temperature, 18 g of an aqueous solution of 10 mass % diethylene triamine was added, and immediately after the addition, the temperature of the suspension was increased to 70° C., and the temperature was kept for 5 hours. Thereafter, the temperature of the suspension was increased to 80° C., and the temperature was kept for 2 hours.

The interfacial polymerization was started when the aqueous solution of 10 mass % diethylene triamine was introduced, and the suspension polymerization was started when the temperature reached 55° C. while increasing the temperature of the suspension to 70° C.

In this manner, clothianidin is dispersed in the matrix formed by suspension polymerization, and the matrix is covered with polyurea formed in interfacial polymerization, thereby producing a suspension (suspending agent) of controlled release particles.

Thereafter, the suspension after reaction was cooled to 30° C. or less, thereby producing a suspension (suspending agent) of controlled release particles, in which clothianidin is dispersed in the matrix, and the matrix is covered with polyurea.

### Example B3

### Synthesis of Polyurea Covered/Clothianidin-Containing Controlled Release Particles: Corresponding to Third Embodiment

The processes were conducted in the same manner as in Example B2 except that the polymerization conditions were changed as follows, thereby producing a suspension (suspending agent) of controlled release particles, in which clothianidin is dispersed in the matrix and the matrix is covered with polyurea.

That is, immediately after the addition of the aqueous solution of diethylene triamine, the temperature of the suspension was increased to 60° C., and the temperature was kept for 1 hour, and then the temperature of the suspension was increased to 70° C., and the temperature was kept for 2 hours. Thereafter, the temperature of the suspension was increased to 80° C., and the temperature was kept for 1 hour.

The interfacial polymerization was started when the aqueous solution of 10 mass % diethylene triamine was introduced, and the suspension polymerization was started when the temperature reached 55° C. while increasing the temperature of the suspension to 60° C.

### Example B4

### Synthesis of Polyurea Covered/Clothianidin-Containing Controlled Release Particles: Corresponding to Third Embodiment

A suspension (suspending agent) of controlled release particles containing clothianidin was produced in the same manner as in Example B2, except that the polymerization conditions were changed as follows.

That is, after adding the aqueous solution of diethylene triamine, the temperature of the suspension was increased to 50° C., and the temperature was kept for 2 hours, and then the temperature of the suspension was increased to 60° C., and the temperature was kept for 1 hour, and then the temperature of the suspension was increased to 70° C., and the temperature was kept for 2 hours. Thereafter, the temperature of the suspension was increased to 80° C., and the temperature was kept for 1 hour.

The interfacial polymerization was started when the aqueous solution of 10 mass % diethylene triamine was introduced, and suspension polymerization was started after the start of interfacial polymerization and when the temperature of the suspension was increased to 55° C. while increasing the temperature to 60° C.

### Example B5

### Synthesis of Polyurea Covered/Clothianidin-Containing Controlled Release Particles: Corresponding to Third Embodiment

A suspension (suspending agent) of controlled release particles containing clothianidin was produced in the same manner as in Example B2 except that the polymerization conditions were changed as follows.

That is, first, the temperature of the suspension was increased to 60° C., and the temperature was kept for 1 hour. Thereafter, the aqueous solution of diethylene triamine was added, and immediately thereafter, the temperature of the suspension was increased to 70° C., and the temperature was kept for 2 hours. Thereafter, the temperature of the suspension was increased to 80° C., and the temperature was kept for 1 hour.

That is, the suspension polymerization was started when the temperature reached 55° C. while increasing the temperature of the suspension to 60° C., and interfacial polymerization was started after the start of suspension polymerization and when the aqueous solution of 10 mass % diethylene triamine was introduced.

### Example B10 to Example B13, Example B19 to Example B23, Example B27, Example B28, Example B31 and Example B32

### Synthesis of Polyurea Covered/Clothianidin-Containing Controlled Release Particles

### (Example B10 to Example B13, Example B19 to Example B23, Example B27, Example B31 and Example B32: Corresponding to Third Embodiment)

### (Example B28: Corresponding to Fourth Embodiment)

A suspension (suspending agent) of controlled release particles covered with polyurea and containing clothianidin was produced in the same manner as in Example B2, except that the mixing formulation was changed according to the description shown in Table B3 to Table B5.

### Example B6

### Synthesis of Polyurea Covered/Clothianidin-Containing Controlled Release Particles: Corresponding to Third Embodiment

A 200 mL beaker (1) was charged with 50 g of slurry C prepared in Preparation Example B3, 17.5 g of styrene, 17.5 g of EGDMA, 15 g of T-1890, and 0.5 g of PEROYL L, and the mixture was stirred at room temperature, thereby dissolving styrene, EGDMA, T-1890, and PEROYL L in slurry C. In this manner, an oil phase component containing styrene, EGDMA, T-1890, PEROYL L, and slurry C was prepared.

Separately, a 500 mL beaker (2) was charged with 240.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, a 500 mL beaker (2) was charged with the oil phase component in which styrene, EGDMA, T-1890, and PEROYL L, and the mixture was stirred with a T.K.Homo Mixer MARK type 2.5 (manufactured by PRIMIX Corporation) at a number of revolution of 5000 rpm for 5 minutes to disperse the oil phase component, thereby preparing a suspension (aqueous dispersion).

Thereafter, the suspension (aqueous dispersion) was transferred to a 500 mL 4-neck flask equipped with a stirrer, a reflux condenser, a thermometer, and a nitrogen inlet tube, and the mixture was stirred under nitrogen gas flow.

Then, 18 g of an aqueous solution of 10 mass % diethylene triamine was added to the suspension to start interfacial polymerization, and thereafter, the temperature of the suspension was increased to start suspension polymerization.

To be specific, first, to the suspension of room temperature, 18 g of an aqueous solution of 10 mass % diethylene triamine was added to the suspension, and immediately after the addition, the temperature of the suspension was increased to 70° C., and the temperature was kept for 5 hours. Thereafter, the temperature of the suspension was increased to 80° C., and the temperature was kept for 2 hours.

The interfacial polymerization was started when the aqueous solution of 10 mass % diethylene triamine was introduced, and the suspension polymerization was started when the temperature reached 55° C. while increasing the temperature of the suspension to 70° C.

In this manner, a suspension (suspending agent) of controlled release particles in which clothianidin is dispersed in matrix formed by suspension polymerization and the matrix is covered with polyurea formed by interfacial polymerization was produced.

Thereafter, the suspension after reaction was cooled to 30° C. or less, a suspension (suspending agent) of controlled release particles in which clothianidin is dispersed in the matrix, and the matrix is covered with polyurea was produced.

### Example B7 to Example B9, Example B14 to Example B18, Example B24 to Example B26, Example B29, Example B30, Example B33, Example B34

### Synthesis of Polyurea Covered/Clothianidin-Containing Controlled Release Particles

### (Example B7 to Example B9, Example B14 to Example B18, Example B24 to Example B26, Example B33 and Example B34: Corresponding to Third Embodiment)

### (Example B29 and Example B30: Corresponding to Fourth Embodiment)

A suspension (suspending agent) of controlled release particles covered with polyurea and containing clothianidin was produced in the same manner as in Example B6, except that the mixing formulation and polymerization conditions were changed in accordance with the description in Table B2 to Table B5.

### Example B35

### Synthesis of Imidacloprid-Containing Controlled Release Particles: Corresponding to Third Embodiment

A suspension (suspending agent) of controlled release particles containing imidacloprid was produced in the same manner as in Example B2, except that the mixing formulation was changed according to the description shown in Table B5.

### Reference Example B1

### Synthesis of Clothianidin-Containing Controlled Release Particles: Corresponding to Reference Embodiment

A 200 mL beaker (1) was charged with 100 g of slurry B prepared in Preparation Example B2 and 0.5 g of PEROYL L, and the mixture was stirred at room temperature, thereby dissolving PEROYL L in slurry B. In this manner, an oil phase component containing PEROYL L and slurry B was prepared.

Separately, a 500 mL beaker (2) was charged with 258.50 g of ion-exchange water, 40 g of an aqueous solution of 10% PVA-217, and 1 g of an aqueous solution of 1% Pronon 208, and the mixture was stirred at room temperature, thereby producing a homogeneous aqueous solution.

Then, a 500 mL beaker (2) was charged with an oil phase component to which PEROYL L was blended, and the mixture was stirred with a T.K.Homo Mixer MARK type 2.5 (manufactured by PRIMIX Corporation) at a number of revolution of 6000 rpm for 5 minutes to disperse the oil phase component in water, thereby preparing a suspension (aqueous dispersion).

Thereafter, the suspension (aqueous dispersion) was transferred to a 500 mL 4-neck flask equipped with a stirrer, a reflux condenser, a thermometer, and a nitrogen inlet tube, and subjected to suspension polymerization while increasing the temperature under a nitrogen gas flow and stirring.

In suspension polymerization, polymerization was started at a point where the temperature reached 55° C., and thereafter, polymerization was performed continuously at 70±1° C. for 5 hours and at 80±1° C. for 2 hours.

Thereafter, the suspension after reaction was cooled to 30° C. or less, and a suspension (suspending agent) of controlled release particles containing clothianidin was produced.

### Reference Example B2

### Synthesis of Clothianidin-Containing Controlled Release Particles: Corresponding to Reference Embodiment

A 200 mL beaker (1) was charged with 100 g of slurry B prepared in Preparation Example B2 and 0.5 g of PEROYL L, and the mixture was stirred at room temperature, thereby dissolving PEROYL L in slurry B. In this manner, an oil phase component containing PEROYL L and slurry B was prepared.

Separately, a 500 mL beaker (2) was charged with 258.26 g of ion-exchange water, 40 g of an aqueous solution of 10% PVA-217, 1 g of an aqueous solution of 1% Pronon 208, and 0.24 g of DEMOL NL, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 6000 rpm for 5 minutes to disperse the oil phase component in water, thereby preparing a suspension (aqueous dispersion).

Thereafter, suspension polymerization was performed in the same manner as in Reference Example B1, thereby producing a suspension (suspending agent) of controlled release particles containing clothianidin.

### Reference Example B3

### Synthesis of Clothianidin-Containing Controlled Release Particles: Corresponding to Reference Embodiment

A 200 mL beaker (1) was charged with 100 g of slurry A prepared in Preparation Example B1 and 0.5 g of PEROYL L, and the mixture was stirred at room temperature, thereby dissolving PEROYL L in slurry A. In this manner, an oil phase component containing PEROYL L and slurry A was prepared.

Separately, a 500 mL beaker (2) was charged with 258.50 g of ion-exchange water, 40 g of an aqueous solution of 10% PVA-217, and 1 g of an aqueous solution of 1% Pronon 208, and the mixture was stirred at room temperature, thereby producing a homogeneous aqueous solution.

Then, an oil phase component was added to the 500 mL beaker (2), and the mixture was stirred with a T.K.Homo Mixer MARK type 2.5 (manufactured by PRIMIX Corporation) at a number of revolution of 6000 rpm for 5 minutes to disperse the oil phase component, thereby preparing a suspension (aqueous dispersion).

Thereafter, suspension polymerization was performed in the same manner as in Reference Example B1, thereby producing a suspension (suspending agent) of controlled release particles containing clothianidin.

TABLE B2

| Composition | Material | Ex. B1 | Ex. B2 | Ex. B3 | Ex. B4 | Ex. B5 |
|---|---|---|---|---|---|---|
| Aqueous | Deionized water | 240.26 | 240.26 | 240.26 | 240.26 | 240.26 |
| phase | AQUEOUS SOLUTION OF 10% PVA- | 40 | 40 | 40 | 40 | 40 |
| (Aqpueous | 217 | | | | | |
| solution) | Aqueous solution of 1% Pronon 208 | 1 | 1 | 1 | 1 | 1 |
| | DEMOL NL | 0.24 | 0.24 | 0.24 | 0.24 | 0.24 |
| | Aqueous solution of 10% DETA | 18 | 18 | 18 | 18 | 18 |
| Oil phase | Slurry | B | A | A | A | A |
| ingredient | | Clothianidin | Clothianidin | Clothianidin | Clothianidin | Clothianidin |
| | | slurry | slurry | slurry | slurry | slurry |
| | | 85 | 50 | 50 | 50 | 50 |
| | i-BMA | — | 17.5 | 17.5 | 17.5 | 17.5 |
| | Styrene | — | — | — | — | — |
| | EGDMA | — | 17.5 | 17.5 | 17.5 | 17.5 |
| | T-1890 | 15 | 15 | 15 | 15 | 15 |
| | PEROYL L | 0.5 | 0.5 | 0.5 | 0.5 | 0.5 |

| | | | | | |
|---|---|---|---|---|---|
| Total | 400 | 400 | 400 | 400 | 400 |
| Revolutions per minute in dispersion (rpm)*All for 5 | 6000 | 5000 | 5000 | 5000 | 5000 |
| minutes | | | | | |
| Polymerization conditions | 1 | 1 | 2 | 3 | 4 |
| Controlled release particles type | 1 | 1 | 1 | 1 | 1 |
| Controlled release particles concentration in | 25 | 25 | 25 | 25 | 25 |
| suspension (%) | | | | | |
| Antibiotic compound concentration in | 28 | 16.7 | 16.7 | 16.7 | 16.7 |
| controlled release particles (%) | | | | | |
| Antibiotic compound concentration in suspension (%) | 7.0 | 4.1 | 4.1 | 4.1 | 4.1 |
| Median size (μm) | 28.2 | 17.7 | 23.5 | 24.0 | 26.5 |
| Alkali-resistance (Test A) | 33.3 | 44.7 | 29.3 | 39.0 | 8.7 |
| Remaining ratio (%) of antibiotic compound | | | | | |

| | | |
|---|---|---|
| Mixing ratio of polymerizable vinyl monomer | DVB | i-BMA/EGDMA |
| | 100% | 50%/50% |

| Composition | Material | Ex. B6 | Ex. B7 | Ex. B8 | Ex. B9 |
|---|---|---|---|---|---|
| Aqueous | Deionized water | 240.26 | 240.26 | 240.26 | 240.26 |
| phase | AQUEOUS SOLUTION OF 10% PVA- | 40 | 40 | 40 | 40 |
| (Aqpueous | 217 | | | | |
| solution) | Aqueous solution of 1% Pronon 208 | 1 | 1 | 1 | 1 |
| | DEMOL NL | 0.24 | 0.24 | 0.24 | 0.24 |
| | Aqueous solution of 10% DETA | 18 | 18 | 18 | 18 |
| Oil phase | Slurry | C | C | C | C |
| ingredient | | Clothianidin | Clothianidin | Clothianidin | Clothianidin |
| | | slurry | slurry | slurry | slurry |
| | | 50 | 50 | 50 | 50 |
| | i-BMA | — | — | — | — |
| | Styrene | 17.5 | 17.5 | 17.5 | 17.5 |
| | EGDMA | 17.5 | 17.5 | 17.5 | 17.5 |
| | T-1890 | 15 | 15 | 15 | 15 |
| | PEROYL L | 0.5 | 0.5 | 0.5 | 0.5 |

| | | | | |
|---|---|---|---|---|
| Total | 400 | 400 | 400 | 400 |
| Revolutions per minute in dispersion (rpm)*All for 5 | 5000 | 5000 | 5000 | 5000 |
| minutes | | | | |
| Polymerization conditions | 1 | 2 | 3 | 4 |
| Controlled release particles type | 1 | 1 | 1 | 1 |
| Controlled release particles concentration in | 25 | 25 | 25 | 25 |
| suspension (%) | | | | |
| Antibiotic compound concentration in controlled release | 16.7 | 16.7 | 16.7 | 16.7 |
| particles (%) | | | | |
| Antibiotic compound concentration in suspension (%) | 4.1 | 4.1 | 4.1 | 4.1 |
| Median size (μm) | 18.4 | 18.9 | 16.1 | 25.6 |
| Alkali-resistance (Test A) | 60.0 | 31.5 | 32.0 | 12.0 |
| Remaining ratio (%) of antibiotic compound | | | | |

| | |
|---|---|
| Mixing ratio of polymerizable vinyl monomer | Styrene/EGDMA |
| | 50%/50% |

TABLE B3

| | | Example | Example | Example | Example | Example |
|---|---|---|---|---|---|---|
| Composition | Material | B10 | B11 | B12 | B13 | B14 |
| Aqueous phase | Deionized water | 222.26 | 246.26 | 249.26 | 252.26 | 222.26 |
| (Aqueous | AQUEOUS SOLUTION OF 10% PVA-217 | 40 | 40 | 40 | 40 | 40 |
| solution) | Aqueous solution of 1% Pronon208 | 1 | 1 | 1 | 1 | 1 |
| | DEMOL NL | 0.24 | 0.24 | 0.24 | 0.24 | 0.24 |
| | Aqueous solution of 10% DETA | 36 | 12 | 9 | 6 | 36 |
| Oil phase | Slurry | A | A | A | A | C |
| ingredient | | Clothianidin | Clothianidin | Clothianidin | Clothianidin | Clothianidin |
| | | slurry | slurry | slurry | slurry | slurry |
| | | 50 | 50 | 50 | 50 | 50 |
| | i-BMA | 10 | 20 | 21.25 | 22.5 | — |
| | Styrene | — | — | — | — | 10 |
| | EGDMA | 10 | 20 | 21.25 | 22.5 | 10 |
| | T-1890 | 30 | 10 | 7.5 | 5 | 30 |
| | PEROYL L | 0.5 | 0.5 | 0.5 | 0.5 | 0.5 |

| | | | | | |
|---|---|---|---|---|---|
| Total | 400 | 400 | 400 | 400 | 400 |
| Revolutions per minute in dispersion (rpm)*All for 5 minutes | 5000 | 5000 | 5000 | 5000 | 5000 |
| Polymerization conditions | 1 | 1 | 1 | 1 | 1 |
| Controlled release particles type | 1 | 1 | 1 | 1 | 1 |
| Controlled release particles concentration in suspension (%) | 25 | 25 | 25 | 25 | 25 |
| Antibiotic compound concentration in controlled release | 16.7 | 16.7 | 16.7 | 16.7 | 16.7 |
| particles (%) | | | | | |
| Antibiotic compound concentration in suspension (%) | 4.1 | 4.1 | 4.1 | 4.1 | 7.5 |
| Median size (μm) | 29.1 | 13.9 | 12.9 | 12.9 | 25.7 |
| Alkali resistance (Test A) | 49.9 | 36.7 | 32.2 | 27.9 | 61.2 |
| Remaining ratio (%) of antibiotic compound | | | | | |

| | | |
|---|---|---|
| Mixing ratio of polymerizable vinyl monomer | i-BMA/EGDMA | Styrene/ |
| | 50%/50% | EGDMA |
| | | 50%/50% |

| | | Example | Example | Example | Example |
|---|---|---|---|---|---|
| Composition | Material | B15 | B16 | B17 | B18 |
| Aqueous phase | Deionized water | 246.26 | 249.26 | 252.26 | 255.26 |
| (Aqueous | AQUEOUS SOLUTION OF 10% PVA-217 | 40 | 40 | 40 | 40 |
| solution) | Aqueous solution of 1% Pronon208 | 1 | 1 | 1 | 1 |
| | DEMOL NL | 0.24 | 0.24 | 0.24 | 0.24 |
| | Aqueous solution of 10% DETA | 12 | 9 | 6 | 3 |
| Oil phase | Slurry | C | C | C | C |
| ingredient | | Clothianidin | Clothianidin | Clothianidin | Clothianidin |
| | | slurry | slurry | slurry | slurry |
| | | 50 | 50 | 50 | 50 |
| | i-BMA | — | — | — | — |
| | Styrene | 20 | 21.25 | 22.5 | 23.75 |
| | EGDMA | 20 | 21.25 | 22.5 | 23.75 |
| | T-1890 | 10 | 7.5 | 5 | 2.5 |
| | PEROYL L | 0.5 | 0.5 | 0.5 | 0.5 |

| | | | | |
|---|---|---|---|---|
| Total | 400 | 400 | 400 | 400 |
| Revolutions per minute in dispersion (rpm)*All for 5 minutes | 5000 | 5000 | 5000 | 5000 |
| Polymerization conditions | 1 | 1 | 1 | 1 |
| Controlled release particles type | 1 | 1 | 1 | 1 |
| Controlled release particles concentration in suspension (%) | 30 | 35 | 30 | 35 |
| Antibiotic compound concentration in controlled release | 16.7 | 16.7 | 16.7 | 16.7 |
| particles (%) | | | | |
| Antibiotic compound concentration in suspension (%) | 5.0 | 5.8 | 5.0 | 5.8 |
| Median size (μm) | 16.6 | 16.7 | 13.9 | 13.6 |
| Alkali resistance (Test A) | 58.2 | 56.9 | 54.4 | 35.0 |
| Remaining ratio (%) of antibiotic compound | | | | |

| | |
|---|---|
| Mixing ratio of polymerizable vinyl monomer | Styrene/EGDMA |
| | 50%/50% |

TABLE B4

| | | Example | Example | Example | Example |
|---|---|---|---|---|---|
| Composition | Material | B19 | B20 | B21 | B22 |
| Aqueous phase | Deionized water | 240.26 | 240.26 | 240.26 | 240.26 |
| (Aqueous solution) | AQUEOUS SOLUTION OF 10% PVA-217 | 40 | 40 | 40 | 40 |
| | Aqueous solution of 1% Pronon208 | 1 | 1 | 1 | 1 |
| | DEMOL NL | 0.24 | 0.24 | 0.24 | 0.24 |
| | Aqueous solution of 10% DETA | 18 | 18 | 18 | 18 |
| Oil phase ingredient | Slurry | F | F | A | A |
| | | Clothianidin | Clothianidin | Clothianidin | Clothianidin |
| | | slurry | slurry | slurry | slurry |
| | | 50 | 50 | 50 | 50 |
| | i-BMA | 35 | 20.4 | 24 | 1.25 |
| | Styrene | — | — | — | — |
| | EGDMA | — | 14.6 | 11 | 33.75 |
| | T-1890 | 15 | 15 | 15 | 15 |
| | PEROYL L | 0.5 | 0.5 | 0.5 | 0.5 |
| Total | | 400 | 400 | 400 | 400 |
| Revolutions per minute in dispersion (rpm)*All for 5 minutes | | 5000 | 5000 | 5000 | 5000 |
| Polymerization conditions | | 1 | 1 | 1 | 1 |
| Controlled release particles type | | 1 | 1 | 1 | 1 |
| Controlled release particles concentration in suspension (%) | | 25 | 25 | 25 | 25 |
| Antibiotic compound concentration in controlled release particles (%) | | 16.7 | 16.7 | 16.7 | 16.7 |
| Antibiotic compound concentration in suspension (%) | | 4.1 | 4.1 | 4.1 | 4.1 |
| Median size (μm) | | 35.9 | 27.6 | 20.1 | 18.6 |
| Alkali resistance (Test A) | | 56.0 | 54.0 | 57.7 | 15.9 |
| Remaining ratio (%) of antibiotic compound | | | | | |
| Mixing ratio of polymerizable vinyl monomer | | i-BMA/EGDMA | | | |
| | | 100%/0% | 77.5%/ | 60%/40% | 25%/75% |
| | | | 22.5% | | |
| | | Example | Example | Example | Example |
| Composition | Material | B23 | B24 | B25 | B26 |
| Aqueous phase | Deionized water | 240.26 | 240.26 | 240.26 | 240.26 |
| (Aqueous solution) | AQUEOUS SOLUTION OF 10% PVA-217 | 40 | 40 | 40 | 40 |
| | Aqueous solution of 1% Pronon208 | 1 | 1 | 1 | 1 |
| | DEMOL NL | 0.24 | 0.24 | 0.24 | 0.24 |
| | Aqueous solution of 10% DETA | 18 | 18 | 18 | 18 |
| Oil phase ingredient | Slurry | D | E | C | C |
| | | Clothianidin | Clothianidin | Clothianidin | Clothianidin |
| | | slurry | slurry | slurry | slurry |
| | | 50 | 50 | 50 | 50 |
| | i-BMA | — | — | — | — |
| | Styrene | — | 35 | 33.75 | 1.25 |
| | EGDMA | 35 | — | 1.25 | 33.75 |
| | T-1890 | 15 | 15 | 15 | 15 |
| | PEROYL L | 0.5 | 0.5 | 0.5 | 0.5 |

| Total | 400 | 400 | 400 | 400 |
|---|---|---|---|---|
| Revolutions per minute in dispersion (rpm)*All for 5 minutes | 5000 | 5000 | 5000 | 5000 |
| Polymerization conditions | 1 | 1 | 1 | 1 |
| Controlled release particles type | 1 | 1 | 1 | 1 |
| Controlled release particles concentration in suspension (%) | 25 | 25 | 25 | 25 |
| Antibiotic compound concentration in controlled release particles (%) | 16.7 | 16.7 | 16.7 | 16.7 |
| Antibiotic compound concentration in suspension (%) | 4.1 | 4.1 | 4.1 | 4.1 |
| Median size (μm) | 15.2 | 43.9 | 23.9 | 12.5 |
| Alkali resistance (Test A) | 3.4 | 45.9 | 77.2 | 16.8 |
| Remaining ratio (%) of antibiotic compound | | | | |
| Mixing ratio of polymerizable vinyl monomer | i-BMA/ | Styrene/EGDMA | | |
| | EGDMA | | | |
| | 0%/100% | 100%/0% | 75%/25% | 25%/75% |

TABLE B5

| | | Example | Example | Example | Example | Example | Example |
|---|---|---|---|---|---|---|---|
| Composition | Material | B27 | B28 | B29 | B30 | B31 | B32 |
| Aqueous | Deionized water | 240.26 | 240.26 | 240.26 | 240.26 | 173.60 | 125.96 |
| phase | AQUEOUS SOLUTION OF 10% PVA-217 | 40 | 40 | 40 | 40 | 40 | 40 |
| (Aqueous | Aqueous solution of 1% Pronon208 | 1 | 1 | 1 | 1 | 1 | 1 |
| solution) | DEMOL NL | 0.24 | 0.24 | 0.24 | 0.24 | 0.24 | 0.24 |
| | Aqueous solution of 10% DETA | 18 | 18 | 18 | 18 | 18 | 18 |
| Oil phase | Slurry | G | G | H | H | A | A |
| ingredient | | Clothianidin | Clothianidin | Clothianidin | Clothianidin | Clothianidin | Clothianidin |
| | | slurry | slurry | slurry | slurry | slurry | slurry |
| | | 56 | 80 | 60 | 80 | 50 | 50 |
| | i-BMA | 14.5 | 2.5 | — | — | 17.5 | 17.5 |
| | Styrene | — | — | 12.5 | 2.5 | — | — |
| | EGDMA | 14.5 | 2.5 | 12.5 | 2.5 | 17.5 | 17.5 |
| | T-1890 | 15 | 15 | 15 | 15 | 15 | 15 |
| | PEROYL L | 0.5 | 0.5 | 0.5 | 0.5 | 0.5 | 0.5 |

| | | | | | | |
|---|---|---|---|---|---|---|
| Total | 400 | 400 | 400 | 400 | 333 | 286 |
| Revolutions per minute in dispersion (rpm)*All for 5 | 5000 | 5000 | 5000 | 5000 | 5000 | 5000 |
| minutes | | | | | | |
| Polymerization conditions | 1 | 1 | 1 | 1 | 1 | 1 |
| Controlled release particles type | 1 | 2 | 2 | 2 | 1 | 1 |
| Controlled release particles concentration in suspension (%) | 25 | 25 | 25 | 25 | 30 | 35 |
| Antibiotic compound concentration in controlled release | 28 | 40 | 30 | 40 | 16.7 | 16.7 |
| particles (%) | | | | | | |
| Antibiotic compound concentration in suspension (%) | 7.0 | 10.0 | 7.5 | 10.0 | 5.0 | 5.8 |
| Median size (μm) | 13.2 | 7.1 | 18.5 | 5.3 | 15.4 | 13.8 |
| Alkali resistance (Test A) | 22.1 | 17.3 | 11.8 | 9.8 | 43.8 | 43.0 |
| Remaining ratio (%) of antibiotic compound | | | | | | |

| | | | |
|---|---|---|---|
| Mixing ratio of polymerizable vinyl monomer | i-BMA/EGDMA | Styrene/EGDMA | i-BMA/EGDMA |
| | 50%/50% | 50%/50% | 50%/50% |

| | | Example | Example | Example |
|---|---|---|---|---|
| Composition | Material | B33 | B34 | B35 |
| Aqueous | Deionized water | 173.56 | 125.96 | 240.26 |
| phase | AQUEOUS SOLUTION OF 10% PVA-217 | 40 | 40 | 40 |
| (Aqueous | Aqueous solution of 1% Pronon208 | 1 | 1 | 1 |
| solution) | DEMOL NL | 0.24 | 0.24 | 0.24 |
| | Aqueous solution of 10% DETA | 18 | 18 | 18 |
| Oil phase | Slurry | C | C | I |
| ingredient | | Clothianidin | Clothianidin | Imidacloprid |
| | | slurry | slurry | slurry |
| | | 50 | 50 | 50 |
| | i-BMA | — | — | 17.5 |
| | Styrene | 17.5 | 17.5 | — |
| | EGDMA | 17.5 | 17.5 | 17.5 |
| | T-1890 | 15 | 15 | 15 |
| | PEROYL L | 0.5 | 0.5 | 0.5 |

| | | | |
|---|---|---|---|
| Total | 333 | 286 | 400 |
| Revolutions per minute in dispersion (rpm)*All for 5 | 5000 | 5000 | 5000 |
| minutes | | | |
| Polymerization conditions | 1 | 1 | 1 |
| Controlled release particles type | 1 | 1 | 1 |
| Controlled release particles concentration in suspension (%) | 30 | 35 | 25 |
| Antibiotic compound concentration in controlled release | 16.7 | 16.7 | 16.7 |
| particles (%) | | | |
| Antibiotic compound concentration in suspension (%) | 5.0 | 5.8 | 4.1 |
| Median size (μm) | 12.0 | 11.6 | 13.3 |
| Alkali resistance (Test A) | 58.8 | 59.6 | 62.1^{1} |
| Remaining ratio (%) of antibiotic compound | | | |

| | | |
|---|---|---|
| Mixing ratio of polymerizable vinyl monomer | Styrene/EGDMA | i-BMA/ |
| | | EGDMA |
| | 50%/50% | 50%/50% |

^{1}Imidacloprid concentration

TABLE B6

| | | Reference | Reference | Reference | | |
|---|---|---|---|---|---|---|
| Composition | Material | Example B1 | Example B2 | Example B3 | Control | |
| Aqueous | Deionized water | 258.50 | 258.26 | 258.50 | Aqueous solution of | Aqueous solution of |
| phase | AQUEOUS | 40 | 40 | 40 | 0.25% Clothianidin | 0.25% Imidacloprid |
| | SOLUTION OF | | | | | |
| | 10% PVA-217 | | | | | |
| | Aqueous solution of | 1 | 1 | 1 | | |
| | 1% Pronon 208 | | | | | |
| | DEMOL NL | — | 0.24 | — | | |
| Oil phase | Slurry | B | B | A | | |
| | | Clothianidin | Clothianidin | Clothianidin | | |
| | | slurry | slurry | slurry | | |
| | | 100 | 100 | 100 | | |
| | PEROYL L | 0.5 | 0.5 | 0.5 | | |

| | | | |
|---|---|---|---|
| Total | 400 | 400 | 400 |
| Controlled release particles | 25 | 25 | 25 |
| concentration in suspension (%) | | | |
| Antibiotic compound concentration | 33.3 | 33.3 | 33.3 |
| in controlled release particles (%) | | | |
| Antibiotic compound concentration | 8.3 | 8.3 | 8.3 |
| in suspension (%) | | | |
| Controlled release particles type | Reference | Reference | Reference |
| | embodiment | embodiment | embodiment |
| Median size (μm) | 28.2 | 24.5 | 43.5 |
| Notes | DVB | DVB | i- |
| | | | BMA/EGDMA |
| | 100% | 100% | 50%/50% |

In Table B2 to Table B5, “1” in the polymerization conditions section indicates that immediately after the aqueous solution of diethylene triamine is added to the suspension, the temperature of the suspension was increased to 70° C., and the temperature was kept for 5 hours. Thereafter, the temperature of the suspension was increased to 80° C., and the temperature was kept for 2 hours.

In Table B2 to Table B6, “2” in the polymerization conditions section indicates that immediately after the aqueous solution of diethylene triamine is added to the suspension, the temperature of the suspension was increased to 60° C., and the temperature was kept for 1 hour, and then the temperature of the suspension was increased to 70° C., and the temperature was kept for 2 hours. Thereafter, the temperature of the suspension was increased to 80° C., and the temperature was kept for 1 hour.

In Table B2 to Table B5, “3” in the polymerization conditions section indicates that immediately after the aqueous solution of diethylene triamine was added to the suspension, the temperature of the suspension was increased to 50° C., and the temperature was kept for 2 hours, and then the temperature of the suspension was increased to 60° C., and the temperature was kept for 1 hour. Thereafter, the temperature of the suspension was increased to 70° C., and the temperature was kept for 2 hours. Thereafter, the temperature of the suspension was increased to 80° C., and the temperature was kept for 1 hour.

In Table B2 to Table B5, “4” in the polymerization conditions section indicates that the temperature of the suspension was increased to 60° C., and the temperature was kept for 1 hour, and thereafter the aqueous solution of diethylene triamine was added. Immediately thereafter, the temperature of the suspension was increased to 70° C., and the temperature was kept for 2 hours. Thereafter, the temperature of the suspension was increased to 80° C., and the temperature was kept for 1 hour.

In Table B2 to Table B5, “1” in the controlled release particles type section indicates that the controlled release particles have a structure of the third embodiment shown in FIG. B1, and “2” in the controlled release particles type section indicates that controlled release particles have a structure of the fourth embodiment shown in FIG. B2.

### Kneading of Powder Formulation of Controlled Release Particles with Thermoplastic Resin, and Molding

### Example B36

### Kneading of Powder Formulation of Example B1 with Polyethylene and Molding

The suspension of the controlled release particles produced in Example B1 was filtered with a filter cloth having 100 pores, and thereafter, dried at room temperature for one day, thereby producing powder of the controlled release particles (powder formulation). The produced powder of the controlled release particles (powder formulation) was dry-blended with high-density polyethylene (HDPE) HI-ZEX 6300M (manufactured by Prime Polymer Co., Ltd., melt flow rate 0.11 g/10 min) so that clothianidin relative to HDPE was 0.25%, introduced into a biaxial extrusion and injection molding DSM Xplore MC15M (manufactured by DSM), melt-kneaded at 220° C. for 5 minutes to produce a strand, and then injection molded in the melted state, thereby producing a strip molded article (10 mm×76 mm×4 mm).

### Example B37

### Kneading of Powder Formulation of Example B27 with Polyethylene and Molding

A strip molded article was produced in the same manner as in Example B36, except that the suspension of the controlled release particles produced in Example B27 was used instead of the suspension of the controlled release particles produced in Example B1.

### Reference Example B4

### Kneading of Powder Formulation of Reference Example B1 with Polyethylene and Molding

A strip molded article was produced in the same manner as in Example B36, except that the suspension of the controlled release particles produced in Reference Example B1 was used instead of the suspension of the controlled release particles produced in Example B1.

### Reference Example B5

### Kneading of Powder Formulation of Reference Example B3 with Polyethylene and Molding

A strip molded article was produced in the same manner as in Example B36, except that the suspension of the controlled release particles produced in Example B3 was used instead of the suspension of the controlled release particles produced in Example B1.

(Formulation of powder formulation of controlled release particles) Example B38

1.4 parts by mass of the suspension of the controlled release particles produced in Example B1 (clothianidin concentration 7.0 mass %) was blended with 100 parts by mass of KAGALITE No. 2 (manufactured by KAGALITE KOGYO CO., LTD., fine grain of pumice, particle size 425 to 1400 μm), and then the mixture was dried, thereby producing clothianidin powder formulation. The powder formulation had a clothianidin concentration of about 0.1 mass %.

### Example B39

A clothianidin powder formulation was produced in the same manner as in Example B38, except that 1.4 parts by mass of the suspension of the controlled release particles produced in Example B27 (clothianidin concentration 7.0 mass %) was blended instead of the suspension of the controlled release particles produced in Example B1. The powder formulation had a clothianidin concentration of about 0.1 mass %.

### Reference Example B6

A clothianidin powder formulation was produced in the same manner as in Example B38, except that 1.2 parts by mass of suspension (clothianidin concentration 8.3 mass %) of the controlled release particles produced in Reference Example B1 was blended instead of the suspension produced in Example B1. The powder formulation had a clothianidin concentration of about 0.1 mass %.

### Reference Example B7

A clothianidin powder formulation was produced in the same manner as in Example B38, except that 1.2 parts by mass of the suspension (clothianidin concentration 8.3 mass %) of the controlled release particles produced in Reference Example B3 was blended instead of the suspension produced in Example B1. The powder formulation had a clothianidin concentration of about 0.1 mass %.

1. SEM (Scanning Electron Microscope) observation The suspension (suspending agent) of Example B1, Example B2, Example B6, Example B30, and Example B35 was dropped on the stage, and thereafter, after water was vaporized away, the produced controlled release particles were observed with a scanning electron microscope Hitachi TM-3000 (manufactured by Hitachi High-Technologies Corporation). SEM images of the controlled release particles produced in Example B1, Example B2, Example B6, Example B30, and Example B35 are shown in FIG. B3 to FIG. B7, respectively.

### 2. TEM (Transmission Electron Microscope) Observation

The suspension (suspending agent) of Example B2 and Reference Example B1 to Reference Example B3 was freeze-dried, then dispersed in a bisphenol liquid epoxy resin, and thereafter cured with amine. Then, the cured product was cut with an ultramicrotome to expose its cross section, the cross section was dyed with osmium tetroxide, and as necessary, also with ruthenium tetroxide, the cross section was cut out with an ultramicrotome into extremely thin slices, thereby preparing samples. The prepared samples were observed with a transmission electron microscope (model number “H-7100”, manufactured by Hitachi, Ltd.).

Image-processed TEM photographs of Example B2 and Reference Example B1 to Reference Example B3 is shown in FIG. B8 to FIG. B11, respectively.

In FIG. B8 to FIG. B11, the blank space shown with reference numeral 3 represents a mark showing that clothianidin was dissolved and fell off in the process of allowing the ultrathin slice to float and to be collected in water, and represents the shape of the clothianidin domain.

In FIG. B8, the shell 7 is made of polyurea, to be specific, made in a manner such that the polyurea concentration is lower relative to the matrix 2 gradually from the outermost layer (outermost surface) to the inner side. The shell 7 is disposed (unevenly distributed) at the outer layer portion of the matrix 2 so as to surround the domain 3.

Meanwhile, as is clear from FIG. B9 to FIG. B11, in the controlled release particles 1 of Reference Example B1 to Reference Example B3, the shell 7 (ref: FIG. B8) is not formed.

### 3. Alkali-Resistance Test

### 3-1. Suspending Agent of Controlled Release Particles

Alkali-resistance test (test A and B) of the controlled release particles was conducted in the following manner.

### (Test A)

The suspending agent of Example B1 to Example B35 was diluted with deionized water so that the antibiotic compound concentration (for Example B1 to Example B34, clothianidin concentration, for Example B35, imidacloprid concentration) was 0.25%. 1 mL of the diluted suspending agent was weighed in a glass bottle, and 4 mL of a saturated calcium hydroxide solution was added thereto, thereby preparing a test solution. The test solution was allowed to stand in a constant temperature of 40° C.

After 7 days from allowing the test solution to stand, 5 mL of acetonitrile was added to the test solution, the antibiotic compound was extracted, the amount of the antibiotic compound was determined with HPLC, and the remaining ratio of the antibiotic compound was calculated.

The results are shown in Table B2 to Table B6.

Separately, as a control, an aqueous solution of 0.25% clothianidin and aqueous solution of 0.25% imidacloprid was used and the test was conducted in the same manner. As a result, the remaining ratio in test A of the aqueous solution of 0.25% clothianidin was 2.5%, and the remaining ratio in test A of the aqueous solution of 0.25% imidacloprid was 0%.

Table B2 to Table B6 show at least the following points.

In Example B2 to Example B4, interfacial polymerization is started before the start of suspension polymerization, and therefore the phase separation between the matrix containing clothianidin and the shell can be progressed well. Meanwhile, in Example B5, interfacial polymerization is started after the start of suspension polymerization, and therefore the phase separation between the matrix and the shell cannot be progressed well, and Example B2 to Example B4 have excellent alkali-resistance compared with Example B5.

In Example B6 to Example B8, interfacial polymerization is started before the start of suspension polymerization, and therefore the phase separation between the matrix containing clothianidin and the shell can be progressed well. Meanwhile, in Example B9, interfacial polymerization is started after the start of suspension polymerization, and therefore the phase separation between the matrix and the shell cannot be progressed well, and in Example B6 to Example B8, alkali-resistance is excellent compared with Example B9.

The amount of T-1890 blended relative to i-BMA and EGDMA increases in the order of Example B13, Example B12, Example B11, Example B2, and Example B10. Therefore, the shell thickness (the shell concentration in the controlled release particles) increases in the order of Example B13, Example B12, Example B11, Example B2, and Example B10. Therefore, alkali-resistance increases in the order of Example B13, Example B12, Example B11, Example B2, and Example B10.

The amount of T-1890 relative to styrene and EGDMA increases in the order of Example B18, Example B17, Example B16, Example B15, Example B6, and Example B14. Therefore, the shell thickness (shell concentration in controlled release particles) increases in the order of Example B18, Example B17, Example B16, Example B15, Example B6, and Example B14. Therefore, alkali-resistance improves in the order of Example B18, Example B17, Example B16, Example B15, Example B6, and Example B14.

The amount of clothianidin blended in controlled release particles decreases in the order of Example B28, Example B27, and Example B2, and alkali-resistance improves in the order of Example B28, Example B27, and Example B2.

The amount of clothianidin in the controlled release particles is reduced and alkali-resistance improves in the order of Example B30, Example B29, and Example B2.

With the suspension polymer having higher hydrophobicity, phase separation from polyurea progresses well. Therefore, in Example B2 and Example B19 to Example B23, in Example B2 and Example B19 to Example B21 in which the amount of i-BMA blended is relatively large, compared with Example B22 and Example B23 having significantly low amount of i-BMA blended, phase separation progresses well between the shell and the matrix containing clothianidin. Therefore, alkali-resistance is excellent in Example B2, Example B20, and Example B21 compared with Example B22 and Example B23.

Of Example B6 and Example B23 to Example B26, in Example B6, Example B24, and Example B25 in which the amount of styrene blended is relatively high, compared with Example B23 and Example B26 in which styrene is significantly low, phase separation progresses well between the shell and the matrix containing clothianidin. Therefore, alkali-resistance is excellent in Example B6, Example B24, and Example B25 compared with Example B23 and Example B26.

In Example B6, styrene is contained as the polymerizable vinyl monomer. In Example B2, i-BMA is contained as the polymerizable vinyl monomer. Styrene in Example B6 is highly hydrophobic compared with i-BMA in Example B2, and therefore phase separation between shell and polymer progresses well. Therefore, alkali-resistance is excellent in Example B6 compared with Example B2.

### (Test B)

The suspension of the controlled release particles produced in Example B1, Example B2, and Reference Example B1 to Example B3 was filtered with a filter cloth having 100 pores, and thereafter, dried at room temperature for one day, thereby producing powder of the controlled release particles (powder formulation). The powder was diluted with deionized water to 1000 times, and 6.3 mL of the dilution was measured and introduced in a glass bottle, and 2 mL of a saturated calcium hydroxide solution was added, thereby preparing a test solution. The test solution was allowed to stand in a constant temperature of 40° C.

10 mL of acetonitrile was added to the test solution after 1 day and after 7 days from the test, and clothianidin was extracted. The clothianidin amount was determined with HPLC, and the remaining ratio was calculated.

As a control, an aqueous solution of technical product of clothianidin was used and the test was conducted in the same manner.

The results are shown in Table B7.

TABLE B7

| | |
|---|---|
| Test B | |
| Reference Example | Clothianidin remaining ratio(%) |

| B•Example B | After 1 day | After 7 days |
|---|---|---|
| Example B1 | 100.0 | 57.9 |
| Example B2 | 100.0 | 58.2 |
| Reference Example B1 | 91.2 | 11.9 |
| Reference Example B2 | 92.5 | 15.6 |
| Reference Example B3 | 92.1 | 15.4 |
| Clothianidin (control) | 86.7 | 7.3 |

As can be seen from Table B7, the suspending agent containing the controlled release particles having shell (ref: reference numeral 7 in FIG. B1) of Examples B1 and 2 has a high clothianidin remaining ratio in any of after 1 day and after 7 days from the test start, compared with the suspending agent containing the controlled release particles having no shell of Reference Example B1 to Reference Example B3.

### 3-2. Powder Formulation of Controlled Release Particles

1.0 g of powder formulation produced in Example B38, Example B39, and Reference Example B6, Reference Example B7 was measured, and 3.6 mL of deionized water and 2 mL of aqueous solution of saturated calcium hydroxide was added thereto, thereby preparing a test solution. The test solution was allowed to stand in a constant temperature of 40° C.

10 mL of acetonitrile was added to the test solution after 1 day and after 7 days from the test, and clothianidin was extracted. The clothianidin amount was determined with HPLC, and the remaining ratio was calculated.

As a control, an aqueous solution of technical product of clothianidin was used and the test was conducted in the same manner.

The results are shown in Table B8.

TABLE B8

| | |
|---|---|
| Reference Example | Clothianidin remaining ratio(%) |

| B•Example B | After 1 day | After 7 days |
|---|---|---|
| Example B38 | 99.0 | 55.8 |
| Example B39 | 99.2 | 56.3 |
| Reference Example B6 | 90.2 | 10.9 |
| Reference Example B7 | 91.8 | 15.1 |
| Clothianidin (control) | 86.7 | 7.3 |

As can be seen from Table 8, the powder formulation of Example B38 and Example B39 containing the controlled release particles having shell (ref: reference numeral 7 in FIG. B1) of Example B1 and Example B2 has a high clothianidin remaining ratio in any of 1 day after the test start and 7 days after the test start, compared with the powder formulation of Reference Example B6 and Reference Example B7 containing the controlled release particles of Reference Example B1 and Reference Example B3 having no shell.

### 4. Termite Control Test on Molded Article

Silica sand was watered so that its water content was 8% (optimal water content for termite activities), and a plastic vessel was charged with the silica sand. Then, the strip molded article of Example B36 and Example B371 was set on the surface of the silica sand.

As a comparison, test was conducted for the one in which a strip molded article made only of HDPE to which controlled release particles were not kneaded was set.

50 ergates of coptotermes were introduced to the above-described plastic vessel, and the number of the dead coptotermes (=death rate) and activities of the termites were observed for 7 days (test was conducted with n=2). All the termites were dead on the second and third day from the start of the test with the strip molded article of Example B36 and Example B37.

Meanwhile, with the strip molded article with only HDPE, i.e., a comparison, the termites were not dead even after 7 days, and no change can be seen in the activities of the termites.

That is, significant formicidal effects can be seen in Example B36 and Example B37.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### DESCRIPTION OF REFERENCE NUMERAL

1 Controlled release particles
2 Matrix
3 Domain
5 Attachment
7 Shell Industrial Applicability

The controlled release particles produced by the production method of controlled release particles are used in various use, and is used for, for example, building material; for example, electric wire cable material and covering material for the electric wire cable; for example, pipes for gas and a covering material for the pipe; and for example, textile goods such as garments and a mosquito net.

1. The controlled release particles produced by a production method including:
an oil phase component preparation step in which an oil phase component containing a hydrophobic slurry is prepared by dispersing, in the hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer.

2. The controlled release particles according to claim 1,
wherein in the polymerization step, the polymerizable vinyl monomer is subjected to suspension polymerization in the presence of a salt of a condensate of aromatic sulfonic acid and formaldehyde, and/or
the polymerizable vinyl monomer contains a (meth)acrylate monomer and a (meth)acrylate-based crosslinkable monomer.

3. The controlled release particles according to claim 1, wherein the antibiotic compound is a neonicotinoid-based insecticide.

4. The controlled release particles according to claim 3, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

5. Controlled release particles having a two-phase structure formed from
a matrix made of a polymer, and
a domain made of an antibiotic compound substantially insoluble to a monomer for producing the polymer and is dispersed in the matrix.

6. The controlled release particles according to claim 5, wherein both of the matrix and the domain are exposed on the surface of the controlled release particles.

7. The controlled release particles according to claim 5, wherein the domain is covered by the matrix.

8. The controlled release particles according to claim 7, wherein the antibiotic compound is further attached to the surface of the matrix.

9. The controlled release particles according to claim 5, wherein the antibiotic compound is a neonicotinoid-based insecticide.

10. The controlled release particles according to claim 9, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

11. The controlled release particles according to claim 1, prepared as powder formulation.

12. A molding material comprising:
a thermoplastic resin, and
controlled release particles,
wherein
the controlled release particles are produced by a production method including:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer.

13. A molded article comprising:
a thermoplastic resin, and
controlled release particles,
wherein
the controlled release particles are produced by a production method including:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer.

14. A method for producing controlled release particles, the method comprising the steps of:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer.

15. The method for producing controlled release particles according to claim 14, wherein
in the polymerization step, the polymerizable vinyl monomer is subjected to suspension polymerization in the presence of a salt of a condensate of aromatic sulfonic acid and formaldehyde, and/or
the polymerizable vinyl monomer contains a (meth)acrylate monomer and a (meth)acrylate-based crosslinkable monomer.

16. The method for producing controlled release particles according to claim 14, further including a step of preparing powder formulation by blending the suspension produced in the polymerization step and a solid carrier, and drying these.

17. The method for producing controlled release particles according to claim 14, wherein the antibiotic compound is a neonicotinoid-based insecticide.

18. The method for producing controlled release particles according to claim 17, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

19. Controlled release particles produced by a production method including:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer,
wherein
in any of at least one step of the oil phase component preparation step, the water dispersion step, and the polymerization step, a hydrophobic shell-forming component and a hydrophilic-shell forming component are blended, and
in the polymerization step, the polymerizable vinyl monomer is subjected to suspension polymerization and the hydrophobic shell-forming component and the hydrophilic shell-forming component are subjected to interfacial polymerization to form a shell that covers a suspension polymer.

20. The controlled release particles according to claim 19, wherein the interfacial polymerization is started simultaneously with the start of the suspension polymerization, or is started before the start of the suspension polymerization.

21. The controlled release particles according to claim 19, wherein the hydrophobic shell-forming component contains polyisocyanate, and
the hydrophilic shell-forming component contains polyamine.

22. The controlled release particles according to claim 19, wherein the antibiotic compound is a neonicotinoid-based insecticide.

23. The controlled release particles according to claim 22, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

24. Controlled release particles comprising:
a matrix made of a polymer,
a domain made of an antibiotic compound substantially insoluble to a monomer for producing the polymer and is dispersed in the matrix, and
a shell that covers the matrix.

25. The controlled release particles according to claim 24, wherein the shell is made of polyurea.

26. The controlled release particles according to claim 24, wherein the antibiotic compound is attached to the surface of the shell.

27. The controlled release particles according to claim 24, wherein the antibiotic compound is a neonicotinoid-based insecticide.

28. The controlled release particles according to claim 27, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.

29. The controlled release particles according to claim 19, prepared as powder formulation.

30. A molding material comprising:
a thermoplastic resin, and
controlled release particles,
wherein
the controlled release particles are produced by a production method including:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer, and
in any of at least one step of the oil phase component preparation step, the water dispersion step, and the polymerization step, a hydrophobic shell-forming component and a hydrophilic-shell forming component are blended, and
in the polymerization step, the polymerizable vinyl monomer is subjected to suspension polymerization and the hydrophobic shell-forming component and the hydrophilic shell-forming component are subjected to interfacial polymerization to form a shell that covers a suspension polymer.

31. A molded article comprising:
a thermoplastic resin, and
controlled release particles
wherein
the controlled release particles are produced by a production method including:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer, and
in any of at least one step of the oil phase component preparation step, the water dispersion step, and the polymerization step, a hydrophobic shell-forming component and a hydrophilic-shell forming component are blended, and
in the polymerization step, the polymerizable vinyl monomer is subjected to suspension polymerization and the hydrophobic shell-forming component and the hydrophilic shell-forming component are subjected to interfacial polymerization to form a shell that covers a suspension polymer.

32. A method for producing controlled release particles, the method comprising the steps of:
an oil phase component preparation step in which an oil phase component containing a hydrophobic slurry is prepared by dispersing, in a hydrophobic polymerizable vinyl monomer, an antibiotic compound that is hydrophobic and is substantially insoluble to the hydrophobic polymerizable vinyl monomer without the presence of a solvent,
a water dispersion step in which the oil phase component is dispersed in water to prepare an aqueous dispersion, and
a polymerization step in which the polymerizable vinyl monomer is subjected to suspension polymerization to produce a polymer,
wherein
in any of at least one step of the oil phase component preparation step, the water dispersion step, and the polymerization step, a hydrophobic shell-forming component and a hydrophilic-shell forming component are blended, and
in the polymerization step, the polymerizable vinyl monomer is subjected to suspension polymerization and the hydrophobic shell-forming component and the hydrophilic shell-forming component are subjected to interfacial polymerization to form a shell that covers a suspension polymer.

33. The method for producing controlled release particles according to claim 32, wherein in the polymerization step, interfacial polymerization is started simultaneously with the start of the suspension polymerization, or is started before the start of the suspension polymerization.

34. The method for producing controlled release particles according to claim 32, wherein
the hydrophobic shell-forming component is polyisocyanate, and
the hydrophilic shell-forming component is polyamine.

35. The method for producing controlled release particles according to claim 32, further including a step of preparing powder formulation by blending the suspension produced in the polymerization step and a solid carrier, and drying these.

36. The method for producing controlled release particles according to claim 32, wherein the antibiotic compound is a neonicotinoid-based insecticide.

37. The method for producing controlled release particles according to claim 36, wherein the neonicotinoid-based insecticide contains at least one selected from the group consisting of (E)-1-(2-chlorothiazole-5-ylmethyl)-3-methyl-2-nitroguanidine and 1-(6-chloro-3-pyridylmethyl)-N-nitroimidazolidin-2-ylideneamine.
